(19) United States
(12) Patent Application Publication
(10) Pub. No.: US 2002/0072956 A1
(43) Pub. Date: Jun. 13, 2002

(54) System and method for determining the optimum configuration strategy for systems with multiple decision options

(76) Inventors: Sean P. Willems, Brookline, MA (US); John D. Ruark, Cambridge, MA (US)

Correspondence Address: PILLSBURY WINTHROP LLP, 1600 TYSONS BOULEVARD, MCLEAN, VA, 22102, US

(21) Appl. No.: 09/971,114

(22) Filed: Oct. 5, 2001

Related U.S. Application Data
(60) Provisional application No. 60/238,124, filed on Oct. 6, 2000.

(51) Int. Cl. G06F 17/60

(52) U.S. Cl. 705/10; 705/400

(57) ABSTRACT

The present invention provides an apparatus and method for optimizing total costs over the stages of a network of interconnected stages. The method of the present invention includes receiving at least one data set for each of a plurality of interconnected stages, each data set corresponding to an option at the corresponding stage, each data set including a first cost and a second cost. The method further includes determining, based upon the at least one data set, an optimum series of options over a series of the stages by selecting a single option at each stage in the series of the stages that minimizes the sum of total costs over the series of the stages, wherein the total costs is a function of said at least one data set.

The present application claims priority to U.S. Provisional Application of Willems et al., filed Oct. 6, 2000, Ser. No. 60/238,124, the entirety of which is hereby incorporated into the present application by reference as if set forth fully herein.

### COPYRIGHT NOTICE

This patent document contains information subject to copyright protection. The copyright owner has no objection to the facsimile reproduction by anyone of the patent document or the patent, as it appears in the U.S. Patent and Trademark Office files or records, but otherwise reserves all copyright rights whatsoever.

### BACKGROUND OF THE INVENTION

1. Field of the Invention

The present invention relates to systems and methods for determining the optimum configuration strategy for systems with multiple decision options at each stage of the system. More specifically, the present invention relates to systems and methods for determining the optimum configuration strategy for decision option chains.

2. Description of Related Art

Increasing competitive pressures are forcing companies to increase their rates of innovation. The increasing rate of innovation shortens each product's duration in the market, thereby compressing each product's life cycle. Product categories, like networking equipment, which used to have a life span of two to four years are now obsolete after one to two years.

Without proper management, increasing product turnover will increase design and manufacturing costs. More frequent product development cycles require additional product development resources. Shorter production runs inhibit a company's ability to achieve manufacturing cost reductions by exploiting the learning curve and scale economies. Unless companies can efficiently manage multiple generations of the product, there is a substantial risk that costs will spiral out of control.

With the above in mind, attention has been given to the design of a product's supply chain. Factors that affect the design of a supply chain are numerous. One factor is the quality of the supplier-manufacturer relationship. Examples of this work include work on optimal sampling policies for incoming parts (Nurani et al. (1995)), illustrating the benefits of highly robust part designs (Clausing (1993)), and calculating the cost of quality implications from poor quality vendors. Another stream of research has worked on ensuring that the supplier is capable of meeting the manufacturer's volume requirements. This research, which falls broadly under the category of supplier certification (Grieco and Gozzo (1992)), designs practices to ensure that the supplier is able to keep up as the manufacturer ramps up production. There are also relevant strategic issues including the proper organizational structure for complex supply chains (Laseter (1998)).

At present, when a company selects a supply chain for a product that they manufacture or assemble, they typically focus on the product's unit manufacturing cost (UMC). UMC is defined as the per unit cost of a completed finished goods item. This is typically the sum of two sets of costs: direct costs and allocated overhead. As the name implies, direct costs are those costs that can be directly attributed to the production of the product. Examples include raw material, transportation, and processing costs. Overhead costs include those costs that are necessary to support the product family but can not be attributed to specific units of production. Examples of engineering costs include quality auditing and process engineering costs. These two components of UMC are often treated independently. That is, engineering costs are based on volume projections for the product and then divided by the total number of units sold in order to yield a per unit cost. Direct costs are just the sum of the direct costs added across the supply chain. As described herein, UMC will refer to just the direct portion of the product's cost.

In practice, UMC is the dominant criterion in the design of a supply chain for several reasons. First, in most structured product development processes a product must achieve a gross margin target before it gains approval. Gross margin is calculated by dividing the difference between selling price and UMC by the selling price. Since the price is typically dictated by exogenous factors, the team must focus on UMC in order to meet the gross margin target. This gives UMC a disproportionate influence during the product development process. Second, it can be measured directly, without any ambiguity. This is in contrast to the calculation of costs like expected safety-stock cost which require an estimate of quantities like demand variability. Since, by construction, these estimates of variability are only estimates, the actual realization of the safety-stock cost will almost surely deviate from its expected value. Although materials managers understand this fact, it nonetheless greatly complicates their budgeting process if they choose to include safety-stock cost since it will make their budget numbers incorrect. UMC does not have this problem because it equals the sum of costs that are specified in contracts; its value will only change if a change in a contract is negotiated. Third, the buyers that negotiate the part purchases are not the same employees that deal with the consequences of the purchasing decisions. They do not see the effects of choosing a cheaper, less responsive, supplier. Finally, few quantitative tools exist to assess the impact of UMC-based decisions on the rest of the supply chain. In the absence of a model that directly proves that minimizing UMC is a bad decision rule, they will continue applying a rule that they know with certainty minimizes one cost: the cost-of-goods sold.

A supply chain can be viewed as a network where the nodes (or stages) represent functionality that must be provided and the arcs capture precedence constraints among the functions. A function might be the procurement of a raw material, the manufacture of an assembly, or the shipment of a product to a distribution center, etc. For each of these functions, there are one or more options available to satisfy the function. As an example, two options might exist for the procurement of a resistor: a high cost local distributor and a lower cost multinational manufacturer.

For most structured product development processes, there comes a time when the materials management organization (MMO) is called in to source the new product's supply chain. The supply chain's functions have already been determined at this point. The role of MMO is to identify the options that can satisfy each function and then to decide which options to select. A question MMO faces is whether to create a higher unit manufacturing cost, but more responsive, supply chain versus a lower manufacturing cost, less responsive supply chain.

Since the supply chain has not yet been established, numerous costs are configuration-dependent. That is, the options selected will impact multiple supply chain design costs. The most obvious cost is the cost-of-goods sold (“COGS”) where COGS is defined as the direct variable cost of the product multiplied by the number of units sold. Traditionally, sourcing decisions have minimized this cost by minimizing the UMC of the product. In most industrial contexts, minimizing UMC is equivalent to minimizing COGS because UMC can be broken into two components: material-related costs and engineering-related costs. If both types of costs are independent then COGS equals the direction portion of UMC times the number of units sold. However, there are also other costs that are determined by the configuration of the supply chain. These costs include the cost of the inventory necessary to provide the desired level of service to the customer.

On the multi-echelon inventory side, numerous papers address optimizing safety-stock placement across the supply chain. The papers that are the most relevant to our work are the papers by Ettl et al. (1996) and Graves and Willems (1998). These papers, and many of their cited references, optimize safety-stock levels for an established supply chain. That is, these models consider supply chains that are already in existence. Because these supply chains are established, several of the relevant costs in the supply chain are already fixed. In particular, the expected pipeline stock cost and COGS are determined by the problem's inputs. Therefore, these costs are constants that do not enter into the analysis.

Inderfurth (1993) does jointly consider the optimization of safety-stock costs and production times for a supply chain where the final production stage produces multiple end items. The optimization captures the impact that the finished goods' lead-times have on the overall safety-stock cost in the supply chain. However, the model only considers changing the configuration at one stage in the supply chain and only considers safety-stock costs.

Assessing the time-to-market costs for new products has also been well studied. Quantitative models that evaluate the cost of development times are considered in Ulrich et al. (1993) and Cohen et al. (1996). Several empirical studies also quantify the benefits of a shorter time-to-market. Hendricks and Singhal (1997) have examined the impact of delayed product introductions on firms'stock price and Datar et al. (1997) have shown that faster product development correlates positively with increased market share in the computer component industry.

In Graves and Willems (1998), a single-state dynamic program is formulated to minimize the safety-stock cost in an existing supply chain. Specifically, Graves and Willems (1998) provide an optimization algorithm for determining where to place safety-stock in the supply chain, which is important since it dictates the major decoupling points in the supply chain.

However, the work performed to date on the design of supply chains does not consider the supply chain system as a whole, and does not optimize over a multitude of factors that affect the overall design of the supply chain, where such factors include manufacturing cost, multi-echelon inventory costs, and time-to-market costs.

Another decision problem that companies face is that the products that they deliver must continually be improved, from one product generation to the next. Thus, companies must decide which parts to design into their product, while keeping in mind development costs associated with redesigning the product, the part manufacturing costs and the level of functionality that the part must provide

A product can be thought of as consisting of two sets of parts: custom parts and standard parts. In networking equipment, for example, custom parts include microprocessors and ASICs. These are the parts that dictate the performance level of the product and hence the product's relative attractiveness to consumers. Standard parts include memory and system boards. These parts act to support the custom parts; they are necessary for the operation of the product, but they do not differentiate the product from the competition. Because custom parts dictate the product's performance, typically they will have to be revised each generation. However, there is no such requirement on standard parts. Standard parts only need to be revised when they conflict with custom parts or constrain the performance of the product or when they become too expensive. For example, 66 megahertz system boards become impractical to use when microprocessor speeds exceed 333 megahertz since the board's slow speed acts to constrain the entire product's performance thereby negating the effect of the improved microprocessor. With regards to cost, many standard parts are commodities and as such can become prohibitively expensive to use as supply options decrease over time; this explains the move from four-megabyte memory chips to sixteen-megabyte memory chips.

Another fact that complicates this problem is the fact that performance requirements for future periods are uncertain. For example, a computer manufacturer may know that the current product requires a 266 megahertz processor but there may be significant uncertainty whether the requirement for the next period will exceed 333 megahertz. In the unlikely event that the design team knows that the next generation processor will not exceed 333 megahertz, then the 66 megahertz system board will be their choice for the current generation. But if there is a high likelihood that the next generation's processor will exceed 333 megahertz, it may be cost-effective to switch to the 100 megahertz system board in the current generation.

The exact part that will be chosen each period will depend on the cost of changing the part from one period to the next, the per generation part cost, and the level of uncertainty with regards to future performance requirements. The product development, equipment selection, and technology choice domains have all addressed aspects of this problem.

In the product development domain, Sanderson (1991) presents a stylized model that examines the cost implication of different ratios of standard to custom parts. The cost function is composed of product development, fixed equipment and variable manufacturing costs. Both the development and manufacturing costs depend on the ratio of standard to custom parts. For a given ratio of standard to custom parts, the cost function can be examined in order to identify ranges where adopting one set of parts versus another is beneficial. For a single product generation, Krishnan et al. (1998) determines the optimal set of common parts and the optimal number of products to offer that maximizes the product family's profitability. The attractiveness of a product offering, and hence its profitability, is dictated by the product's performance level. The authors show that the problem can be converted into a shortest path problem. Because Krishnan et al. (1998) is a single generation problem, the requirements for the period are known with certainty and as such only appear in the demand function.

In the equipment replacement problem, a decision has to be made to either replace a machine in the current period or to replace it in a future period. The classic work in this field is by Terborgh (1949). Relevant factors affecting this decision are the cost of operating the existing machine and the operating characteristics of machines that will become available in the future. For the deterministic version of the problem, extensive planning horizon results have been developed, leading to the creation of efficient forward dynamic programs; refer to Chand and Sethi (1982) for an example of this approach.

The part selection problem differs in several ways from the equipment replacement problem. First, equipment replacement focuses on the role of depreciation and salvage costs for the existing piece of equipment. There is no real analog to these costs in the part selection problem. Second, the equipment replacement models assume that any piece of equipment is suitable to the task at hand, albeit with different operating costs. This may be a reasonable assumption for machinery but it is not a reasonable assumption for parts. That is, there comes a time when some parts are simply unable to satisfy a generation's performance requirement. Finally, equipment replacement models assume that the cost of different machines move in lock step. That is, a newer machine is cheaper to operate than an older machine. A corollary to this is that the newer machine will not become more expensive to operate than older machines when the newer machine is no longer the newest; the assumption here is that costs tend to move together.

The technology choice literature is distinct from the equipment replacement literature in its focus on determining which technology to use given the characterization of demand and the fixed and variable costs associated with each technology. In the equipment replacement problem, the objective is to minimize cost whereas in the technology choice literature the objective is to maximize revenue. The two approaches are not equivalent because the technology literature allows the choice of technology to impact the firm's profitability. Examples of this work include Cohen and Halperin (1986) and Fine and Freund (1990).

In Cohen and Halperin (1986), the authors develop a model that jointly optimizes production levels and the technology chosen each period. That is, different technologies will have different optimal production levels. The authors provide a condition that, if satisfied, proves that any future technology adopted will have a lower per unit variable cost than the existing technology in place.

Oftentimes, technology choice considers flexible manufacturing equipment that is capable of satisfying demand from multiple end items. Fine and Freund (1990) consider a multiproduct firm that has a two-stage decision process. In the first stage, they must determine which technologies to adopt. They can choose flexible equipment, at a higher cost, that can produce any product or they can choose dedicated equipment that can only produce a certain product. In the second stage, the capacity purchased in the first period is used to satisfy demand. The authors solve this as a nonlinear stochastic program and prove properties of the optimal solution.

Finally, the work of Rajagopalan et al. (1998) deserves special consideration due to its close relation to our work. The authors present a model that jointly optimizes technology choice, capacity, and replacement decisions. The sources of uncertainty in their model are the times between technology breakthroughs and the new technology that will emerge. This is modeled as a semi-markov process where the transition from one technology to the next is dependent on the best technology currently available. Assumptions are that the set of possible technologies is known at the start of the planning horizon, that the technologies can be indexed from worst to best, and that the likelihood of moving from one technology to each superior technology can be assigned a probability by the user. That is, at the start of the horizon the user needs to specify the possible interrelationships between all technologies.

Thus, the part selection problem can be viewed as a more constrained version of the technology choice problem. The added constraint is the per period performance requirement. An example where this type of constraint would be useful to the equipment replacement or technology choice literature is for a product like a photolithography machine. In the current generation, machines capable of 0.25 micron widths are sufficient but in two periods they will need to be capable of 0.18 micron widths. The question is: do you buy a 0.25 micron width machine now and install a 0.18 micron width machine in two periods or do you install the 0.18 micron now; it is assumed that the 0.18 machine is capable of producing 0.25 micron widths. If you install the 0.18 micron machine now, your current period costs will increase but they may be offset by the scale economies achieved by the 0.18 machine.

Also, the present disclosure incorporates by reference the following dissertation: Sean Willems, “Two papers in supply chain design: supply chain configuration and part selection in multigeneration products,” Massachusetts Institute of Technology, 1999. Also, Graves, S. C., and S. P. Willems, “Optimizing Strategic Safety-stock Placement in Supply Chains,” Working Paper, 49 pages, January 1998, is incorporated into the present application by reference.

### SUMMARY OF THE INVENTION

Therefore, the present invention provides an apparatus and method for optimizing total costs over the stages of a network of interconnected stages. The method of the present invention includes receiving at least one data set for each of a plurality of interconnected stages, each data set corresponding to an option at the corresponding stage, each data set including a first cost and a second cost. The method further includes determining, based upon the at least one data set, an optimum series of options over a series of the stages by selecting a single option at each stage in the series of the stages that minimizes the sum of total costs over the series of the stages, wherein the total costs is a function of said at least one data set.

The present invention also provides an apparatus and method for representing, via a user interface of a given computer, each stage of an interconnected system using a stage symbol. The stage symbols are interconnected with links to form a representation of the system, the links being displayed on a display device, wherein each stage symbol is connected to at least one other stage symbol by at least one link. Based upon information associated with a plurality of options at the stages, the present invention may include determining an optimum series of options over a series of the stages by selecting a single option at each stage in the series of stages that minimizes the sum of total costs over the series of stages, the total costs being a function of the information.

The present invention further provides an apparatus and method for determining the optimal set of components to be used in a product over a series of periods. The method includes receiving information corresponding to each of a plurality of components used in a product, the information including first data and second data, wherein the first data is a quantifiable attribute of interest and the second data is an availability of each component in each of a plurality of time periods. The method includes determining, based upon the information, corresponding functionality requirements that each component must provide over each of a series of said periods that the corresponding component is incorporated into said product. The method further includes determining the optimal set of components to be used in the product over a series of the periods that minimizes a cost functional subject to satisfying at least one of the second data and the functionality requirements over the series of the periods, wherein the cost functional includes the sum of at least one of a development costs and a manufacturing costs of the product over the series of the stages.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 is a schematic depiction of a serial line supply chain;

FIG. 2 is a schematic depiction of an assembly network supply chain;

FIG. 3 is a schematic depiction of a distribution network supply chain;

FIG. 4 is a schematic depiction of a spanning tree network supply chain;

FIG. 5 is a depiction of the spanning tree network of nodes corresponding to stages of the network;

FIG. 6 is a depiction of the spanning tree network of FIG. 5 with the nodes renumbered;

FIG. 7a is a flowchart of the method for determining the optimum series of options over the network of interconnected stages;

FIG. 7b is an exploded flowchart of block S10 of FIG. 7a;

FIG. 7c is an exploded flowchart of block S22 of FIG. 7a;

FIG. 7d is an exploded flowchart of block S34 of FIG. 7a;

FIG. 8 is a schematic depiction of an example of a spanning tree network for a digital capture supply chain;

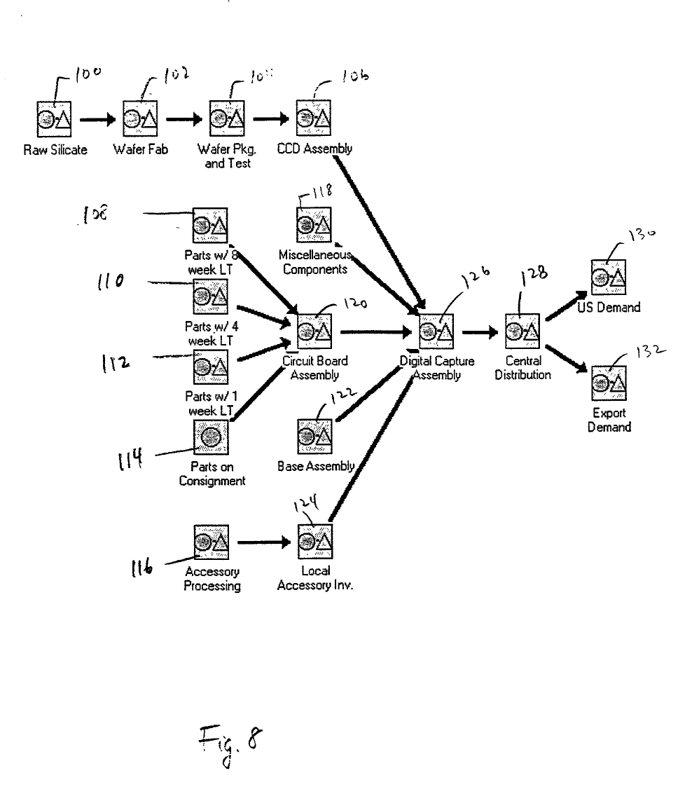

FIG. 9 is a schematic depiction of the spanning tree network of FIG. 8 showing the optimal service times for minimum UMC Heuristic.

FIG. 10 is the schematic depiction of FIG. 8 showing the production times for minimum UMC Heuristic;

FIG. 11 is the schematic depiction of FIG. 8 showing the optimal safety-stock placement for the minimum UMC Heuristic;

FIG. 12 is the schematic depiction of FIG. 8 showing the optimal service times for the minimum production time Heuristic;

FIG. 13 is the schematic depiction of FIG. 8 showing the production times for the minimum production time Heuristic;

FIG. 14 is the schematic depiction of FIG. 8 showing the optimal safety-stock placement policy for minimum production time Heuristic;

FIG. 15 is the schematic depiction of FIG. 8 showing the optimal service times determined using the optimization algorithm of the present invention;

FIG. 16 is the schematic depiction of FIG. 15 showing the production times for reference;

FIG. 17 is the schematic depiction of FIG. 8 showing the optimal safety-stock placement determined using the optimization algorithm of the present invention;

FIG. 18 is a block diagram of an embodiment of a computer system according to the present invention;

FIG. 19 is a block diagram of an embodiment of a networked configuration of the system according to the present invention;

FIG. 20 shows an exemplary embodiment of an interactive decision option chain view page that may be provided by the present invention;

FIG. 21 shows an exemplary embodiment of a chain home page in accordance with the present invention;

FIG. 22 shows an exemplary embodiment of a decision option chain stages and links in accordance with the present invention;

FIG. 23 shows an exemplary embodiment of an expanded stage display showing three stages in accordance with the present invention;

FIG. 24 is a flow chart of a method according to the present invention for providing requested stage information to a user located at a second computer;

FIG. 25 shows an exemplary embodiment of a stage report according to the present invention;

FIG. 26 shows an exemplary embodiment of an options summary according to the present invention;

FIG. 27 shows an exemplary embodiment of an options report in accordance with the present invention;

FIG. 28 shows an exemplary embodiment of a stage properties summary in accordance with the present invention;

FIG. 29 shows an exemplary embodiment of a stage properties demand report in accordance with the present invention;

FIG. 30 shows an exemplary time metrics tracking report associated with a series of stages representing a decision option chain;

FIG. 31 shows an exemplary cost metrics tracking report provided in accordance with the present invention;

FIG. 32 shows an exemplary inventory metrics tracking report provided in accordance with the present invention;

FIG. 33 shows an exemplary embodiment of a chain comparison report in accordance with the present invention;

FIG. 34 shows an exemplary embodiment of a sensitivity analysis results report in accordance with the present invention;

FIG. 35 is a flow chart for one embodiment of a method of the present invention for providing modification of stage information by a user at a second computer; and

FIG. 36 is a flow chart illustration of an embodiment of a method for representing an exemplary supply chain according to the present invention.

FIG. 37 is a flowchart of the method for determining an optimal set of components to be used in a product over a series of periods.

FIG. 38 is a graph showing product volumes over time for several companies; and

FIG. 39 is a graphical depiction of the efficient frontier calculated using the algorithm to determine part selection in multigenerational products.

### DETAILED DESCRIPTION

While the present invention will hereinafter be described in connection with at least one exemplary embodiment thereof, it should be understood that it is not intended to limit the invention to that embodiment. On the contrary, it is intended to cover all alternatives, modifications and equivalents as may be included within the spirit and scope of the invention as defined by the appended claims.

One aspect of the present invention is that an apparatus and method are provided for determining, based upon at least one data set, an optimum series of options over a series of interconnected stages by selecting a single option at each stage in the series of stages that minimizes the sum of total costs over the series of the stages, wherein the total costs is a function of the at least one data set. The at least one data set includes at least a first cost and a second cost. The interconnected stages may be a production system, and the production system may be a supply chain. Where the interconnected stages is a supply chain, the first cost and second cost may include a monetary cost and an amount of time, respectively.

Where the production system is a supply chain, the invention provides a decision support tool that product managers can use during the product development process where the product's design has been fixed, but the vendors, manufacturing technologies, and shipment options have not yet been determined. The supply chain design framework of the present invention considers specific costs that are relevant when designing supply chains. The specific costs that are considered include unit manufacturing costs, inventory cost, and time-to-market costs. Inventory costs include safety-stock cost and pipeline stock cost. The present invention minimizes the sum of these costs when creating a supply chain.

The problem is a design problem because there are several available decision options, or sourcing options, at each stage. Examples include multiple vendors available to supply a raw material and several manufacturing processes capable of assembling the finished product. Other examples of decision options include wherein said decision options include supply, distribution, manufacturing process, equipment, labor, purchase, or other related decision options that would effect the variables including cost and production time. These different decision options have different costs and times. The costs and times include direct costs and production lead-times. Therefore, choices in one portion of the supply chain can affect the costs and responsiveness of the rest of the supply chain. The optimal configuration of the supply chain will choose one option per stage such that the costs of the resulting supply chain are minimized.

An optimal solution algorithm is developed to optimally solve the supply chain configuration for four embodiments. In the first embodiment provides the framework for an algorithm of a serial line supply chain. This framework forms the building blocks of the more general algorithms of the second, third, and fourth embodiments. The second embodiment extends the serial line framework to solve assembly networks. Assembly networks are networks where a stage can have several suppliers, but can itself supply only one stage. The third embodiment extends the serial line framework to solve distribution networks. Distribution networks are networks where a stage can have multiple customers, but only one supplier. The fourth embodiment combines the results from the second and third embodiments to solve spanning tree networks. While still having a specialized structure, spanning trees allow the modeling of numerous real-world supply chains. Serial line networks, assembly networks, and distribution networks are all special cases of the spanning tree network, but discussing each in the above order facilitates understanding of the most general, spanning tree network. Furthermore, nomenclature, definitions, and the development of Equations for the first three embodiments are applicable to the spanning tree network. Lastly, the algorithm and several heuristics are applied to an industry example.

It will be understood to those skilled in the art that although the apparatus and methods above and described herein are described in terms of a supply chain, this application is not intended to be limiting. Rather, the apparatus and method is applicable to any network of interconnected stages. As such, although a supply chain may use cost and time (i.e., direct cost and production lead-times) as the multivariable inputs, which correspond to the first cost and second cost, respectively, any data that is option-specific may be used. Also, the total costs described above and herein applicable to a supply chain, which include at least one of a manufacturing costs, inventory costs, and time-to-market costs, are not intended to be limiting. Rather, the multivariable optimization method can be applied to any cost functional that can be expressed by any quantifiable characteristics.

1. Serial Line Formulation

1.1 Network Representation

The first embodiment of the present invention presents an optimization formulation for a serial line network of interconnected stages. Where the serial line is a supply chain, the first embodiment therefore presents a method to minimize at least one of manufacturing costs, inventory costs, and time-to-market costs for an N-stage serial supply chain. The inventory costs may include both safety-stock cost and pipeline stock cost. Therefore, the method may minimize the sum of at least one of manufacturing costs, safety-stock costs, pipeline stock costs, and time-to-market costs.

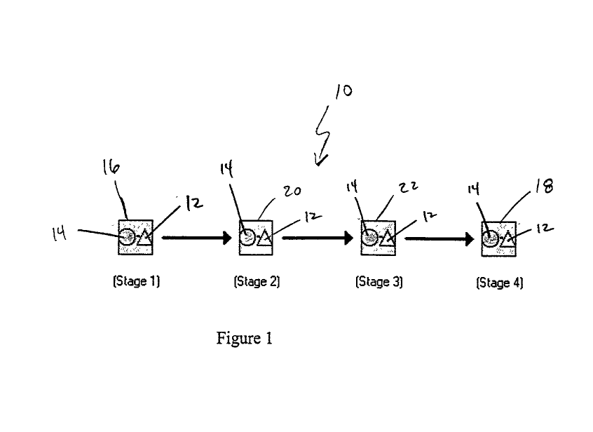

FIG. 1 shows a schematic of a plurality of interconnected stages 10 having N stages, where stage i is the immediate upstream “supplier” for stage i+1, for i=1, 2, . . . , N−1. In a supply chain, each stage may represent an operation to be performed. The operation to be performed may be a processing function. Therefore, a typical stage might represent the procurement of a raw material or the manufacturing of a subassembly or the shipment of the finished product from a regional warehouse to the customer's distribution center. Each stage is also a potential location for holding a safety-stock inventory of the item processed at the stage, which is indicated by a triangle 12 at the stage. A circle 14 at the stage indicates that the inventory is to be further processed. Hence, stage 1, indicated as reference numeral 16, is, for example, the raw material stage and has no supplier; and stage N (18) is, for example, the finished goods inventory stage, from which customer demand is served. Each stage 20, 22 represents a processing function in the supply chain.

For each stage, one or more options exist that can satisfy the stage's processing requirement. The total number of options available at stage i is denoted by Oᵢ. For example, if a stage represents the procurement of a metal housing, then one option might be a locally-based high-cost provider and another option could be a low-cost multinational company. If these are the only two options available at stage 1, then O₁=2 and the individual options will be denoted O₁₁ and O₁₂ where Oᵢⱼ denotes the jth available option at stage i. Options are differentiated by their direct costs and production lead-times. For each stage, only one option will be chosen in the completed supply chain. Thus, the serial line system model restricts itself to sole sourcing at each stage.

An example of a typical serial line supply chain is shown schematically in FIG. 1. Stage 1 (16) represents the purchase of a raw material from an external vendor. Stage 2 (20) represents transforming the raw material. Stage 3 (22) represents sending the transformed raw material through the company's distribution center. Stage 4 (14) represents the product being shipped to the customer, who places orders directly on the distribution center at stage 4. An example of the options at each of the above stages are shown in Table 1:

TABLE 1

| Stage | Option | Description | Direct Cost | Lead-time |
|---|---|---|---|---|
| 1 | 1 | Local supplier | $45 | 20 days |
| 1 | 2 | Multinational supplier | $20 | 40 days |
| 2 | 1 | Manual assembly | $10 | 10 days |
| 2 | 2 | Automated assembly | $40 | 2 days |
| 2 | 3 | Hybrid assembly line | $20 | 4 days |
| 3 | 1 | Company-owned trucks | $15 | 4 days |
| 3 | 2 | Third party carrier | $30 | 2 days |
| 4 | 1 | Ground transportation | $25 | 5 days |
| 4 | 2 | Air freight | $45 | 3 days |
| 4 | 3 | Premium air freight | $60 | 1 day |

For example, referring to Table 1 and FIG. 1, at stage 1 (16) of the supply chain, the procurement of raw material could be from a local supplier (option 1), or a multinational supplier (option 2). From the local supplier (option 1), the raw material will have a monetary cost of $ 45 (direct cost) and will take 20 days (lead-time); from the multinational supplier (option 2), the raw material will incur a monetary cost of $20 and will take 40 days. Likewise, at stage 2 (20) of the supply chain, transforming the raw material could be accomplished by manual assembly (option 1), by automated assembly (option 2), or by a hybrid assembly line (option 3). Each of the costs (i.e., direct cost and lead-time cost) associated with each option of each stage of the supply chain of FIG. 1 is likewise shown in Table 1.

It will be understood to those skilled in the art that the example options in Table 1 and the description of operations/functions at each stage of the supply chain of FIG. 1 are not intended to be limiting, but are rather intended to merely illustrate the possible options and functions that could be encountered by a manufacturer in a supply chain. Further, although only two or three options are depicted at each stage, any number of options can be available.

Additionally, although only Direct Cost and Lead-Time, corresponding to a first cost and a second cost, respectively, are presented in this section as being inputs that are option-specific to the supply chain, it will be understood to those skilled in the art that any other data that are option-specific can also be modeled in a straight-forward manner as extensions to the Equations presented herein and throughout. For example, such data could include defect rates, variability of lead-time, and bounds and conditions on allowable service times that depend upon which option is chosen, or any other variable quantities.

By merely reviewing the costs and lead-times of Table 1, it is not immediately obvious which option should be selected at each stage. At the extremes, one can create a high-cost, short production lead-time supply chain or a low-cost, long production lead-time supply chain. Thus, the object of the present invention is twofold. First, for a given set of options at each stage of interconnected stages, wherein each option includes at least a first cost and a second cost, a method for determining, based upon the given set of options, the optimal series of options (i.e., configuration) that minimizes the total costs is provided. Where the interconnected stages is a supply chain, the algorithm minimizes total supply chain costs. Furthermore, the present invention provides a methodology and algorithm to provide general insights and conditions on when certain supply chain structures are appropriate.

The stage notation and assumptions for the serial line supply chain, which are also applicable to the embodiments that follow, is developed below.

1.2 Option definition

An option at a stage is defined as a {first cost, second cost} pairing. In a supply chain using inputs of a monetary amount (i.e., direct cost added) and an amount of time (i.e., lead-time), an option at a stage is therefore defined as a {direct cost added, production lead-time} pairing. There are Oᵢ options to choose from at stage i and the jth available option is defined by Oᵢⱼ={cᵢⱼ, Tᵢⱼ}, where cᵢⱼ denotes the direct cost added (i.e., first cost) and Tᵢⱼ denotes the production lead-time (i.e., second cost) of the jth option at stage i. It is noted that 1≦j≦Oᵢ. When a stage reorders, the production lead-time is the time to process an item at the stage, assuming all of the inputs are available. The production lead-time includes both the waiting and processing time at the stage, plus any transportation time required to put the item into inventory. For instance, suppose stage i's selected option has a three-day production lead-time. If we make a production request on stage i in time period t, then stage i completes the production at time t+3, provided that there is an adequate supply from stage i−1 at time t.

It is assumed that the production lead-time is not impacted by the size of the order. In effect, this assumes that there are no capacity constraints that limit production at a stage.

An option's direct cost represents the direct material and direct labor costs associated with the option. If the option is the procurement of a raw material from a vendor, then the direct costs would be the purchase price and the labor cost to unpack and inspect the product.

1.3 Periodic-review base-stock replenishment policy

It is also assumed that all stages operate according to a periodic review policy with a common review period. Each period each stage observes demand either from an external customer or from its downstream stage, and places an order on its supplier to replenish the observed demand. In effect, each stage operates with a one-for-one or base-stock replenishment policy. There is no time delay in ordering; hence, in each period the ordering policy passes the external customer demand back up the supply chain so that all stages see the customer demand.

1.4 External demand

Without loss of generality, it is assumed that external demand (i.e., customer demand) occurs only at node N, and d_{N}(t) denotes the demand at stage N in period t. It is assumed that the demand for the end item comes from a stationary process for which the average demand per time period is μ_{N}. It is also assumed that the demand process is bounded by the function D_{N}(τ), for τ=1, 2, 3, . . . M_{N}, where M_{N} is the maximum possible replenishment time for the item. That is, D_{N}(τ)≧d_{N}(t)+d_{N}(t+1)+. . . +d_{N}(t+τ−1) for all t and for τ=1, 2, 3, . . . M_{N}. We define D_{N}(0)=0 and assume that D_{N}(τ) is increasing and concave on τ=dᵢ(t)=φ_{i,i+1}dᵢ₊₁(t), 2, 3, . . . M_{N}. Thus, D_{N}(τ)−D_{N}(τ−1) is nonnegative and decreases as τ increases.

1.5 Internal demand

An internal stage is one with internal customers or successors. In the serial line formulation, these are stages with labels 1, 2, . . . , N−1. For an internal stage, the demand at time t equals the order placed by its immediate successor. Since each stage orders according to a base stock policy, the demand at internal stage i is denoted as dᵢ(t) and given by:

dᵢ(t)=φ_{i,i+1}dᵢ₊₁(t)

for i=1, 2, . . . , N−1 where φ_{i,i+1} denotes the number of units of stage's i's product necessary to produce one unit of stage i+1's product.

It is assumed that the demand at each internal node of the supply chain is also stationary and bounded. The average demand rate for component i is defined as:

μᵢ=φ_{i,i+1}μᵢ₊₁.

We also assume that demand for the component i is bounded by the function Dᵢ(τ), for τ−1, 2, 3, . . . Mᵢ, where Mᵢ is the maximum possible replenishment time for the item. For the serial case, the demand bound at stage i is derived directly from the demand bound at stage i+1.

1.6 Guaranteed service times

Where the interconnected stages are a supply chain, the model of the present invention assumes that the demand node N promises a guaranteed service cost S_{N} by which the stage will satisfy customer demand. Where at least one of the first cost and second cost is a lead-time, the guaranteed service cost is a guaranteed service time S_{N}. For instance, if S_{N}=0, then the stage provides immediate service from inventory to the final customer. If S_{N}>0, then the customer demand at time t, d_{N}(t), must be filled by time t+S_{N}. Furthermore, it is assumed that stage N provides 100% service for the specified service time: stage N delivers exactly d_{N}(t) to the customer at time t+S_{N}. These guaranteed service times for the end items are model inputs.

An internal stage i quotes and guarantees a service time Sᵢ to its downstream stage i+1. Given the assumption of a base-stock policy, stage i+1 places an order equal to φ_{i,i+1}dᵢ₊₁(t) on stage i at time t; then stage i delivers exactly this amount to stage i+1 at time t+Sᵢ. For instance, if Sᵢ=3, then stage i will fulfill at time t+3 an order placed at time t by stage i+1. These internal service times are decision variables for the optimization model, as will be discussed below.

1.7 Single-Stage Single-Option Model

The following discussion presents a model for the inventory at a single stage, where there is only one option available at the stage. The single-stage model serves as the building block for modeling a multi-stage supply chain. Since it is assumed that there is only one option per stage, the option-specific index can be suppressed and denote the production lead-time at stage i by Tᵢ.

Where at least one of the first cost and second cost is lead-time, we have already noted that each stage quotes and guarantees a service time Sᵢ by which stage i will deliver product to its immediate successor. For a serial supply chain, it must also be the case that stage i is being quoted a service time by its upstream supplier. That is, the inbound service time to stage i is the service time that stage i−1 quotes to stage i. By definition, this inbound service time is equal to Sᵢ₋₁. For the case where i=1, we assume that S₀=0; this corresponds to the case where there is an infinite supply of material available to the supply chain.

It will be understood by those skilled in the art that the term “service time” is not intended to be limiting. For example, where neither the first cost and second cost are lead-time, service time would represent the particular numeric quantity that stage i−1 quotes stage i.

1.7.1 Inventory model

In a supply chain, the finished inventory at stage i at the end of period t is defined as Iᵢ(t), where we assume the inventory system starts at time t=0. Under the assumptions of perfect service and a base-stock replenishment policy, Iᵢ(t) can be expressed as:

Iᵢ(t)=Bᵢ−dᵢ(t−Sᵢ₋₁−Tᵢ, t−Sᵢ) (1)

where Bᵢ=Iᵢ(0)≧0 denotes the base stock and where dᵢ(a, b) denotes the demand at stage i over the time interval (a, b]. Since a periodic-review replenishment policy is assumed, then without loss of generality, all time parameters can be expressed as integer units of the underlying time period. Hence, dᵢ(a, b), the demand at stage i over the time interval (a, b], is given by

dᵢ(a, b)=dᵢ(a+1)+dᵢ(a+2)+ . . . +dᵢ(b)

for a<b and dᵢ(t) being the demand observed at stage i in time period t. When a≧b, we define dᵢ(a, b)=0. And for Equation (1) to be true for small t, we define dᵢ(a, b)=dᵢ(0, b) for a<0.

To explain Equation (1), it is observed that the replenishment time for the inventory at stage i is Sᵢ₋₁ +Tᵢ. Thus, in time period t stage i completes the replenishment of the demand observed in time period t−Sᵢ₋₁−Tᵢ. Hence, at the end of time period t, the cumulative replenishment to the inventory at stage i equals dᵢ(0, t−Sᵢ₋₁−Tᵢ). For a given service time Si, in time period t stage i fills the demand observed in time period t−Sᵢ from its inventory. By the end of time period t the cumulative shipments from the inventory at stage i equal dᵢ(0, t−Sᵢ). The difference between the cumulative replenishment and the cumulative shipments is the inventory shortfall, dᵢ(t−Sᵢ₋₁−Tᵢ, t−Sᵢ). The on-hand inventory at stage i is the initial inventory or base stock minus the inventory shortfall, as given by Equation (1).

1.7.2 Determination of base stock

In order to provide 100% service to its customers, it is required that Iᵢ(t)≧0 with probability 1. From Equation (1) it is seen that 100% service requires that

Bᵢ≧dᵢ(t−Sᵢ₋₁−Tᵢ, t−Sᵢ) with probability 1.

Since it is assumed that demand is bounded, the above requirement can be satisfied with the least inventory by setting the base stock as follows:

Bᵢ=Dᵢ(τ) where τ=max {0, Sᵢ₋₁+Tᵢ−Sᵢ}. (2)

By assumption, any smaller value for the base stock can not assure that Iᵢ(t)≧0 with probability 1, and thus cannot guarantee 100% service.

That is, the base stock is set equal to the maximum possible demand over the net replenishment time for the stage. The replenishment time for stage i is the time to get the inputs (Sᵢ₋₁) plus the production time at stage i (Tᵢ). The net replenishment time for stage i is the replenishment time minus the service time (Sᵢ) quoted by the stage. The demand over the net replenishment time is demand that has been filled but that has not yet been replenished. The base stock must cover this time interval of exposure; thus the base stock is set to the maximum demand over this time interval.

It is possible that the promised service time is longer than the replenishment time, i.e., Sᵢ₋₁+Tᵢ<Sᵢ, and thus the net replenishment time is negative. For example, it may take five days for the stage to replenish its inventory, but the promised service time is eight days. In this case, we see from Equation (2) that there is no need for a finished goods inventory; the base stock Bᵢ can be set to zero and still provide 100% service. Indeed, in such a case, the stage would delay each order on its suppliers by Sᵢ−Sᵢ₋₁−Tᵢ periods, so that the supplies arrive when needed.

With no loss of generality, the inbound service time can be redefined so that the net replenishment time is nonnegative. In particular, Sᵢ₋₁ is redefined to be the smallest value that satisfies the following constraints:

Sᵢ₋₁≧Sᵢ for i 1, 2, . . . , N

and

Sᵢ₋₁+Tᵢ≧Sᵢ.

If the inbound service time is such that Sᵢ₋₁>Sᵢ for some i=1, 2, . . . , N, then stage i delays orders from stage i by Sᵢ₋₁−Sᵢ periods.

1.7.3 Safety-stock model

Equations (1) and (2) are used to find the expected inventory level E[Iᵢ], thus:

E[Iᵢ]=BᵢE[dᵢ(t−Sᵢ₋₁−Tᵢ, t−Sᵢ)]=Dᵢ(Sᵢ₋₁+Tᵢ−Sᵢ)−(Sᵢ₋₁+Tᵢ−Sᵢ)μ_{I} (3)

for Sᵢ₋₁+Tᵢ−Sᵢ≧0. The expected inventory represents the safety-stock held at stage i. The safety-stock is a function of the net replenishment time and the bound on the demand process.

1.7.4 Pipeline Inventory

In addition to the safety-stock, the present invention accounts for the in-process or pipeline stock at the stage. Following the argument for the development for Equation (1), it is observed that the work-in-process inventory at time t is given by

Wᵢ(t)=dᵢ(t−Sᵢ₋₁Tᵢ, t−Sᵢ₋₁).

That is, the work-in-process corresponds to Tᵢ periods of demand given the assumption of a deterministic production lead-time for the stage. The amount of inventory on order at time t is

Oᵢ(t)=dᵢ(t−Sᵢ₋₁, t)

where the units of Oᵢ(t) are in terms of finished items at stage i, and denote the amount of component kits on order from stage i−1 to stage i. Similar to the work-in-process, the amount on order equals Sᵢ₋₁ periods of demand.

From Equation (1) it is seen that the finished inventory plus the work-in-process plus the on-order inventory is a constant, namely the base stock. Furthermore, it is seen that the expected work-in-process depends only on the lead-time at stage i and is not a function of the service times:

E[Wᵢ]=Tᵢμᵢ. (4)

1.7.5 Safety-stock cost calculation

Safety-stock cost is a cost associated with holding stock at a stage to protect against variability. The variability may include a variability of demand at the stage. Variability of demand may be based upon a forecast, or it may be based on other user defined criteria. Therefore, to determine the safety-stock cost at stage i, stage i's holding cost must first be determined. Since this present discussion considers only the single-option model for each stage, it is known that the direct costs added at the stage is cᵢ. For the purposes of calculating holding costs, it is necessary to determine the total direct costs that have been added from stage 1 up to and including the current stage. For stage i, denote Cᵢ as the total direct cost added up to and including stage i, i.e., the cumulative cost at stage i. Since the supply chain in the present discussion is a serial line by assumption, Cᵢ is determined by the trivial recursion Cᵢ=Cᵢ₋₁+cᵢ for stages i=1, . . . , N and C₀=0.

If we assume a holding cost rate of α then the per unit holding cost at stage i equals αCᵢ. Therefore, the expected safety-stock cost at stage i equals αCᵢE[Iᵢ].

1.7.6 Pipeline stock cost calculation

The cost of the pipline stock at stage I is equal to the pipeline stock at the stage multiplied by the average value of the stock at the stage. If it is assumed that the costs accrue as a linear function of the time spent at the stage, then the average value of a unit of pipeline stock at stage i equals (Cᵢ₋₁+Cᵢ)/2. This can also be written as Cᵢ₋₁+cᵢ/2. Therefore, the expected pipeline stock cost at stage i equals α(Cᵢ₋₁+cᵢ/2)E[Wᵢ]. This assumption of a linear cost-accrual process approximates the real process. However, it is contemplated that a more complicated function, i.e., a non-linear or multi-linear function, can be used to determine the cost-accrual process if conditions justify this.

1.8 Multi-Stage Multi-Option Serial Supply Chain Model

The discussion above with respect to the single-stage single-option model is now used as a building block to model the expected safety-stock levels and pipeline stock levels across the multi-stage, multi-option, serial supply chain. The consideration of multiple options at a stage does introduce some additional complexity to the formulation. In particular, there is the need to explicitly account for the fact that only one option will be selected at each stage. To do this, a 0-1 indicator variable is introduced, the indicator variable being yij for i=1, 2, . . . , N and 1≦j≦Oᵢ. yᵢⱼ equals 1 if option j is selected for stage i and equals 0 otherwise, i.e., yᵢⱼ=1 implies Oᵢⱼ is selected. Given this additional notation, the model for stage i is formulated as:

$$\begin{matrix}E [ {I}_{i} ] = {\sum }_{j - 1}^{{O}_{i}} {y}_{ij} [ {D}_{i} ( {S}_{i - 1} + {T}_{ij} - {S}_{i} ) - ( {S}_{i - 1} + {T}_{ij} - {S}_{i} ) {μ}_{i} ] & ( 5 ) \\ E [ {W}_{i} ] = {\sum }_{j = 1}^{{O}_{i}} {y}_{ij} {T}_{ij} {μ}_{i} & ( 6 )\end{matrix}$$

yᵢⱼ(Sᵢ₋₁+Tᵢⱼ−Sᵢ)≧0 for 1≦j≦Oᵢ (7)

$${\sum }_{j = 1}^{{O}_{i}} {y}_{ij} = 1 \qquad ( 8 )$$

yᵢⱼε{0, 1} for 1≦j≦Oᵢ (9)

Equation (5) expresses the expected safety-stock as a function of the net replenishment time and demand characterization given that option j is selected at stage i. In Equation (6), the expected pipeline stock equals the mean demand times the selected option's production time. Equation (7) ensures that the net replenishment time is nonnegative. Finally, Equations (8) and (9) require that exactly one option be selected at each stage.

It can be seen from Equations (5)-(9) that the expected inventory in the supply chain is a function of the demand process, the options selected and the service times. It is assumed that the options' production lead-times, and the means and bounds of the demand processes are known input parameters. The guaranteed service time for stage N is also an input. Thus, in any optimization context, the internal service times and options selected are the decision variables.

In order to determine which options and service times are optimal, we need to know how choosing a particular option and service time configuration affects the supply chain's costs. This is the subject of the next section.

1.9 Multi-Stage Multi-Option Objective Function Determination

The formulation of total costs that are relevant to a supply chain configuration problem will now be developed. In a supply chain, there are at least four relevant costs that are considered during the optimization of the supply chain: manufacturing cost, safety-stock cost, pipeline stock cost, and time-to-market costs. Safety-stock cost and pipeline stock cost, which constitute inventory costs, have already been introduced and only need to be modified to handle the addition of multiple options at a stage. The manufacturing cost is equal to the total direct cost of all the units of product that are shipped to consumers. The time-to-market cost is a function of the configuration's longest path.

It will be understood by those skilled in the art that the total costs of manufacturing cost, inventory cost, and time-to-market costs is not intended to be limiting. Rather, and especially where the interconnected stages is a network other than a supply chain, the total costs may be the summation of any quantifiable characteristics that are desired to be optimized.

Note that all four of these costs are influenced by the option chosen at each stage. For example, a supply chain comprising stages with low direct costs and long lead times may have a low cost of goods sold but a high safety-stock cost. To make this statement more rigorous, the direct and cumulative cost added at each stage must first be determined. In particular, the calculation of Cᵢ must take the selected options into account. This is done as follows:

$${C}_{i} = {C}_{i - 1} + {\sum }_{j = 1}^{{O}_{i}} {y}_{ij} {c}_{ij} \qquad ( 10 )$$

for i=1, 2, . . . , N where C₀=0. That is, in general, the cumulative cost (i.e., cumulative first cost) is the sum of the first costs of the preceding stages of at least one option plus the first cost at the given stage associated with a corresponding option. With this cost information, we can now determine the supply chain's cost.

1.9.1 Safety-stock Cost

By definition, safety-stock is held at the end of the stage, after its processing activity has occurred. Therefore, the value of a unit of safety-stock at stage i is equal to the cumulative cost of the product at stage i. The expected safety-stock cost at stage i is:

αCᵢE[Iᵢ] (11)

where α represents the holding cost rate.

1.9.2 Pipeline Stock Cost

The cost of the pipeline stock for stage I is equal to the expected pipeline stock multiplied by the average cost of the product at the stage. Two equivalent cost calculations are shown below:

$$( {C}_{i - 1} + \frac{{\sum }_{j = 1}^{{O}_{i}} {y}_{ij} {c}_{ij}}{2} ) α E [ {W}_{i} ] = ( {C}_{i} + \frac{{\sum }_{j = 1}^{{O}_{i}} {y}_{ij} {c}_{ij}}{2} ) α E [ {W}_{i} ] \qquad ( 12 )$$

1.9.3 Cost of Goods Sold

Cost of goods sold (COGS) (i.e., manufacturing cost) represents the total cost of all the units that are delivered to customers during a company-defined interval of time. Typically, the interval of time is one year. The cost of goods sold is determined by multiplying the end item's annual demand times the end item's unit manufacturing cost. That is,

COGS=βC_{N}μ_{N} (13)

where β is a scalar that converts the model's underlying time unit into the company's time interval of interest; β is the scalar that expresses Equation (13) in the same units as Equations (11) and (12). Recall that the model has an underlying time unit that is common to all stages. For example, if the model's underlying time unit is one day and the company's interval of interest is one year, then we would need to multiply μ_{N} by 365 to get the expected annual volume of the product. This annual volume would then be multiplied by the unit manufacturing cost, C_{N}, to get the expected cost of goods sold per year.

The above derivation of COGS is formulated from the perspective of the end item. For an intuitive understanding of the cost, this is an easier interpretation. However, when formulating the objective function, we will find it useful to divide the cost among the stages in the supply chain. To do this, we note that the cumulative cost at stage N is just the summation of the chosen direct costs at each of the stages. Therefore, COGS can be calculated as follows:

$$COGS = β {\sum }_{i = 1}^{N} {\sum }_{j = 1}^{{O}_{i}} {y}_{ij} {c}_{ij} {μ}_{i} \qquad ( 14 )$$

This formulation is analogous to the echelon stock cost seen in many classic multiechelon inventory works, including Clark and Scarf (1960).

1.9.4 Time-to-Market Cost

Time-to-market cost (TTMC) attaches a dollarized cost to the longest time path in the supply chain. We let τᵢ denote the maximum time for stage i. In general, τᵢ equals:

$${τ}_{i} = {\sum }_{h = 1}^{i} {\sum }_{j = 1}^{{O}_{h}} {y}_{hj} {T}_{hj} \qquad ( s1 )$$

Although the problem formulation is general enough to consider time-to-market costs at all stages, in practice it is common to only associate time-to-market costs with finished goods stages. For a serial line, by definition, the only finished goods stage is stage N. The maximum time for stage N, τ_{N}, equals:

$${τ}_{N} = {\sum }_{i = 1}^{N} {\sum }_{j = 1}^{{O}_{i}} {y}_{ij} {T}_{ij} \qquad ( s2 )$$

That is, for a serial line, the maximum time at stage N equals the sum of the production times at each of the stages in the supply chain.

The target time for stage i is denoted by λᵢ. Time-to-market cost is a function of τᵢ and λᵢ. Let the function Lᵢ(τᵢ, λᵢ) denote the time-to-market cost at stage i. In general, Lᵢ(τᵢ, λᵢ) is of the form:

$${L}_{i} ( {τ}_{i} , {λ}_{i} ) = \{ \begin{matrix}{x ( {λ}_{i} - {τ}_{i} )}^{p} & if {τ}_{i} \leq {λ}_{i} \\ {δ ( {τ}_{i} - {λ}_{i} )}^{p} & if {τ}_{i} > {λ}_{i}\end{matrix} \qquad ( s3 )$$

where χ, δ and p are constants. It will be understood to those skilled in the art that χ, δ and p could be stage dependent, and as such indexed by i. It will also be understood to those skilled in the art that the definition of Lᵢ(τᵢ, λᵢ) in (s3) is merely representative of the types of time-to-market costs seen in practice. The problem framework is general enough to allow any time-to-market cost encountered in the real world, whether it be convex, concave, or discontinuous.

Given this development, the time-to-market cost can be expressed as:

$$TTMC = {\sum }_{i = 1}^{N} {L}_{i} ( {τ}_{i} , {λ}_{i} ) \qquad ( s4 )$$

As a practical matter, if the only relevant time-to-market costs are at stage N, then λᵢ can be set to infinity and χ set to zero for all stages other than stage N.

1.10 Math Programming Formulation

With the inventory calculations discussed above with respect to the multi-stage, multi-option, serial supply chain model (section 1.8) and the formulation with respect to the relevant costs in the supply chain (section 1.9), we are now in a position to formulate an optimization problem for finding the optimal options configuration for the entire serial supply chain, which is shown below as problem P:

$$min {\sum }_{i = 1}^{N} {\sum }_{j = 1}^{{O}_{i}} {y}_{ij} [ {αC}_{i} [ {D}_{i} ( {S}_{i - 1} + {T}_{ij} - {S}_{i} ) - ( {S}_{i - 1} + {T}_{ij} - {S}_{i} ) {μ}_{i} ] + ( {C}_{i} - \frac{{c}_{ij}}{2} ) {αT}_{ij} {μ}_{i} + {βc}_{ij} {μ}_{i} ] + {\sum }_{i = 1}^{N} {L}_{i} ( {\sum }_{h = 1}^{i} {\sum }_{j = 1}^{{O}_{h}} {y}_{ij} {T}_{ij} , {λ}_{i} )$$

$$st$$

$$\begin{matrix}{C}_{i} - {C}_{i - 1} - {\sum }_{j = 1}^{{O}_{i}} {y}_{ij} {c}_{ij} = 0 & for i = 1 , 2 , … , N \\ \begin{matrix}{y}_{ij} ( {S}_{i - 1} + {T}_{ij} - {S}_{i} ) \geq 0 \\ {S}_{N} \leq {s}_{N}\end{matrix} & for i = 1 , 2 , … , N , 1 \leq j \leq {O}_{i} \\ {\sum }_{j = 1}^{{O}_{i}} {y}_{ij} = 1 & for i = 1 , 2 , … , N \\ {y}_{ij} ∈ \{ 0 , 1 \} & for i = 1 , 2 , … , N , 1 \leq j \leq {O}_{i} \\ {S}_{i} \geq 0 and integer & for i = 1 , 2 , … , N \\ {y}_{ij} ∈ \{ 0 , 1 \} & for i = 1 , 2 , … , N , 1 \leq j \leq {O}_{i} \\ {y}_{ij} ( {S}_{i - 1} + {T}_{ij} - {S}_{i} ) \geq 0 & for i = 1 , 2 , … , N , 1 \leq j \leq {O}_{i}\end{matrix}$$

where s_{N} is the guaranteed service time for demand node N, and S_{N} is a user-specified input to the model. Thus, the objective of problem P is to minimize the sum of the supply chain's safety-stock cost, pipeline stock cost, cost of goods sold, and time-to-market cost. The constraints, as described above, assure that exactly one option is chosen per stage, that the net replenishment time for each stage is nonnegative and that Stage N satisfies its service guarantee. The decision variables are the service times and the options selected.

Problem P is an integer nonlinear optimization problem. For a fixed set of feasible yᵢⱼ (corresponding to the case where the user specifies the option selected at each stage) and Lᵢ( ) equal to zero (corresponding to the case where there is no time-to-market cost), it is known in the art (see Graves and Willems (1998)) that the objective function is a concave function provided that the demand bound Dᵢ( ) is a concave function for each stage i. Hence, in the single-option case, we minimize a concave function over a set of linear constraints. Although the feasible region is not necessarily bounded, it can be shown that the optimal service times need not exceed the sum of the production lead-times, provided that the demand bound Dᵢ( ) is a non-decreasing function for each stage i. Thus, the problem for this restricted version of problem P is to minimize a concave function over a closed, bounded convex set. As is known in the art, an optimum for such a problems is at an extreme point of the feasible region (see, e.g., Luenberger, 1973).

1.11 Dynamic Programming Solution Procedure

The serial line case can be solved to optimality using dynamic programming. Below is a construction of the dynamic program's state space and solution procedure.

1.11.1 State space determination

In order to solve the dynamic program efficiently, a state space that allows the algorithm to solve the network in a node-by-node fashion, using only information that is locally available at the node needs to be defined. When there is only one available option per stage, it is known in the art (see Graves and Willems (1998)) how to formulate the dynamic program with a single state variable. The state variable is either the inbound or outbound service time at the stage. The type of service time that is used at a stage depends on the where the stage resides in the network.

The single-option problem only requires one state variable because several key parameters are uniquely determined by the options. In particular, the maximum replenishment time and the cumulative cost at each stage are known constants if there is only one available option per stage. Having a constant cumulative cost is important because this makes the pipeline stock and cost of goods sold deterministic quantities. These two costs do not depend on service times, so the options chosen entirely determine their values. When there is only one option per stage, the maximum time for each stage is also a constant. Therefore, when there is only one available option per stage, the optimization problem simplifies to determining the optimal set of service times that minimize the supply chain's safety-stock cost.

When time-to-market costs are not included in the problem, the multi-option serial supply chain problem can be modeled using two state variables. As shown in Graves and Willems (1998), one state variable will represent the outbound service time at the stage. The additional state variable will be the cumulative cost at the stage. When time-to-market costs are included, as in Problem P, three state variables are needed. The additional state variable is the maximum time associated with the cumulative cost state variable.

As noted in Section 1.2, an option at a stage may be defined as a {direct cost added, production lead-time} pairing. This notion of paired values will translate to the definition of the cumulative cost and maximum time state variables. The set of feasible cumulative costs and maximum times at stage i is defined by the pairing {Xᵢ, Ψᵢ}. Since the cumulative cost and maximum time at stage i is determined by the options selected at stages 1 to i, and there are a finite number of options at each stage, the cumulative cost and maximum time at stage i can only take on a set of discrete values. For example, if stage 1 has two options then it can have at most two pairings of cumulative costs and maximum times. In this case, each possible {cumulative cost, maximum time} pairing is equal to one of stage 1's options. If stage 2 also has two options, then stage 2 can have at most four {cumulative cost, maximum time} pairings, which are created by adding each option's cost element to stage 1's cumulative costs, and adding each option's production time to stage 1's maximum times.

It is also useful to define {XIᵢ, ΨIᵢ} as the set of incoming cumulative costs to stage i. For the serial line supply chain, these are just the cumulative costs at stage i−1. In set notation, {XIᵢ, ψIᵢ}⊂{Xᵢ₋₁, Ψᵢ₋₁}.

1.11.2 Forward recursive formulation

The dynamic program is a forward recursion starting at stage 1 and proceeding to stage N. For each stage, the dynamic program evaluates a functional equation denoted by fᵢ(C, τ, S). The function fᵢ(C, τ, S) is defined as the minimum supply chain cost for node 1 to i given that stage i's cumulative cost is C, stage i's maximum time is τ, and stage i quotes a service time of S.

To develop the functional equation, we first define, in general, the total costs of the interconnected system as a function of state variables. The state variables include the first cost at stage I as a function of the service second-cost quoted to stage I (SI), plus stage I's service second-cost, cumulative first-cost (c), maximum first-cost (τ), and the option (Oᵢⱼ) selected. Where the first cost and second cost are direct cost and lead-time, as discussed above, the state variables thus include cost at stage i as a function of the service time quoted to stage i (SI), plus stage i's service time (S), cumulative cost (C), maximum time (τ), and option (Oᵢⱼ) selected, and the total costs is given by Equation (15) below:

$${g}_{ij} ( SI , C , τ , S ) = α C [ {D}_{i} ( SI + {T}_{ij} - S ) - ( SI + {T}_{ij} - S ) {μ}_{i} ] + ( C - \frac{{c}_{ij}}{2} ) α {T}_{ij} {μ}_{i} + β {c}_{ij} {μ}_{i} + {L}_{i} ( τ , {λ}_{i} ) \qquad ( 15 )$$

gᵢⱼ(SI, C, τ, S) is the summation of the safety-stock cost, pipeline stock cost, direct manufacturing cost, and time-to-market cost contributed by the stage. By observation, gᵢⱼ(SI, C, τ, S) is strictly decreasing in S over the interval 0≦S≦SI+Tᵢⱼ and strictly increasing in SI over the interval [S−Tᵢⱼ]⁺≦SI≦Mᵢ₋₁.

There are four conditions on gᵢⱼ(SI, C, τ, S); one condition corresponding to each of the function's parameters. The first condition is that [S−Tᵢⱼ]⁺≦SI≦τᵢ−Tᵢⱼ. The left inequality constrains the service time quoted to stage i (SI) so that the net replenishment time at stage i is nonnegative. The right inequality restricts the service time at stage i−1 to not exceed the maximum service time that stage i−1 can quote. The second condition is that 0≦S≦SI+Tᵢⱼ. The service time at stage i must be nonnegative and can not exceed the net replenishment time. Third, it is required that the incoming cumulative cost to stage i equal a cost that the upstream configuration can produce. This requires the cumulative cost (C) minus option j's direct cost (cᵢⱼ) to equal a feasible cumulative cost at stage i−1 and the maximum time (τ) minus option j's direct production time (Tᵢⱼ) to equal a feasible maximum time at stage i−1. Thus, for C to be feasible, we must have {C−cᵢⱼ}εXᵢ₋₁ and for τ to be feasible we must have {τ−Tᵢⱼ}εΨᵢ₋₁.

The minimum supply chain cost for stages 1 through i given that stage i utilizes option Oᵢⱼ is now defined. Let fᵢⱼ(C, τ, S) denote this option-specific optimal cost-to-go function, which is defined below:

$${f}_{ij} ( C , τ , S ) = {min}_{SI} \{ {g}_{ij} ( SI , C , τ , S ) + {f}_{i - 1} ( C - {c}_{ij} , τ - {T}_{ij} , SI ) \} \qquad ( 16 )$$

The first term represents the supply chain's costs incurred at stage i and is defined in Equation (15). The second term corresponds to the minimum cost for the stages that are upstream of stage i. For these upstream stages, we include their minimum supply chain costs as a function of stage i−1's service time, SI, maximum time, τ−Tᵢⱼ, and its cumulative cost C−cᵢⱼ. The four conditions on Equation (15) also apply to Equation (16).

The functional equation for fᵢ(C, τ, S) is:

$${f}_{i} ( C , τ , S ) = {min}_{j} \{ {f}_{ij} ( C , τ , S ) \} x \qquad ( 17 )$$

where the minimization is over the options at stage i that are feasible given a cumulative cost of C at stage i, a maximum time of τ at stage i, and a service time of S.

The functional equation is evaluated for all {cumulative cost, maximum time, service time} states that are feasible at stage i. Thus, for each CεXᵢ and τεΨᵢ, we solve for S 0, 1, . . . Mᵢ. Mᵢ, the maximum replenishment time at stage i, is calculated by the recursion Mᵢ=Mᵢ₋₁+max {Tᵢⱼ}. The set Xᵢ is defined by the recursion Xᵢ{xᵢ₋₁+cᵢⱼ|xᵢ₋₁εXᵢ₋₁, j=1 , . . . , Oᵢ} and the set Ψᵢ is defined by the recursion Ψᵢ={ψᵢ₋₁+Tᵢⱼ|ψᵢ₋₁εΨᵢ₋₁, j=1, . . . , Oᵢ}.

To find the optimal solution, it is first noted that the service time at stage N can not exceed s_{N}. Therefore, for each feasible cumulative cost C and maximum time τ at stage N, f_{N}(C, τ, s_{N}) can be evaluated and the option with the minimum cost chosen. By backtracking through the network, as is generally known in the art, the optimal option and service time at each stage can be produced.

The framework for finding the optimal supply chain of a serial line system, as formulated and solved above, now provides the building blocks for finding the optimal supply chain for an assembly network supply chain, described below.

2.0 Assembly Network Formulation

2.1 Network Representation

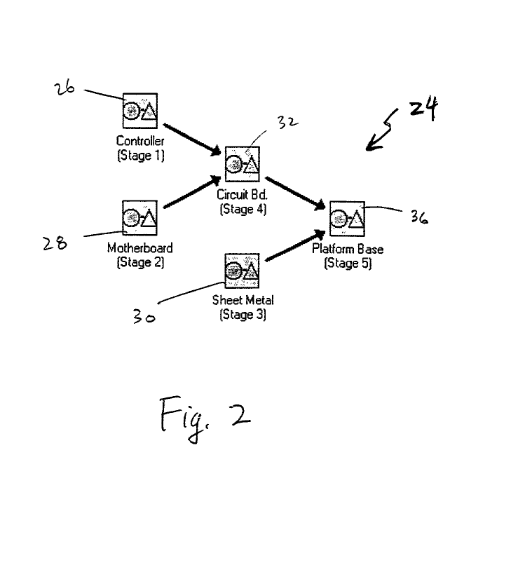

An exemplary assembly network of interconnected stages is one in which each stage can receive inputs from several adjacent suppliers but can directly supply only one downstream stage. FIG. 2 is an example of an assembly network 24. The assembly network of FIG. 2 may be a supply chain. In network terms, an assembly network is a graph where each node can have multiple incoming arcs but only one outgoing arc. We assume the nodes are topologically ordered. That is, for every arc (i, j)εA, i<j. By construction, this implies that the finished goods node will be labeled node N.

Let B(i) denote the set of stages that are backwards adjacent to stage i; B(i)={h:(h, i)εA}. The cardinality of B(i), denoted |B(i)|, equals the number of stages directly supplying stage i.

For each node i we define Ni to be the subset of nodes {1, 2, . . . i} that are connected to i on the sub-graph consisting of nodes {1, 2, . . . i}. That is, Nᵢ is the set of nodes that form an in-tree rooted at node i. The term Nᵢ will be used to explain the dynamic programming recursion, discussed below. The term Nᵢ is determined by the following Equation:

$${N}_{i} = \{ i \} + {⋃}_{h ∈ B ( i )} {N}_{h}$$

An example of the options at each stage of the supply chain of FIG. 2 are shown in Table 2 below.

TABLE 2

| | | | | |
|---|---|---|---|---|
| 1 | 1 | Multinational Supplier | $5 | 10 days |
| 1 | 2 | Local Supplier | $19 | 4 days |
| 2 | 1 | Multinational Supplier | $5 | 10 days |
| 2 | 2 | Local Supplier | $10 | 4 days |
| 3 | 1 | Local Vendor #1 | $15 | 18 days |
| 3 | 2 | Local Vendor #2 | $20 | 10 days |
| 4 | 1 | Manual Assembly | $25 | 10 days |
| 4 | 2 | Automated Assembly | $30 | 8 days |
| 5 | 1 | Low Volume Equipment | $10 | 30 days |
| 5 | 2 | High Volume Equipment | $15 | 15 days |

FIG. 2 represents an example of a supply chain for a subassembly that is created by inserting a circuit board into a metal housing. The circuit board has two main components, a motherboard and a controller. All of the stages have two sourcing options, consisting of a low cost, long lead-time supplier and a higher cost, shorter lead time supplier. Referring to FIG. 2 and Table 2, stage 1 (26) represents the operation of procuring the controller, of which there are two options: a multinational supplier (option 1) and a local supplier (option 2). Each of these options includes a first cost and a second cost. More specifically, option 1 has a direct cost (first cost) of $5 and a lead-time (second cost) of 10 days. Option 2 has a direct cost (first cost) of $10 and a lead-time (second cost) of 4 days. Stage 2 (28) represents the procurement of the motherboard, which has two options. Stage 3 (30) may represent the procurement of sheet metal, which has two options. Stage 4 (32) may represent the assembly of the controller and motherboard onto the circuit board, of which there are two options (manual or automatic assembly). Stage 5 (36) may represent the assembly of the circuit board and the sheet metal housing, of which there are two options, one for low volume equipment and one for high volume equipment.

For the supply chain shown in FIG. 2, Nᵢ is {3} for i=3 and {1, 2, 4} for i=4.

It will be understood to those skilled in the art that the example options in Table 1 and the description of functions at each stage of FIG. 2 are not intended to be limiting, but are rather intended to merely illustrate the possible options and functions at each stage that could be encountered by a manufacturer in a supply chain. Further, although only two options are depicted at each stage, any number of options can be available.

2.2 Stage Notation and Assumptions

The assumptions and notation adopted for the serial line network are equally valid for assembly networks. However, the discussion which follows addresses two differences between the serial line and assembly network cases. First, the notation for the demand process must be redefined now that the network is not a serial line. Second, the incoming service time (i.e., generally, incoming service second cost) to a stage has to be defined since a stage can have several upstream suppliers, each quoting the stage a different service time.

2.2.1 Internal demand

For an internal stage, the demand at time t equals the order placed by its immediate successor. Since each stage orders according to a base stock policy, the demand at internal stage i is denoted as dᵢ(t) and given by:

dᵢ(t)=φᵢⱼdⱼ(t)

where φᵢⱼ denotes the number of units of stage's i's product necessary to produce one unit of stage j's product.

It is assumed that the demand at each internal node of the supply chain is also stationary and bounded. The average demand rate for component i is:

μᵢ=φᵢⱼμⱼ.

It is also assumed that demand for the component i is bounded by the function Dᵢ(τ), for τ=1, 2, 3, . . . Mᵢ, where Mᵢ is the maximum possible replenishment time for the item. For the assembly case, the demand bound at stage i is derived from the demand bound at its downstream adjacent stage j.

2.2.2 Guaranteed service times

Since each stage in a serial line has only one downstream customer, Sᵢ still represents the service time that stage i quotes to its downstream customer. However, the possibility of multiple upstream adjacent stages requires additional notation to characterize the incoming service time quoted to a stage. Let SIᵢ denote the maximum incoming service time quoted to stage i. That is, SIᵢ=max {Sh} for all h such that (h, i)εA. This assumes that stage i must wait until all of its raw materials arrive before it can begin its processing function.

2.2.3 Computation of maximum time at stage i

Because of the added complexity of the three network structures (assembly, distribution, and spanning-tree) compared to the serial structure, the calculation of the maximum time at stage i, τᵢ, is more complex. The maximum time at stage i is the maximum of the maximum time of all stages that directly feed into i plus the time of the selected option at stage i.

$${τ}_{i} = {max}_{h : ( h , i ) ε A} ( {τ}_{h} ) + {\sum }_{j = 1}^{{O}_{i}} {y}_{ij} {T}_{ij}$$

These can be calculated from i=1 up to i=N. That is, in general, the maximum time (i.e., second cost) at stage i is the maximum second cost of the stages that directly feed into a given stage plus the second cost associated with a corresponding option.

2.3 Solution Procedure

2.3.1 Dynamic programming formulation

Generally, as in the serial line formulation discussed above, the state variables for the assembly network formulation are service second cost, maximum second cost, and cumulative first cost. Where the first cost and second cost are a monetary amount (i.e., direct cost) and an amount of time (i.e., lead-time), these state variables are designated as service time, maximum time, and cumulative cost. However, the assembly case is complicated by the fact that different configurations at upstream stages can produce the identical {cumulative cost, maximum time} pairing at the downstream stage. Since these different configurations will have different supply chain costs (i.e., total costs), there is needed a way to efficiently enumerate and evaluate these configurations in order to determine the optimal cost-to-go for the downstream stage. Therefore, before the dynamic programming algorithm can be presented, a new data structure must first be created.

2.3.1.1 Incoming {cumulative cost, maximum time} combinations

The new data structure will be developed for a supply chain and for where the first cost and second cost for the corresponding options are a monetary amount (i.e., direct cost) and an amount of time (i.e., lead-time). However, it will be understood to those skilled in the art that the development below is applicable for any network of interconnected stages and for any option data.

Let CIᵢ denote the incoming cumulative cost to stage i. This is equal to the cumulative cost at stage i, Cᵢ, minus the stage's direct cost added, cᵢⱼ. Let τIᵢ denote the incoming maximum time to stage i. This is equal to the maximum time at stage i, τᵢ, minus the stage's direct cost added, Tᵢⱼ. For the assembly network case, we need a data structure that allocates {CIᵢ, τIᵢ} across the stages in B(i). In the serial network case, the allocation is immediate: CIᵢ=Cᵢ₋₁ and τIᵢ=τᵢ₋₁ since B(i)={i−1}. In the assembly network case, however, a combination at stage i is defined as a set comprising |B(i)| elements, each element corresponding to a feasible cumulative cost for one of the stages in B(i). Combining the elements of the combination will equal the pairing {CIᵢ, τᵢ}.

Let Qᵢ(CI,τ) denote the set of combinations where the summation of each combination equals CI and the greatest maximum time among each of the combinations equals τI. For a combination q⊂Qᵢ(CI,τ), define v_{qh} as the cumulative cost at stage h associated with combination q and w_{qh} as the maximum time at stage h associated with combination q. That is, v_{qh}εXₕ and w_{qh}εΨₕ.

For example, in the supply chain of FIG. 2 and options of Table 2, two combinations produce an incoming cumulative cost of $65 at stage 5. The configurations are {$45, $20} and {$50, $15} where the first term of each combination is the cumulative cost at stage 3 and the second term is the cumulative cost at stage 4. In the notation above: B(5)={3, 4};

|Q₅($65)|=2; Q₅($65)={{$45, $20}, {$50, $15}}; v_={$45 }, v₁₄={$20} and v₂₃={$50}, v₂₄={$15}.

2.3.1.2 Forward recursive formulation

The dynamic program is a forward recursion, starting at stage 1 and proceeding to stage N. For each stage, the dynamic program evaluates a functional equation denoted by fᵢ(C, τ, S). The function fᵢ(C, τ, S) is defined as the minimum supply chain cost for the in-tree rooted at node i given that stage i has a {cumulative cost, maximum time} pairing of {C, τ} and quotes a service time of S.

To develop the functional equation, the supply chain cost for stage i as a function of the maximum service time quoted to stage i (SI), plus stage i's service time (S), cumulative cost (C), maximum time (τ), and option selected (Oᵢⱼ) is first defined in Equation (18) below as:

$${g}_{ij} ( SI , C , τ , S ) = α C [ {D}_{i} ( SI + {T}_{ij} - S ) - ( SI + {T}_{ij} - S ) {μ}_{i} ] + ( C - \frac{{c}_{ij}}{2} ) α {T}_{ij} {μ}_{i} + β {c}_{ij} {μ}_{i} + {L}_{i} ( τ , {λ}_{i} ) \qquad ( 18 )$$

Note that Equation (18) is exactly the same as Equation (15). It is only included here for completeness.

The next step is to characterize the minimum total supply chain cost for each of the sub-networks that are upstream of stage i. That is, the total cost-to-go for each subnetwork Nₕ, where hεB(i), is to be calculated. Let FIᵢ(CI,τI, SI) denote the minimum total upstream cost-to-go given that the {incoming cumulative cost, incoming maximum time} pairing to stage i is {CI,τI} and the maximum incoming service time to stage i is SI. FIᵢ(CI,τI,SI) is defined below as:

$${FI}_{i} ( CI , τ I , SI ) = {min}_{q ∈ {Q}_{i} ( CI , τ )} \{ {\sum }_{h ∈ B ( i )} {f}_{h} ( {v}_{qh} , {w}_{qh} , SI ) \} \qquad ( 19 )$$

Equation (19) finds the minimum total supply chain cost for the in-trees rooted at stage i's upstream adjacent stages. For a given combination q, the function loops over all of the upstream adjacent stages and returns the minimum cost-to-go for each stage given the maximum service time it can quote and its allocated portion of stage i's incoming cumulative cost. The summation of these |B(i)| terms equals the cost of the combination quoting a maximum service time of SI. To find the minimum total supply chain cost, all upstream combinations belonging to the set Qᵢ(CI,τI) must be minimized.

The minimum cost-to-go at stage i, given that stage i utilizes option Oⱼᵢ, will now be defined. Let fᵢⱼ(C, τ, S) denote this option-specific optimal cost-to-go function. It is defined below as:

$${f}_{ij} ( C , τ , S ) = {min}_{SI} \{ {g}_{ij} ( SI , C , τ , S ) + {FI}_{i} ( C - {c}_{ij} , τ - {T}_{ij} , SI ) \} \qquad ( 20 )$$

The first term represents the supply chain costs incurred at stage i and is defined in Equation (18). The second term, defined in Equation (19), represents the minimum total supply chain cost for the subgraph that is upstream adjacent to stage i. Since the {cumulative cost, maximum time} pairing at stage i is {C,τ}, this subgraph's cumulative cost must equal C−cᵢⱼ and its maximum time must equal τ−Tᵢⱼ.

We can now use Equation (20) to develop the functional equation for fᵢ(C, τ, S):

$${f}_{ij} ( C , τ , S ) = {min}_{j} \{ {f}_{ij} ( C , τ , S ) \} \qquad ( 21 )$$

where the minimization is over the available options at stage i. The minimization can be done by enumeration, as is generally known in the art.

The functional equation is evaluated for all {cumulative cost, maximum time, service time} states that are feasible at stage i. Thus, for each CεXᵢ and τεΨᵢ, we solve for S=0, 1, . . . , Mᵢ. In the assembly network, distribution network, and spanning-tree network formulations, Mᵢ, the maximum replenishment time at stage i, is calculated by the recursion:

$${M}_{i} = {max}_{h ∈ B ( i )} ( {M}_{h} ) + {max}_{1 \leq j \leq {O}_{i}} .$$

To find the optimal solution, it is first noted that the service time at stage N can not exceed s_{N}. Therefore, for each feasible cumulative cost C and maximum time τ at stage N, f_{N}(C, τ, s_{N}) can be evaluated and the option with the minimum cost chosen. By backtracking through the network, as is generally known in the art, the optimal option and service time at each stage can be produced.

The framework for finding the optimal supply chain for an assembly network, as formulated and solved above, now provides building blocks for finding the optimal supply chain for a distribution network supply chain, described below.

3.0 Distribution Network Formulation

3.1 Network Representation

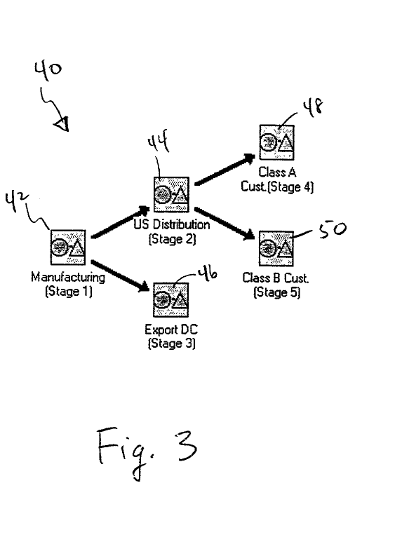

The interconnected stages can be modeled as a distribution network. The distribution network may be a supply chain. A supply chain that can be modeled as a distribution network is one in which each stage can have only one supplier and one or more customers. A distribution network supply chain, designated as reference numeral 40, is shown schematically in FIG. 3. In network terms, a distribution network is a graph where each stage can have multiple outgoing arcs but only one incoming arc. By assumption, the stages (or nodes) are topologically ordered. That is, for every arc (i, j) εA, i<j. By construction, this implies that the raw material stage (or node) will be labeled node 1 (42).

Let D(i) denote the set of stages that are forward adjacent to stage i; D(i)={k:(i, k) εA}. The cardinality of D(i), denoted |D(i)|, equals the number of stages directly served by stage i.

For each node i we define Nᵢ to be the subset of nodes {i, i+1, . . . N} that are connected to i on the sub-graph consisting of nodes {i, i+1. . . N}. We will use Nᵢ to explain the dynamic programming recursion. We can determine Nᵢ by the following Equation:

$${N}_{i} = \{ i \} + {⋃}_{k ∈ D ( i )} {N}_{k} .$$

An example of the options at each stage of the supply chain of FIG. 3 are shown in Table 3 below.

TABLE 3

| Stage | Option | Description | Direct Cost | Lead-time |
|---|---|---|---|---|
| 1 | 1 | Low Volume Equipment | $10 | 30 days |
| 1 | 2 | High Volume Equipment | $15 | 15 days |
| 2 | 1 | 3rd Party Carrier | $3 | 5 |
| 2 | 2 | Premium Carrier | $6 | 2 |
| 3 | 1 | Shipment by Boat | $5 | 30 days |
| 3 | 2 | Shipment by Air | $25 | 3 days |
| 4 | 1 | 3rd Party Carrier | $6 | 10 days |
| 4 | 2 | Premium Carrier | $12 | 3 days |
| 5 | 1 | 3rd Party Carrier | $6 | 10 days |
| 5 | 2 | Premium Carrier | $12 | 3 days |

FIG. 3 represents an example of a supply chain 40 for a product's distribution system. Stage 2 (44) represents distribution of the product domestically, and stage 3 (46) represents exportation of the product. As seen in FIG. 3, for the domestic market, there are two classes of customers, class A, which is represented at stage 4 (48), and class B, which is represented at stage 5 (50), respectively. All of the stages have two sourcing options, shown in Table 3, which include, for example, premium and basic transportation vendors. As indicated by the circles and triangles at the stages, each stage may hold safety-stock and each stage may further process the product, respectfully.

For the supply chain shown in FIG. 3, Nᵢ is {3} for i=3 and {2, 4, 5} for i=2.

It will be understood to those skilled in the art that the example options in Table 3 and the description of functions at each stage of FIG. 3 are not intended to be limiting, but are rather intended to merely illustrate the possible options and functions at each stage that could be encountered by a manufacturer in such the supply chain. Further, although only two options are depicted at each stage, any number of options may be available.

3.2 Additional Stage Assumptions

The assumptions and notation adopted for the serial network are equally valid for distribution networks. However, the demand process and the impact on service times must be clarified.

3.2.1 Demand assumptions

3.2.1.1 External demand

It is assumed that the demand process for each end item behaves in the same manner as the demand process for the single end item in the serial case. It is also assumed that the service time for each external node is bounded. For each stage i that is an external stage, let sᵢ denote the maximum service time the stage can quote.

3.2.1.2 Internal demand

An internal stage is one with internal customers or successors. For an internal stage, the demand at time t is the sum of the orders placed by the immediate successors. Since each stage orders according to a base-stock policy, the demand at internal stage i is given by:

$${d}_{i} ( t ) = {\sum }_{( i , j ) ∈ A} {φ}_{ij} {d}_{j} ( t )$$

where A is the arc set for the network representation of the supply chain.

We assume that the demand at each internal node of the supply chain is stationary and bounded. The average demand rate for component i is:

$$μ i = {\sum }_{( i , j ) ∈ A} {φ }_{ij} {μ}_{j} .$$

It is assumed that demand for the component i is bounded by the function Dᵢ(τ), for τ=1, 2, 3, . . . Mᵢ, where Mᵢ is the maximum replenishment time for the item. This bound may be a given input or it may be derived from the demand bounds for the downstream, or customer, stages for stage i, as generally known in the art. (See Graves and Willems (1998)).

3.2.2.1 Service times

3.2.2.2 Internal service times

An internal stage i quotes and guarantees a service time Sᵢⱼ for each downstream stage j, (i, j) εA.

For the initial development of the model, it is assumed that stage i quotes the same service time to all of its downstream customers; that is, we assume that Sᵢⱼ=Sᵢ for each downstream stage j, (i, j) εA. A method to extend the model to permit customer-specific service times is generally known in the art. (See Graves and Willems (1998)). In brief, if there is more than one downstream customer, zero-cost, zero production lead-time dummy nodes can be inserted between a stage and its customers to enable the stage to quote different service times to each of its customers. The stage quotes the same service time to the dummy nodes and each dummy node is free to quote any valid service time to its customer stage.

The service times for both the end items and the internal stages are decision variables for the optimization model. However, as a model input, bounds on the service times for each stage may be imposed. In particular, it is assumed that for each end item a maximum service time is given as an input.

3.3 Solution Procedure

3.3.1 Dynamic programming formulation

The state variables for the distribution network formulation are service second cost, maximum second cost, and cumulative first cost. Where the first cost and second cost are a monetary amount (i.e., direct cost) and an amount of time (i.e., lead-time), these state variables may be designated as service time, maximum time, and cumulative cost, respectively. However, in contrast to the serial and assembly network cases, the service time state variable refers to the incoming service time quoted to the stage. That is, the incoming service time is the time (i.e., second cost) that a preceding stage quotes fulfillment to a given stage. Thus, an outgoing service time is the time (i.e., second cost) of an option that a given stage quotes fulfillment to a successive stage. Also, in contrast to the serial and assembly network cases, the {cumulative cost, maximum time} pairing refers to the incoming cumulative cost and incoming maximum time to the stage.

Although the Qᵢ(C, τ) data structure is developed for the assembly network case, it is not necessary for distribution networks. Since each stage only has one upstream supplier, the option selected at the current stage uniquely determines the incoming cumulative cost to the stage.

3.3.1 Recursive formulation

In contrast to the previous two sections, in the distribution network the algorithm proceeds from the leaves of the network and works back towards the node with no incoming arcs. For each stage, the dynamic program evaluates a total cost function. The total cost functional equation is denoted by Fᵢ(CI, τI, SI). The function Fᵢ(CI, τI, SI) is defined as the minimum supply chain cost for the out-tree rooted at node i given that stage i's incoming cumulative cost is CI, maximum incoming time is τI, and stage i is quoted a service time of SI.

To develop the functional equation, the supply chain cost for stage i as a function of the maximum service time quoted to stage i, plus stage i's service time, cumulative cost and option selected is first defined, as:

$${g}_{ij} ( SI , C , τ , S ) = α C [ {D}_{j} ( SI + {T}_{ij} - S ) - ( SI + {T}_{ij} - S ) {μ}_{i} ] + ( C - \frac{{c}_{ij}}{2} ) α {T}_{ij} {μ}_{i} + β {c}_{ij} {μ}_{i} + {L}_{i} ( τ , {λ}_{i} ) \qquad ( 22 )$$

Note that Equation (22) is exactly the same as Equations (15) and (18). It is only included here for completeness.

The next step is to define the minimum supply chain cost for the out-tree rooted at stage i given that stage i utilizes option Oᵢⱼ Let Fᵢⱼ(C, τ, S) denote this option-specific optimal cost-to-go function, defined below as:

$${F}_{ij} ( CI , τ I , SI ) = {min}_{S} \{ {g}_{ij} ( SI , CI + {c}_{ij} , τ I + {T}_{ij} , S ) + {\sum }_{k ∈ D ( i )} {F}_{k} ( CI + {c}_{ij} , τ I + {T}_{ij} , S ) \} \qquad ( 23 )$$

The first term represents the supply chain costs incurred at stage i and is defined in Equation (22). The second term represents the minimum total supply chain cost for the subgraph that is downstream adjacent to stage i. Since the cumulative cost at stage i is CI+cᵢⱼ and its maximum time is τI+Tᵢⱼ the incoming cumulative cost to each of these downstream customers must equal CI+cᵢⱼ and the incoming maximum time must equal τ+Tᵢⱼ.

There are two conditions on Equation (23). First, if stage i is an internal stage then the service time (S) must be nonnegative and it must not exceed the incoming service time (SI) plus the option's production time (Tᵢⱼ). This condition prevents the net replenishment time from becoming negative. If stage i is an external stage, then the upper bound on S is the minimum of SI+Tᵢⱼ and sᵢ. Second, the {incoming cumulative cost, incoming maximum time} pairing {CI, τI} must be a feasible incoming pairing at stage i. That is, CIεXIᵢ and τIεΨIᵢ.

Equation (23) is now used to develop the functional equation for Fᵢ(CI, τI, SI):

$${F}_{i} ( CI , τ I , SI ) = {min}_{j} \{ {F}_{ij} ( CI , τ I , SI ) \} \qquad ( 24 )$$

where the minimization is over the available options at stage i. The minimization can be done by enumeration, as is known in the art.

The functional equation is evaluated for all {incoming cumulative cost, incoming maximum time, incoming service time} states that are feasible at stage i. Thus, for each CIεXIᵢ and τεΨᵢ, we solve for S=0, 1, . . . , Mᵢ−min (Tᵢⱼ) for 1≦j≦Oᵢ. Mᵢ, the maximum replenishment time at stage i, is calculated by the recursion:

$${M}_{i} = {max}_{h ∈ B ( i )} ( {M}_{h} ) + {max}_{1 \leq j \leq {O}_{i}} ( {T}_{ij} ) .$$

To find the optimal solution, note that there is only one {incoming cumulative cost, incoming maximum time, incoming service time} state at stage 1; by construction this state is {$0, 0, 0}. Therefore, to find the optimal solution the algorithm just picks the option associated with Fᵢ(0, 0, 0) and progress through the network to produce the optimal option and service time at each stage.

The framework for finding the optimal supply chain for distribution network, as formulated and solved above, now provides building blocks for finding the optimal supply chain for a spanning tree network, described below.

4.0 Spanning Tree Network

4.1 Network Representation

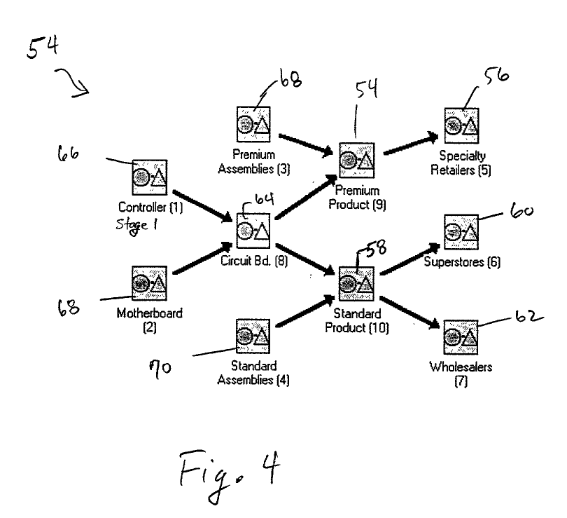

A spanning tree network, generally indicated as reference numeral 54, is shown schematically in FIG. 4. A spanning tree network is a network of interconnected stages that contains N nodes and N-1 arcs. Assembly networks and distribution network are both special cases of spanning trees. Spanning trees allow the flexibility to capture numerous kinds of real world systems, including real world supply chains. Spanning trees can, for example, model supply chain networks where a common component goes into different final assemblies that each have different distribution channels. For example, FIG. 4 illustrates an example of a supply chain with the various functions of the each stage labeled thereon. The premium product, indicated at stage 9 (54) is delivered to specialty retailers at stage 5 (56), while the standard product, indicated at stage 10 (58), is delivered to superstores at stage 6 (60) and wholesalers at stage 7 (62). The common component is the circuit board, indicated at stage 8 (64), which is fed into both stages 9 (54) and 10 58). Stages 1 (66) and 2 (68) represent the procurement of a controller and a motherboard, respectively, of the computer product. Stages 3 (70) and 4 (70) represent premium and standard assemblies, respectively, that are not common to the premium and standard products, respectively. It will be understood to those skilled in the art that description of functions at each stage of FIG. 4 is not intended to be limiting, but are rather intended to merely illustrate the possible functions at each stage that could be encountered in a spanning tree network, and more particularly, in a spanning tree supply chain network.

The following discussion for a spanning tree network, therefore, presents a generalization of the previous three embodiments (i.e., the serial line system, the assembly network, and the distribution network). As before, let B(i) denote the set of backwards adjacent nodes and let D(i) denote the set of forward adjacent nodes. The next step is to label the nodes of the spanning tree.

4.1.1 Node Labeling Algorithm for Spanning Tree

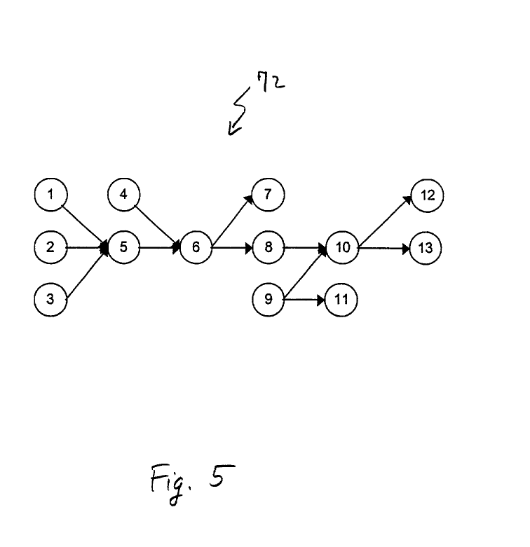

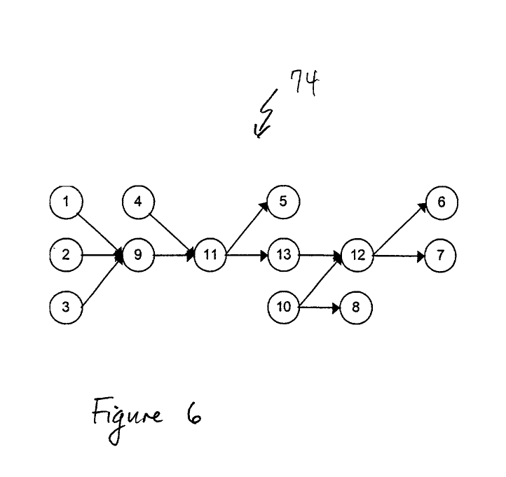

The labeling procedure when an underlying network of the interconnected stages is a spanning tree will now be described. To illustrate the procedure, reference is made to FIGS. 5 and 6. FIG. 5 shows an example of a spanning tree, supply chain, network 72 with the stages numbered sequentially from left to right, from stage 1 to stage 13.

For a spanning tree, there is not a readily apparent ordering of the nodes by which the algorithm would proceed. Therefore, it is desired to sequence or number the nodes so that the algorithm is most efficient. The algorithm for labeling or re-numbering the nodes is as follows:

1. Start with all nodes in the unlabeled set, U.

2. Set k:=1

3. Find a node iεU such that node i is adjacent to at most one other node in U. That is, the degree of node i is 0 or 1 in the sub-graph with node set U and arc set A defined on U.

4. Remove node i from set U and insert into the labeled set L; label node i with index k.

5. Stop if U is empty; otherwise set k:=k+1 and repeat steps 3-4.

For a spanning tree, it is easy to show, as is generally known in the art, that there will always be an unlabeled node in step 3 that is adjacent to at most one other unlabeled node. As a consequence, the algorithm will eventually label all of the nodes in N iterations. Indeed, it can be shown that each node labeled in the first N-1 steps is adjacent to exactly one other node in set U. That is, the nodes with labels 1, 2, . . . N-1 each have one adjacent node with a higher label; define p(k) to be the node with higher label that is adjacent to node k, for k=1, 2, . . . N-1. The node with label N obviously has no adjacent nodes with larger labels.

The above algorithm is thus used to renumber the nodes. For instance, the above algorithm was used to re-number the nodes in FIG. 5 to produce the sub-graph 74 of nodes illustrated in FIG. 6. Note that the labeling is not unique as there may be multiple choices for node i in step 3.

For each node k we define Nₖ to be the subset of nodes {1, 2, . . . k} that are connected to k on the sub-graph consisting of nodes {1, 2, . . . k}. The term Nₖ is used to explain the dynamic programming recursion. Nₖ is determined by the following Equation:

$${N}_{k} = \{ k \} + {⋃}_{i < k , ( i , k ) ∈ A} {N}_{i} + {⋃}_{j < k , ( k , j ) ∈ A} {N}_{j} .$$

For instance, for the sub-graph 74 in FIG. 6, Nₖ is {3} for k=3, {1, 2, 3, 9} for k=9, {1, 2, 3, 4, 5, 9, 11} for k=11 and {6, 7, 8, 10, 12} for k=12. Nₖ can be computed as part of the algorithm for re-numbering the nodes.

For each node i we define Nᵢ to be the subset of nodes {1, 2, . . . i} that are connected to i on the sub-graph consisting of nodes {1, 2, . . . i}. We will use Nᵢ to explain the dynamic programming recursion. We can determine Nᵢ by the following Equation:

$${N}_{i} \{ i \} + {⋃}_{\{ k : k ∈ B ( i ) , k < i \}} {N}_{k} + {⋃}_{\{ k : k ∈ D ( i ) , k < i \}} {N}_{k} .$$

For the spanning tree supply chain shown in FIG. 4, Nᵢ is {1, 2, 8} for i=8 and {4, 6, 7, 8, 10} for i=10.

4.2 Stage Notation and Assumptions

The assumptions and notation adopted for the previous cases are still valid for spanning tree networks. No additional assumptions are necessary. As with the previous embodiments, the discussion and development which follows is directed toward a spanning tree supply chain network. Furthermore, the first cost and second cost of each option of the supply chain are a monetary amount (i.e., direct cost) and an amount of time (i.e., lead-time). However, it will be understood by those skilled in the art that the discussion below is applicable for any spanning tree network and for any first cost and second cost data.

4.3 Solution Procedure

As with the previous network topologies, spanning tree networks can be solved as a three-state dynamic program. However, in the case of a spanning tree, there will be two forms of the functional equation, depending on the node's orientation in the network. The first form is fᵢ(C, τ, S), defined as the minimum total costs for the subgraph Nᵢ given that stage i has a cumulative cost C, a maximum time of τ, and quotes a service time of S. The second form is Fᵢ(CI, τI, SI), defined as the minimum total costs for the subgraph Nᵢ given that stage i's predecessor's outgoing cumulative cost is C, maximum time is τ, and quotes stage i a service time of SI. The first functional equation is a straightforward generalization of the functional equation for assembly networks. The second functional equation is an adaption of the functional equation for distribution networks, where the adaption explicitly considers the differences between spanning trees and distribution networks. Where the spanning tree network is a supply chain, the total costs are the supply chain total costs.

An important property of the node labeling procedure described above is that for each node in the spanning tree, excluding the root node, there is exactly one adjacent node that has a higher label. The root node is the last node that is labeled by the labeling procedure. This adjacent node with a higher label is referred to as the parent node, and the parent node to node i is denoted p(i).

At node i for 1≦i≦N−1, the dynamic programming algorithm will evaluate the total costs as a function of first state variables or second state variables, depending upon the orientation of node i relative to p(i). More specifically, at node i for 1≦i≦N−1, the dynamic programming algorithm will evaluate either fᵢ(C, τ, S) or Fᵢ(CI, τI, SI), depending upon on the orientation of node i relative to p(i). If p(i) is downstream of node i, then the algorithm evaluates fᵢ(C, τ, S), where C, τ, S are the first state variables. If p(i) is upstream of node i, then the algorithm evaluates Fᵢ(CI, τI, SI), where CI, τI, SI are the second state variables. For node N, as will be seen, either functional equation can be evaluated using the second state variables.

4.4 Forward {cumulative cost, maximum time} combinations

Before the functional equations can be developed, a new data structure must be introduced. To some extent, this data structure is an analog to the combination data structure that was introduced in above with respect to incoming {cumulative cost, maximum time} combinations for an assembly network (section 2.3.1.1), where a monetary amount (i.e., direct cost) and an amount of time (i.e., lead-time) are used for the first cost and second cost. In summary, the incoming {cumulative cost, maximum time} combination addressed the fact that multiple upstream configurations could produce the same incoming {cumulative cost, maximum time} pairing at the downstream stage.

In the context of spanning trees, a similar type of situation can arise when evaluating a node with downstream adjacent stages. Recall that when solving distribution networks, if stage i supplies stage k then the incoming cumulative cost at stage k equals the outgoing cumulative cost at stage i and the incoming maximum time at stage k equals the outgoing maximum time at stage i. By the definition of a distribution network, stage i can be the only stage that supplies stage k, and hence there is a one-to-one correspondence between the upstream stage's outgoing {cumulative cost, maximum time} pairing and the downstream stage's incoming {cumulative cost, maximum time} pairing.

However, in the case of a spanning tree, a downstream stage can have more than one supplier. For example, stages i and j can both supply stage k. Therefore, when solving node i, accounting must be made for the following: the incoming {cumulative cost, maximum time} pairing at stage k will not equal the outgoing {cumulative cost, maximum time} pairing at stage i. In fact, it is quite possible that multiple incoming {cumulative cost, maximum time} pairings at stage k can be associated with each outgoing {cumulative cost, maximum time} pairing at stage i.

Let Rᵢₖ(C, τ) denote the set of incoming {cumulative cost, maximum time} pairings at stage k that are feasible if stage i's outgoing {cumulative cost, maximum time} pairing is {C, τ}. Rᵢₖ(C, τ) is defined for each kεD(i) and CεXᵢ, τεΨᵢ.

To relate the forward {cumulative cost, maximum time} combination to the incoming {cumulative cost, maximum time} combination, it is noted that {CI, τI}εRᵢₖ(C, τ) implies there exists a qεQₖ(CI, τI) such that v_{qi} equals C and w_{qi} equals τ. Whereas the incoming {cumulative cost, maximum time} combination acts to tie all of a stage's upstream adjacent stages together, the forward {cumulative cost, maximum time} combination individually relates a stage to its downstream adjacent customers. This difference is due to the fact that when solving a stage involves evaluating a forward adjacent stage, all of the stages adjacent to the forward stage, besides the current stage, have already been solved. By definition of the solution procedure, a forward adjacent stage will only be evaluated if it has already been solved. And when a node is solved, it can have at most one adjacent node unsolved. Therefore, there is nothing besides the current stage being solved that relates the forward stages to one another.

4.3.1 Redefinition of Incoming {cumulative cost, maximum time} combinations

In the assembly network formulation, Qᵢ(CI, τ) denotes the set of combinations where the summation of each combination equals CI and the greatest maximum time among each of the combinations equals τI. For spanning trees, we have to modify the definition of Qᵢ(CI, τ). In particular, Qᵢ(CI, τ) will only include nodes that have a label lower than stage i. This means that Qᵢ(CI, τ) can not contain stage i's predecessor stage. If stage i's predecessor is downstream of stage i, then all of stages upstream adjacent of stage i have already been solved and they are all included in Qᵢ(CI, τ). However, if stage i's predecessor is upstream of stage i, this stage is excluded from all calculations of Qᵢ(CI, τ). In fact, this stage will have its own version of Qᵢ(CI, τ) which is denoted Pᵢ(CI, τ). If stage i's predecessor is upstream, then Pᵢ(CI, τ) translates all of the possible outgoing {cumulative cost, maximum time} pairings from the predecessor into incoming {cumulative cost, maximum time} pairings at stage i. One skilled in the art will recognize that this transformation is immediate since the predecessor stage is the only stage that comprises Pᵢ(CI, τ).

In summary, for spanning trees we have to partition the original Qᵢ(CI, τ) into two sets. The new Qᵢ(CI, τ) is defined as before with the exception that the predecessor's information is excluded if it is upstream of stage i; note that if the predecessor is downstream of stage i, it would not be included in the original definition of Qᵢ(CI, τ). If the predecessor is upstream of stage i, then its {cumulative cost, maximum time} pairings are defined in Pᵢ(CI, τ). If the predecessor is downstream of stage i, then Pᵢ(CI, τ) is empty.

4.3.2 Functional Equation development

The total costs (i.e., the total supply chain costs) for the subgraph rooted at stage i as a function of the first state variables, where the first state variables are stage i's incoming service time (SI), outgoing cumulative cost (C), outgoing maximum time (τ), outgoing service time (S), and option selected (Oᵢⱼ), is first be determined, as follows:

$${z}_{ij} ( SI , C , τ , S ) = {g}_{ij} ( SI , C , τ , S ) + {min}_{q ∈ {Q}_{i} ( C - {c}_{ij} )} \{ {\sum }_{\{ h : h ∈ B ( i ) , h < i \}} {f}_{h} ( {v}_{qh} , {w}_{qh} , SI ) \} + {\sum }_{\{ k : k ∈ D ( i ) , k < i \}} {min}_{\{ CI , τ I \} ∈ {R}_{ik} ( C , τ )} \{ {F}_{k} ( CI , τ I , S ) \} \qquad ( 25 )$$

The first term is the supply chain cost at stage i and has previously been discussed with respect to series line systems; it is Equation (15).

The second term corresponds to the nodes in Nᵢ that are upstream of i. The second term consists of the minimum supply chain cost for the configuration upstream of stage i, as a function of the configuration's cumulative cost, maximum time, and service time. The cumulative cost for the configuration is equal to the outgoing cumulative cost at stage i minus stage i's direct cost added, and also excludes the cost added by the predecessor stage if that stage is upstream of stage I (i.e., if Pᵢ(CI, τ) is non-empty). The configuration's maximum time is less than or equal to the maximum time at stage i minus stage i's production time. The incoming service time to stage i (SI) is the maximum service time that is being quoted to stage i. Therefore, SI is an upper bound on the service time that each of the upstream stages can quote. It can be shows that fₕ(C, τ, SI), the supply chain costs for the subgraph with node set Nₕ, is non-increasing in the outgoing service time to node i, and thus, the outgoing service time at h can be equated to the incoming service time at i without loss of generality.

The third term corresponds to the nodes in Nᵢ that are downstream of node i. For each node k that is a customer to node i, we include the minimum supply chain cost at stage k as a function of stage i's contribution to the cumulative cost and maximum time at stage k and the service time i quotes k. The argument S represents the outbound service time for node k, and thus a lower bound for the inbound service time for node k. It can be shown that Fₖ(CI, τI, S), the supply chain costs for the subgraph with node set Nₖ, is non-decreasing in the incoming service time to node k, and thus, the incoming service time at k can be equated to the outgoing service time at i without loss of generality.

The minimum supply chain cost for the subgraph with node set Nᵢ is now used to develop the functional equation for fᵢ(C, τ, S):

$${f}_{i} ( C , τ , S ) = {min}_{j , SI} \{ {z}_{ij} ( SI , C , τ , S ) \}$$

where the minimization is over the feasible set of options and incoming service times. As in the case of Equation (15), the incoming service time is bounded by max (0, S−Tᵢⱼ)≦SI≦Mᵢ−Tᵢⱼ and SI integer. This minimization can be done by enumeration, as is generally known in the art.

The functional equation is evaluated for all possible integer outgoing service times and feasible {cumulative cost, maximum time, service time} states for node i. That is, for S=0, 1, . . . , Mᵢ and CεXᵢ and τεΨᵢ.

The functional equation for Fᵢ(CI, τI, SI) is of a similar structure:

$${F}_{i} ( CI , τ I , SI ) = {min}_{j , S} \{ {z}_{ij} ( SI , CI + {c}_{ij} , τ I ++ {T}_{ij} , S ) \}$$

The minimization is over the feasible set of options and outgoing service times. If i is an internal stage, then the feasible set is 1≦j≦Oᵢ and S=0, 1, . . . Mᵢ. If i is an external stage, then S=0, 1, . . . , Mᵢ.

The functional equation is evaluated for all possible integer incoming service times and feasible incoming {cumulative costs, maximum time} for node i. That is, for CIεXIᵢ, τIεΨIᵢ, and SI=0, 1, . . . , Mᵢ−min {Tᵢⱼ} for 0≦j≦Oᵢ.

4.3.3 Dynamic programming algorithm

The dynamic programming algorithm is now as follows:

1. For i:=1 to N−1

2. If p(i) is downstream of i, evaluate fᵢ(C, τ, S) for S−0, 1, . . . Mᵢ and CεXᵢ and τεΨᵢ.

3. If p(i) is upstream of i, evaluate Fᵢ(SI, τI, CI) for SI−0, 1, . . . Mᵢ−min{Tᵢⱼ} and CIεXlᵢ and τIεΨIᵢ.

4. For i:=N evaluate Fᵢ(SI, τI, CI) for SI=0, 1, . . . Mᵢ−min{Tᵢⱼ} and CIεXIᵢ and τIεΨIᵢ.

5. Minimize F_{N}(SI, τI, CI) for SI=0, 1, . . . M_{N}−min{T_{Nj}} and CIεXI_{N} and τIεΨIᵢ, to obtain the optimal objective function value.

This procedure finds the optimal objective function value; to find an optimal set of options and service times entails the standard backtracking procedure for a dynamic program, as is generally known in the art.

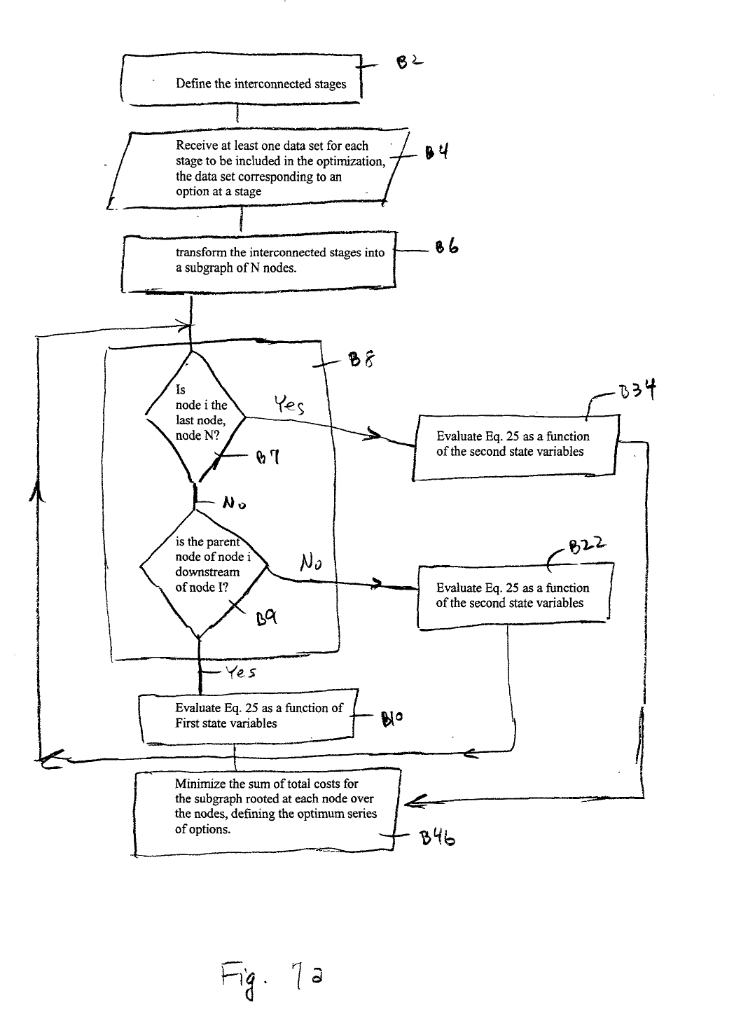

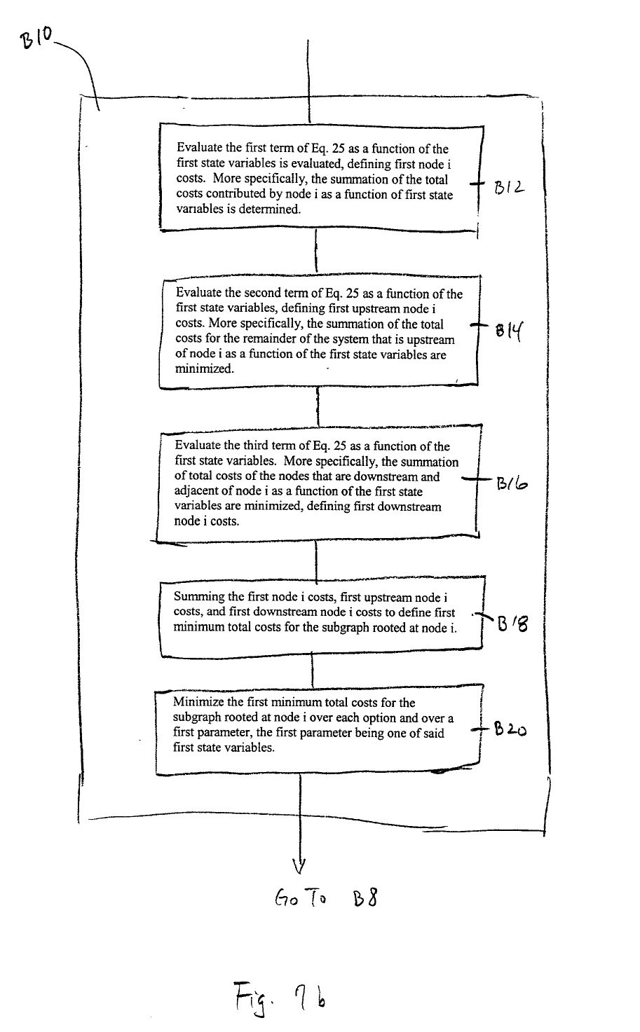

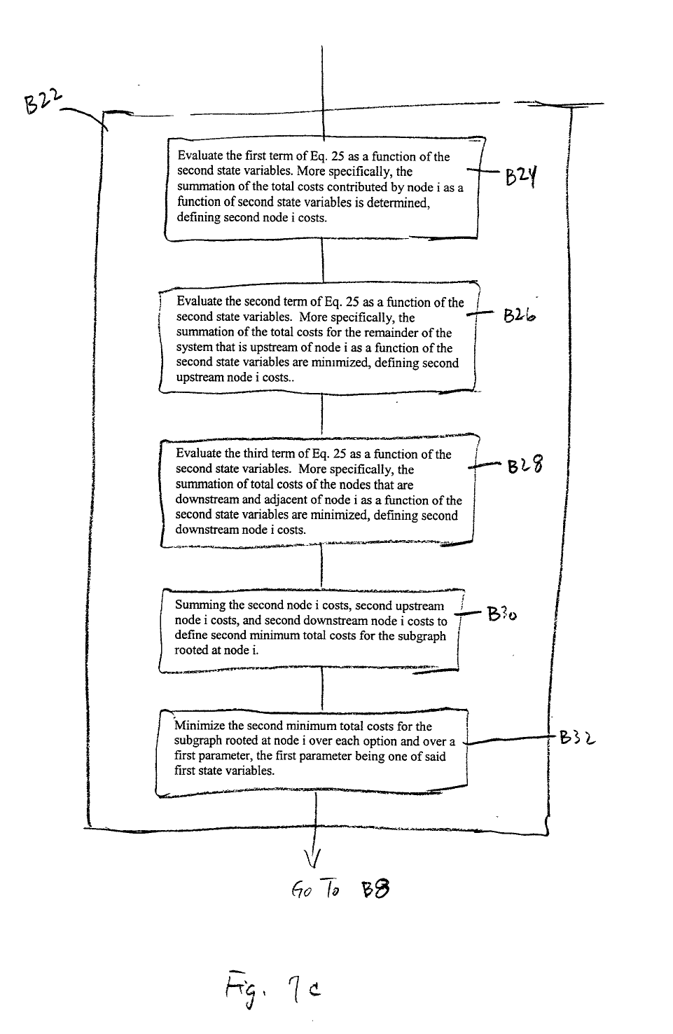

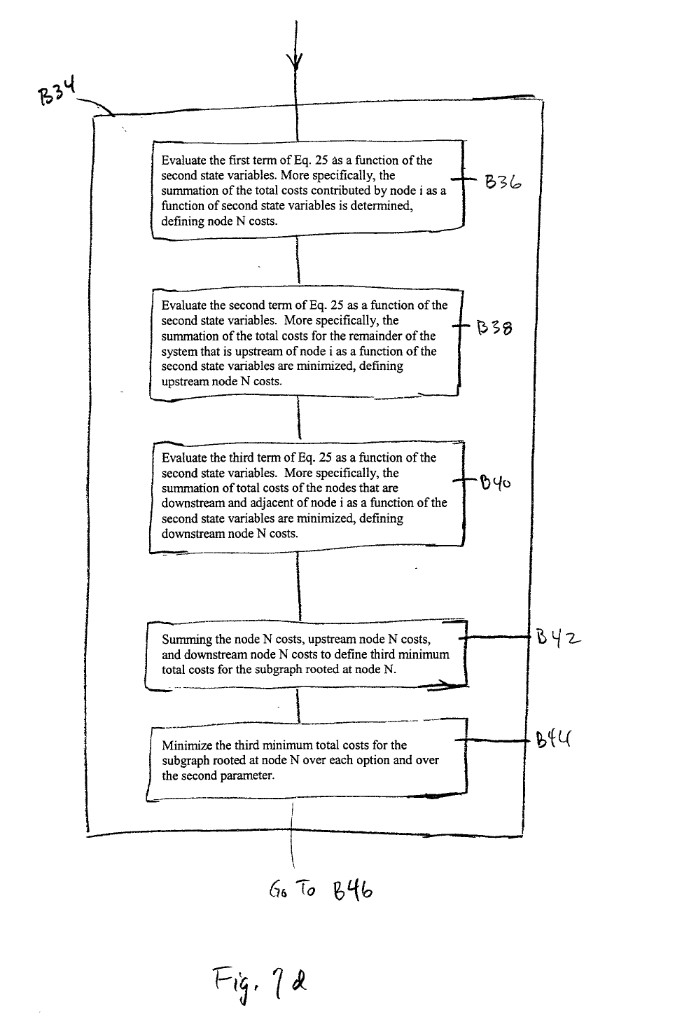

The above method for determining, based upon the at least one data set for each option received, an optimum series of options over a series of the stages by selecting a single option at each stage in the series of the stages that minimizes the sum of total costs over the series of the stages, wherein the total costs is a function of the data sets, are further summarized using a flowchart illustrated in FIGS. 7a-7d. In an embodiment, a method of the present invention as shown in FIGS. 7a-7d may be implemented using a computer system such as, for example, computer system 200 as set forth herein and configured to perform the processing steps as specified in FIGS. 7a-7d.

At B2, the network of interconnected stages are defined. The interconnected stages may be defined using a graphical user interface, which is discussed in detail below in Section 6.0. The series of stages used in the optimization may include all of the stages defined, or may include a single stage.

With the interconnected stages defined, B4 receives at least one data set for each of a plurality of interconnected stages, each of the at least one data set corresponding to an option at the corresponding stage. Each data set includes a first cost and a second cost. The at least one data set may include a plurality of data sets.

At B6, the series of stages of the system are transformed into a subgraph of numbered nodes such that each node corresponds to a stage and each node, except a last node, has only one adjacent node to it that has a higher node number, said one adjacent node having said higher node number being a parent node, the first node of said subgraph being node i=1, the last node being node i=N, each node, except the last node, having a corresponding parent node.

Proceeding in sequential order from node=i to node=N−1, a determination (at B9) of whether the corresponding parent node for node i is downstream or upstream of node i is made at B8, or if node i is the last node (at B7), node N. When the corresponding parent node for node i is downstream thereof, Equation 25 (the total costs) is evaluated as a function of the first state variables at B10. At B12, the first term of Equation 25 as a function of the first state variables is evaluated. More specifically, the summation of the total costs contributed by node i as a function of first state variables is determined at B12, thus defining first node i costs. As discussed above, the first state variables are a function of the first cost and the second cost over the nodes.

At B14, the second term of Equation 25 as a function of the first state variables is evaluated. More specifically, the summation of the total costs for the remainder of the system that is upstream of node i as a function of the first state variables are minimized, defining first upstream node i costs.

At B16, the third term of Equation 25 as a function of the first state variables is evaluated. More specifically, the summation of total costs of the nodes that are downstream and adjacent of node i as a function of the first state variables are minimized, defining first downstream node i costs.

At B18, the first node i costs, first upstream node i costs, and first downstream node i costs determined in B12, B14, and B16, respectively, are summed to define first minimum total costs for the subgraph rooted at node i. It will be understood to those in the art that the order in which B12, B14, and B16 are carried out is immaterial.

At B20, the first minimum total costs for the subgraph rooted at node i are minimized over each option and over a first parameter. The first parameter is one of the first state variables. More specifically, the first parameter is the incoming service second cost. Where the second cost is an amount of time, the incoming service second cost is an incoming service time.

When the corresponding parent node for node i is upstream thereof, Equation 25 (the total costs) is evaluated as a function of the first state variables at B22. At B24, the first term of Equation 25 is evaluated as a function of the second state variables. More specifically, the summation the total costs contributed by node i as a function of the plurality of second state variables are minimized, defining second node i costs. The second state variables are a function of the first state variables.

At B26, the second term of Equation 25 is evaluated as a function of the second state variables. More specifically, the summation of said total costs for the remainder of the system that is upstream of node i as a function of the plurality of second state variables are minimized, defining second upstream node i costs.

At B28, the third term of Equation 25 is evaluated as a function of the second state variables. More specifically, the summation of the total costs for the nodes that are downstream and adjacent of node i as a function of the plurality of second state variable are minimized, defining second downstream node i costs.

At B30, the second node i costs, second upstream node i costs, and second downstream node i costs determined at B24, B26, and B28, respectively are summed, defining a second minimum total costs for the subgraph rooted at node i. It will be understood to those in the art that the order in which B24, B26, and B28 are carried out is immaterial.

At B32, the second minimum total costs for the subgraph rooted at node i are minimized over each option and over a second parameter, the second parameter being one of the second state variables. The second variable may be an outgoing second cost. Where the second cost is an amount of time (i.e., lead-time), the outgoing service second cost is an outgoing service time.

For the last node, when node i=N, Equation 25 is evaluated as a function of the second state variables at B34. At B36, the first term of Equation 25 is evaluated as a function of the second state variables. More specifically, the summation the total costs contributed by node N as a function of the plurality of second state variables are minimized, defining node N costs.

At B38, the second term of Equation 25 is evaluated as a function of the second state variables. More specifically, the summation of the total costs for the remainder of the system that is upstream of node N as a function of the plurality of second state variables are minimized, defining upstream node N costs.

At B40, the third term of Equation 25 is evaluated as a function of the second state variables. More specifically, the summation of the total costs for the nodes that are downstream and adjacent of node N as a function of the plurality of second state variable are minimized, defining downstream node N costs.

At B42, the node N costs, upstream node N costs, and downstream node N costs determined at B36, B38, and B40, respectively, are summed, defining a third minimum total costs for the subgraph rooted at node N. It will be understood to those in the art that the order in which B36, B38, and B40 are carried out is immaterial.

At B44, the third minimum total costs for the subgraph rooted at node N are minimized over each option and over the second parameter.

At B46, the option at each node that minimizes the sum of the total costs for the subgraph rooted at each node over the nodes is determined. This determination may be performed by a normal backtracking procedure, as is known in the art. Therefore, at B46, the optimum series of options that minimizes the sum of the total costs is defined.

The above method is applicable for any network of interconnected stages in which total costs are to be optimized as a function of multi-variable inputs (i.e., at least a first cost and a second cost). Generally, the total costs may be the summation of quantifiable characteristics, which are a function of the multi-variable inputs. Where the interconnected stages is a supply chain, each of the stages represents an operation to be performed, the first cost may be a monetary amount associated with performing the operation, the second cost may be an amount of time associated with performing the operation, and the summation of quantifiable characteristics (i.e., total costs) may include at least one of a manufacturing costs, inventory costs, and time-to-market costs, as discussed above. The inventory costs may include safety-stock costs and pipeline stock costs.

5.0 Supply chain example

The following discussion presents a real world example for the supply chain configuration problem. In the following example, time-to-market costs are not considered. First, a company's current (hereinafter “the company”) supply chain design process is presented. Then, a realistic example and the associated analysis is presented. Lastly, some general results and conclusions from this work is presented. The example which follows is not intended to be limiting, but is provided only to illustrate the methodology of the present invention.

5.1 Current process description

A company currently employs a “target costing” approach when designing new product supply chains. A target costing approach is generally known in the art, and thus will not be described in significant detail. (See Ansari and Bell (1997)). In brief, the market price for the product is set outside of the product design group. Two common reasons for setting the price outside the product design group are: 1) when the product faces many competitors, implying that the firm will be a price taker, and 2) when another department within the company, for example, marketing, specifies the product's selling price. Next, a gross margin for the product is specified, typically by senior management or corporate finance. The combination of the prespecified selling price and the gross margin target dictate the product's maximum unit cost.

The product design team uses the maximum unit cost as an upper bound on the product's unit manufacturing cost (UMC). UMC is defined as the sum of the direct costs associated with the production of a single unit of product. Typical costs include raw material costs, the processing cost at each stage, and transportation costs. The UMC acts as an overall budget for the product, and this budget is then allocated to each of the product's subassemblies.

From an organizational perspective, the supply chain development core team is composed of an early supply chain enabler and one or two representatives associated with each of the product's major subassemblies. The early supply chain enabler is responsible for shepherding the product through the product development process. She is brought in during the early design phase and will stay with the project until it achieves volume production.

The core team will allocate the UMC across the major subassemblies. This is not an arbitrary process. The team will rely on competitive analysis, past product history, future cost estimates, and value engineering when making these decisions. Once the subassembly budgets are set, the design teams for each subassembly are charged with producing a subassembly that can provide the functionality required subject to the subassembly's budget constraint. Even if these groups incorporate multidisciplinary teams and concurrent engineering, the groups will still be operating within their own budget constraints.

In much the same way that the UMC is allocated to the subassemblies, each subassembly group must then determine what processes and components to use. There are numerous factors to consider when sourcing a component, some of which include functionality, price, vendor delivery history, vendor quality and vendor flexibility.

Since many of these factors are difficult to quantify, the team establishes a minimum threshold for each of the intangible factors. If a component exceeds each of the thresholds, then it can be considered. In the context of the supply chain configuration problem, an option will be defined as a {cost added, production lead-time} pairing that satisfies all of the company's intangible factors.

The company's current practice can be described as choosing the component with the least unit cost among all of the components that can be considered. In the framework of the supply chain configuration problem, this corresponds to choosing the option with the least cost added at each stage, regardless of its production lead time. This practice minimizes the product's UMC. While this is admittedly a heuristic, there are several reasons why the company does this. First, as mentioned earlier, all of the other factors besides cost are difficult, if not impossible, to quantify. For example, the company only wants to do business with suppliers that have been certified. The certification process involves a rigorous review of the supplier's quality practices. But given two certified suppliers, there is no mechanism to view one supplier as superior to the other. Second, the UMC of the product will dictate whether or not the business case to launch the product is successful. If the UMC is not low enough to meet the gross margin target, then the project will be terminated. Therefore, there is tremendous pressure to meet the UMC target. Finally, the team that designs the supply chain is not the same team that has to manage the completed supply chain. Although choosing parts with long lead-times might increase significantly the supply chain's safety-stock requirements, this dynamic has not been explicitly considered during the new product's business case analysis.

5.2 Digital Capture Device Example

The product that is analyzed in the discussion that follows can be described as a digital capture device. The product converts an analog input into a digital form. Both scanners and digital cameras satisfy this high-level description.

The product consists of three major subassemblies: the imager, the circuit board, and the base assembly. The imager captures the analog input. It is the subassembly that distinguishes the product in the marketplace. The imager is created in a four-stage process that begins as raw silicate and ends as a completed charge coupled device (CCD). The circuit board converts the analog input into a digital output. To create the circuit board, components are purchased from external vendors and assembled in-house. The base assembly has two components: the base and an accessory. Both components are purchased from an external vendor. The vendor must first modify the accessory before it can be delivered to the company.

The assembly process for the digital capture device involves fitting together the subassemblies and quality testing. Finally, the product supplies two different markets: US demand and export demand.

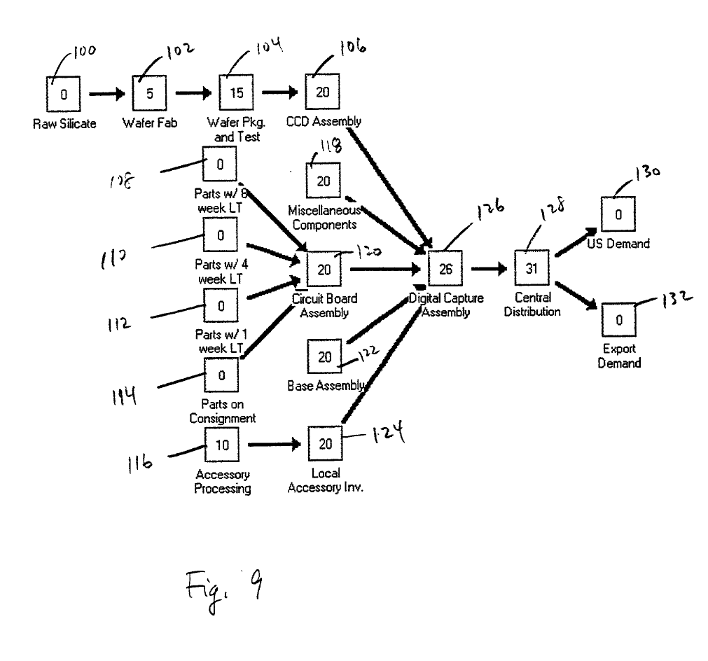

A graphical depiction of the above described supply chain for is shown in FIG. 9. The imager subassembly consists of the four stages, labeled as “raw silicate” 100, “wafer fab” 102, “wafer packaging and test” 104, and “CCD Assembly” 106. Raw silicate is fabricated into imagers which are then packaged and tested. An imager is then mounted onto a stand to form the CCD. The components for the circuit board are grouped into stages 108, 110, 112 according to their traditional procurement lead times. The other stages include “parts on consignment” 114, “accessory processing” 116, “miscellaneous components” 118, “circuit board assembly” 120, “base assembly” 122, and “local accessory inventory” 124. The base assembly and accessory processing are depicted in accordance with their previous descriptions. After the digital capture product is assembled at 126, it then goes through central distribution at 128, from where it satisfies either US 130 or export demand 132.

Table 4 below contains the options available when sourcing the supply chain of FIG. 9.

TABLE 4

| Component/Process Description | Option | Production Time | Cost |
|---|---|---|---|
| Raw Silicate | 1 | 60 | $5.00 |
| | 2 | 20 | $7.50 |
| Wafer Fab | 1 | 30 | $800.00 |
| | 2 | 8 | $825.00 |
| Wafer Pkg. and Test | 1 | 10 | $200.00 |
| | 2 | 5 | $225.00 |
| CCD Assembly | 1 | 5 | $200.00 |
| | 2 | 2 | $250.00 |
| Miscellaneous Components | 1 | 30 | $200.00 |
| Parts w/8 Week LT | 1 | 40 | $105.00 |
| | 2 | 20 | $107.62 |
| | 3 | 10 | $108.96 |
| | 4 | 0 | $110.32 |
| Parts w/4 Week LT | 1 | 20 | $175.00 |
| | 2 | 10 | $177.18 |
| | 3 | 0 | $179.39 |
| Parts w/2 Week LT | 1 | 10 | $200.00 |
| | 2 | 0 | $202.50 |
| Parts on Consignment | 1 | 0 | $225.00 |
| Circuit Board Assembly | 1 | 20 | $225.00 |
| | 2 | 5 | $300.00 |
| Base Assembly | 1 | 70 | $650.00 |
| | 2 | 30 | $665.00 |
| Accessory Processing | 1 | 40 | $100.00 |
| Local Accessory Inv. | 1 | 10 | $60.00 |
| Digital Capture Assembly | 1 | 6 | $420.00 |
| | 2 | 3 | $520.00 |
| Central Distribution | 1 | 5 | $180.00 |
| US Demand | 1 | 5 | $12.00 |
| | 2 | 1 | $25.00 |
| Export Demand | 1 | 11 | $15.00 |
| | 2 | 2 | $40.00 |

The company operates on a five day work week and there are two hundred fifty days in the year. The annual holding cost rate is thirty percent. The company seeks to minimize the total supply chain configuration cost incurred over one year.

For each stage, option 1 reflects the option that was implemented for the existing supply chain. The additional options were judged by the materials management group to reflect {cost added, production lead-time} pairings that were alternatives to the options selected.

For the circuit board's raw materials, the different options refer to different classes of service that the vendor is willing to provide. The head of materials management for the electronics subassembly estimated that the cost of converting an eight week lead-time part to a consignment part would equal 5% of the part's eight week selling price. We used this information to estimate the cost of reducing one week of lead-time for each electronic part as 0.625% of the part's selling price.

As a rule of thumb, the company valued one hour of processing time at a stage at $50 per hour. Recall that the definition of production time includes the waiting time at a stage plus the actual processing time at the stage. Therefore, a slight increase in the processing time at a stage can dramatically reduce the stage's production time. For example, by adding $25 to the cost of wafer fab, the production time was reduced to eight days. A similar analysis was performed for wafer packaging and test, CCD assembly, and the assembly stages.

The two demand stages represent the delivery of product to the company's retail stores. The maximum service time for each of the demand stages equals zero. That is, they must provide immediate service to external customers. In the case of US demand, the product can either be shipped by ground transportation at a cost of twelve dollars and a transportation time of five days or it can be shipped by air at a cost of twenty five dollars with a one day transportation time. Export demand can be satisfied in a similar manner, albeit with different costs and transportation times.

The current product is an improved version of an existing product. Therefore, the company used the previous product's sales as well as market forecasts when determining the demand requirements for the supply chain. For US demand, the mean daily demand and standard deviation of demand were estimated as 15 and 9. For Export demand, the estimates were 4 and 2, respectively. At each of the demand stages, the demand bound was estimated as:

Dⱼ(τ)=τμ+kσ\sqrt{τ}

where τ is the net replenishment time, and μ and τ refer to the stage's mean and standard deviation of demand. The constant k was chosen to equal 1.645. The supply chain group felt that this demand bound captured the appropriate level of demand that they wanted to configure their system to meet using safety-stock.

5.3 Minimizing UMC heuristic

The minimizing UMC heuristic consists of choosing the option with the lowest cost at each stage. For the example in Table 4, this corresponds to choosing option 1 for each stage (or function). A summary of the costs at the subassembly level is shown below:

| Major Function | Cost | % of Total |
|---|---|---|
| Wafer | $1,205.00 | 31.95% |
| Base Platform | $810.00 | 21.47% |
| CBA | $930.00 | 24.66% |
| Misc | $200.00 | 5.30% |
| Assembly | $420.00 | 11.13% |
| Distribution | $207.00 | 5.49% |
| Total | $3,772.00 | |

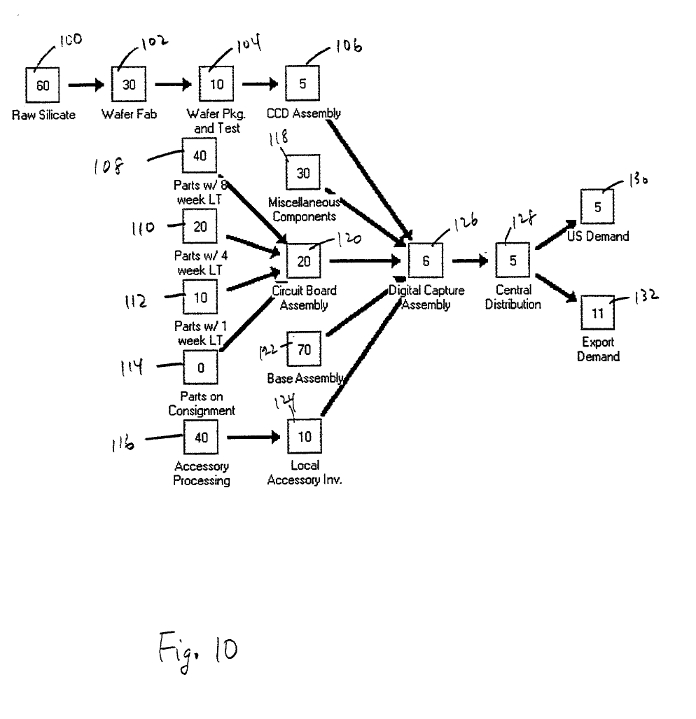

Given that there is only one option at each stage, the only optimization to be done is the optimization of the safety-stock levels across the supply chain, because the expected pipeline stock cost and cost of goods sold are constant when there is only one option per stage. The optimal service times across the supply chain are shown in FIG. 9. As a point of reference, the production times at each stage are shown in FIG. 10.

The optimal safety-stock policy exhibits a dominant path. The dominant path is a serial line that starts at a raw material stage and stretches to the demand stages. Minimizing the service times along this path dictates the service times across the entire supply chain. Stages that are not on the dominant path set their service times as high as possible without changing the net replenishment times for any stages on the dominant path. In the Min UMC supply chain, the dominant path starts at the parts with a one week lead-time and ends at the distribution stages. Since the distribution stages are each linked to the Central Distribution stage, the two external stages share the same dominant path.

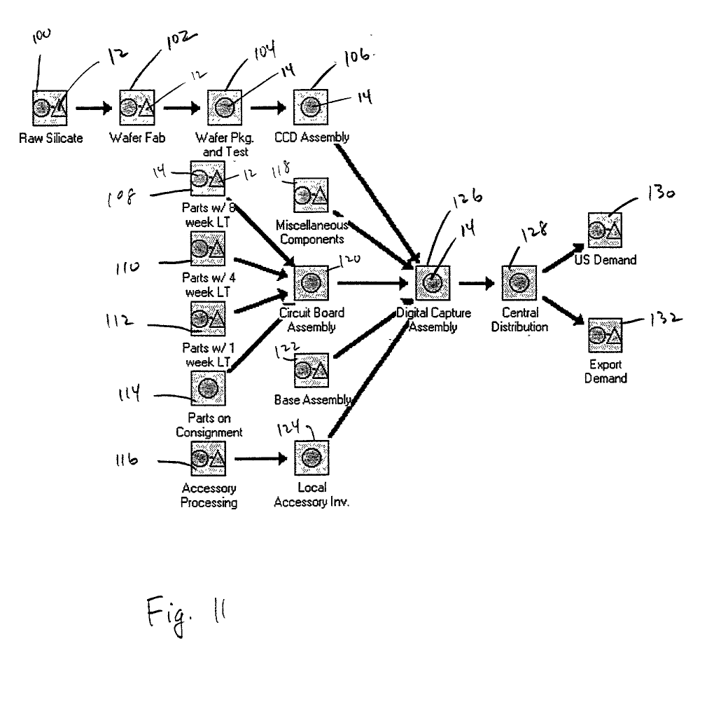

The optimal safety-stock policy is to position several decoupling safety-stocks across the supply chain. FIG. 11 provides a graphical representation of the supply chain's optimal safety-stock policy, where a triangle 12 present at a stage signifies holding safety-stock at that stage. A circle 14 indicates that the stage performs additional processing.

In the figure, a circle 14 denotes a processing operation and a triangle 12 denotes a safety-stock location. Safety-stock is held at both of the demand stages. Since both of these stages must quote a service time of zero, they have to stock inventory. The demand stages are both quoted a service time of 31 days. Given these service times, none of the subassemblies have to hold safety-stock in a completed form. In fact, the safety-stock policies of the subassemblies can best be described as policies that minimize their individual portions of the supply chain given that they can each quote an outgoing service time of 20 days (recall that if they quoted more than 20 days, the net replenishment time of downstream stages like Digital Capture Assembly would have to change). For the circuit board, this translates into storing a safety-stock for each of the raw material stages. For the imager supply chain, the optimal solution is to hold raw silicate and have wafer fab quote a service time of 5. Finally, stages like the accessory and the base assembly quote service times of 20, holding their inventory as far upstream as possible.

A summary of the configuration's costs are shown below in Table 5 (Cost Summary for Min UMC Heuristic).

TABLE 5

| | |
|---|---|
| SS Cost | $178,386 |
| PS Cost | $979,127 |
| COGS | $17,848,750 |
| Total | $19,006,263 |

The safety-stock and pipeline stock costs reflect the company's 30% carrying cost. Therefore, the initial investment in safety-stock and pipeline stock to create the supply chain equals $3,858,376 (this can be seen by dividing the pipeline and safety-stock costs by 0.3). The expected demand over the course of one year is 4,750 units; this is found by multiplying the expected daily demand (19) by the number of days in the year (250). Since a completed unit costs either $3,757 or $3,760, depending on the customer region, COGS dominates the total supply chain configuration cost.

5.4 Minimizing production time heuristic

The minimizing production time heuristic chooses the option at each stage with the least production time. This corresponds to choosing the option with the highest index for each function in Table 4. A summary of the costs at the subassembly level is shown below in Table 6.

TABLE 6

| Major Function | Cost | % of Total |
|---|---|---|
| Wafer | $1,307.50 | 31.78% |
| Base Platform | $825.00 | 20.05% |
| CBA | $1,017.21 | 24.72% |
| Misc | $200.00 | 4.86% |
| Assembly | $520.00 | 12.64% |
| Distribution | $245.00 | 5.95% |
| Total | $4,114.71 | |

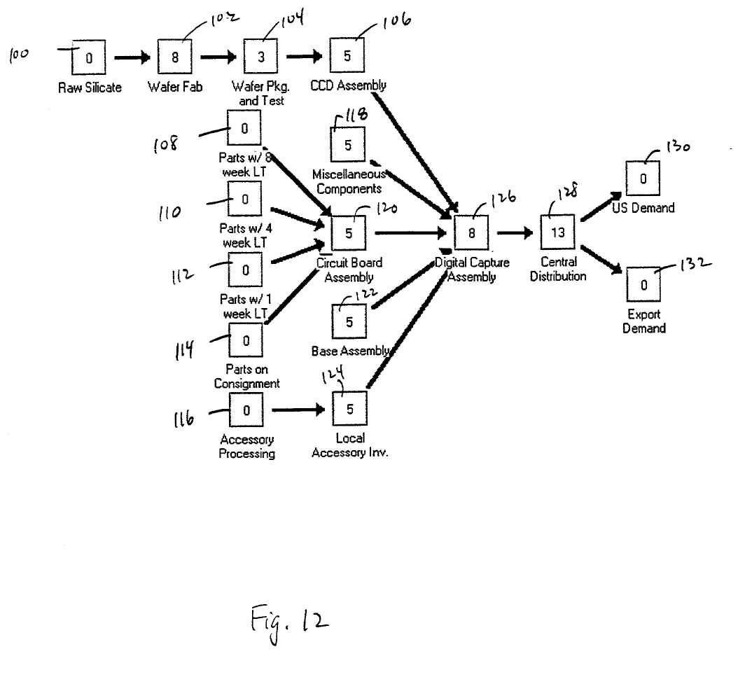

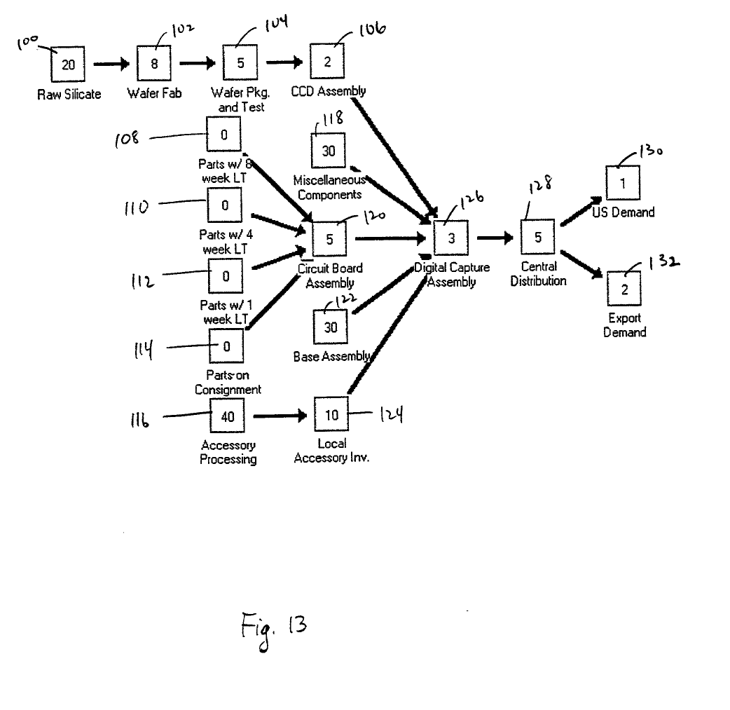

Like the minimum UMC heuristic, the minimum production time heuristic leaves only one option at each stage. The optimal service times across the supply chain are shown in FIG. 12. As a point of reference, the production times at each stage are shown in FIG. 13.

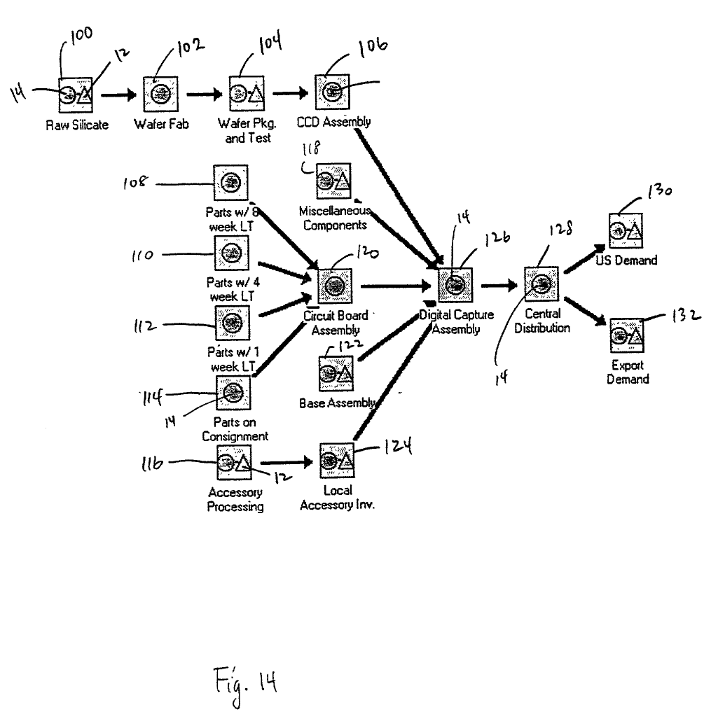

In the Min production time configuration, the dominant path originates at the electronics components and ends at the demand nodes. The optimal stocking policy is represented graphically in FIG. 14. An intuitive explanation for the optimal stocking policy of FIG. 14 is that the minimum production time heuristic causes all of the electronic parts to be held on consignment. Therefore, the compressed lead-time of the entire circuit board assembly makes it attractive to hold as little inventory as possible between the circuit board and the final product; recall that the demand stages must stock inventory due to their service time commitments. The other subassemblies then locally optimize their own portion of the supply chain subject to the constraint that they must quote a service time of 5 or less to Digital Capture Assembly. Since each subassembly's maximum replenishment time is more than 5 days, they will each quote Digital Capture Assembly exactly 5 days. The imager supply chain is the only subassembly that requires optimization; for all the other stages it is either stock or don't stock. The high cost of the Wafer Fabrication makes it optimal to hold as little inventory as possible after the fabrication step.

A summary of the configuration's costs is shown below in Table 7 (Cost Summary for Min Production Time Heuristic).

TABLE 7

| | |
|---|---|
| SS Cost | $122,890 |
| PS Cost | $465,886 |
| COGS | $19,369,873 |
| Total | $19,958,648 |

The safety-stock and pipeline stock costs are dramatically reduced due to the shortened production times across the network. However, this comes at a significant cost since the product's UMC increases by nine percent. The initial investment in safety-stock and pipeline stock to create the supply chain equals $1,962,586 (this can be seen by dividing the pipeline and safety-stock costs by 0.3). The minimum production time heuristic results in a supply chain configuration cost that exceeds the minimum UMC heuristic by $950,000.

5.5 Supply chain configuration optimization

The algorithm presented for a spanning tree is now applied to the supply chain to the above example. The following options that were selected at each stage are shown in Table 8 (Options Selected Using Optimization Algorithm).

TABLE 8

| Component/Process Description | Option | Production Time | Cost |
|---|---|---|---|
| Raw Silicate | 1 | 60 | $5.00 |
| Wafer Fab | 1 | 30 | $800.00 |
| Wafer Pkg. and Test | 1 | 10 | $200.00 |
| CCD Assembly | 1 | 5 | $200.00 |
| Miscellaneous Components | 1 | 30 | $200.00 |
| Parts w/8 Week LT | 3 | 10 | $108.96 |
| Parts w/4 Week LT | 2 | 10 | $177.18 |
| Parts w/2 Week LT | 1 | 10 | $200.00 |
| Parts on Consignment | 1 | 0 | $225.00 |
| Circuit Board Assembly | 1 | 20 | $225.00 |
| Base Assembly | 2 | 30 | $665.00 |
| Accessory Processing | 1 | 40 | $100.00 |
| Local Accessory Inv. | 1 | 10 | $60.00 |
| Digital Capture Device Assembly | 1 | 6 | $420.00 |
| Central Distribution | 1 | 5 | $180.00 |
| US Demand | 2 | 1 | $25.00 |
| Export Demand | 2 | 2 | $40.00 |

In this configuration, the electronic components not held on consignment have a common two week procurement lead-time. Also, the base assembly's lead-time has been shortened to thirty days and the air shipment of finished goods is preferred over the longer ground shipment option.

A summary of the costs at the subassembly level are shown below in Table 9.

TABLE 9

| Major Function | Cost | % of Total |
|---|---|---|
| Wafer | $1,205.00 | 31.45% |
| Base Platform | $825.00 | 21.53% |
| Circuit Board | $936.14 | 24.44% |
| Misc | $200.00 | 5.22% |
| Assembly | $420.00 | 10.96% |
| Distribution | $245.00 | 6.39% |
| Total | $3,831.14 | |

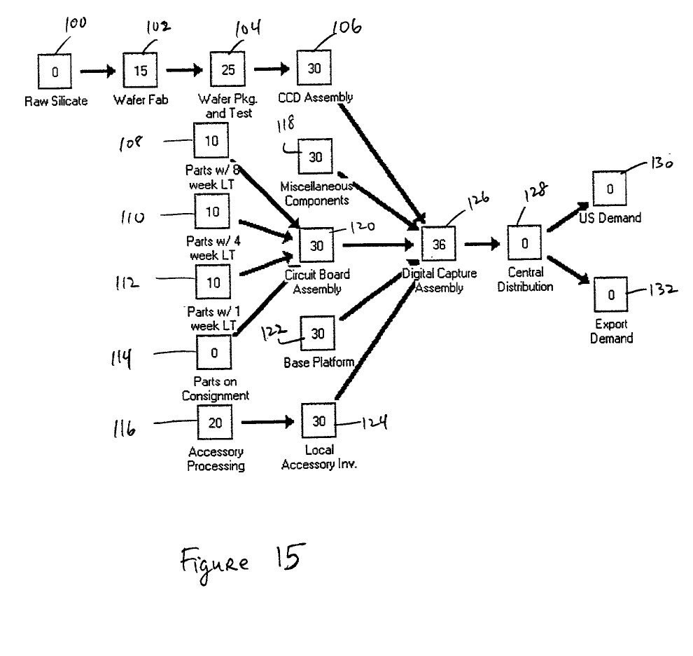

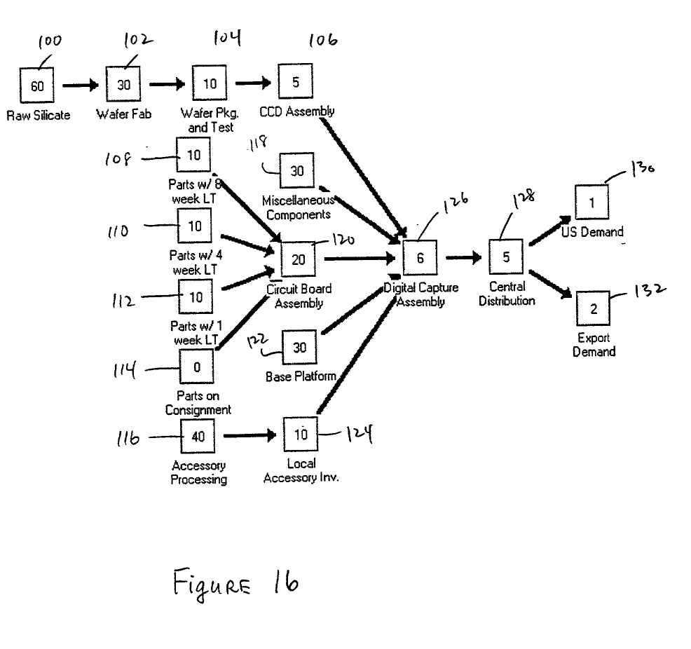

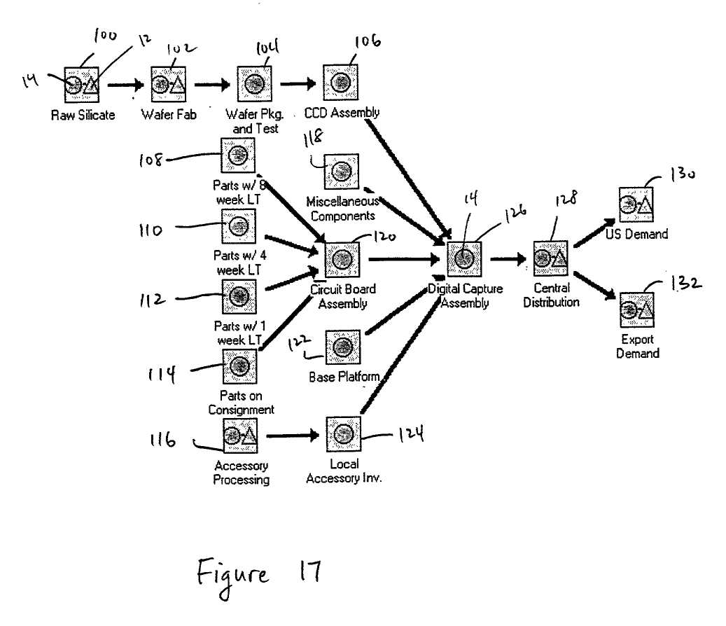

The optimal service times across the supply chain are shown in FIG. 15. As a point of reference, the production times at each stage are shown in FIG. 16. The dominant path still originates at the electronics components and ends at the demand nodes. The optimal stocking policy is represented graphically in FIG. 17.

The optimal policy holds a decoupling inventory at the central distribution center. By holding inventory at the Central Distribution Center, each of the external stages can hold significantly less inventory (since the incoming service time to each of the demand stages equals zero, their net replenishment time equals their production time). The primary reason this is optimal is because the higher shipment costs make it less attractive to hold inventory at the external stages. By choosing a one week production time for each of the electronics components (besides the consignment stage, which is restricted to a zero production time option) and choosing the least production time base platform option, the optimal solution is one where the upstream assemblies are “balanced.” That is, each subassembly is configured in the optimal way to quote a service time of 30 to the Digital Capture Assembly. A summary of the configuration's costs is shown below in Table 10 (Cost Summary for Optimization Algorithm).

TABLE 10

| | |
|---|---|
| SS Cost | $148,254 |
| PS Cost | $700,097 |
| COGS | $18,022,915 |
| Total | $18,871,266 |

The initial investment in safety-stock and pipeline stock to create the supply chain equals $2,827,837. This configuration increases the UMC by 1.6% over the min UMC heuristic but decreases the total configuration cost by $135,000. This represents a per unit savings of $28.42.

To help put this cost savings into perspective, the following chart summarizes the costs for the Min UMC configuration when each stage holds safety-stock (this situation is depicted in Table 11) (Cost Summary for Min UMC Heuristic with Service Times Equal to Zero).

TABLE 11

| | |
|---|---|
| SS Cost | $237,678 |
| PS Cost | $979,127 |
| COGS | $17,848,750 |
| Total | $19,065,555 |

The Min UMC heuristic with service times equal to zero is the most accurate representation of the company's implemented supply chain. The savings generated by optimizing the safety-stock levels without changing the supply chain's configuration equals $59,292 (this optimized case is actually the Min UMC heuristic presented in Section [00327]). The savings generated by jointly optimizing the safety-stock levels and the supply chain's configuration total $194,289. Therefore, jointly optimizing both the configuration and the safety-stock placement will save three times as much as leaving the configuration unchanged and only optimizing the safety-stock placement.

Also, it is important to note that implementing the optimal policy is an extremely easy matter. The difficult step in the supply chain design process is the identification of the parts that exceed all of the intangible requirements. However, this step must be done regardless of which option is eventually chosen. The optimization algorithm just optimally picks among the set of options that are all sufficient to satisfy the product's needs. Finally, it is interesting to note that although the overall UMC has not increased by much, there is no way the design team would have known to pick this configuration. Table 12 summarizes the costs at the subassembly level for the Min UMC heuristic and the Optimization Algorithm's configuration.

TABLE 12

| Major | Subassembly UMC under | Subassembly UMC under | % dif- |
|---|---|---|---|
| Function | Min UMC Heuristic | Optimal Configuration | ference |
| Wafer | $1,205 | $1,205 | 0.00% |
| Base | $810 | $825 | 1.85% |
| Platform | | | |
| Circuit | $930 | $936 | 0.66% |
| Board | | | |
| Misc | $200 | $200 | 0.00% |
| Assembly | $420 | $420 | 0.00% |
| Distri- | $207 | $245 | 18.36% |
| bution | | | |
| Total | $3,772 | $3,831 | 1.54% |

For subassemblies like the base platform, increasing the UMC by $15 is a dramatic increase that would not be authorized without the kind of analysis presented in this section. The same is true of the adoption of premium freight.

The optimization algorithm also neglected to make some choices that the team might have considered “obvious” choices. For example, the higher cost raw silicate option was not selected. Conventional wisdom might have led one to believe that this option would be selected due to the fact that the imager subassembly is an expensive component with a long maximum replenishment time. And with a modest increase in the subassembly's cost, the maximum replenishment time could be significantly shortened. However, the decrease in production time did not offset the subsequent increase in the cost.

5.6 General Conclusions

Based on the current analysis that has been performed, some general hypotheses can be formulated. First, the farther upstream the supply chain, the less likely it will be optimal to choose a significantly higher UMC option. The reason is that choosing the higher cost option not only increases the product's UMC, it also increases the pipeline and safety-stock cost at downstream stages. Furthermore, since these raw materials are in their cheapest state, it is less costly to just hold a safety-stock of raw components, thereby decoupling them from the rest of the supply chain. Therefore, when choosing a higher cost option that is upstream, the savings will have to be truly dramatic to justify the higher UMC.

Second, the larger the number of echelons in the supply chain, the larger the potential significance of this approach. More echelons imply more flexibility in setting up the supply chain. This gives the reduced safety-stock and pipeline stock costs a greater opportunity to outweigh the increase in COGS. This insight should be tempered by the realization that any non-value added steps should be removed wherever possible. Before using the model, a general recommendation would be to remove any non-value added stages from the process.

Finally, given the fact that product life cycles are only getting shorter, it is generally a bad idea to make large investments in creating a supply chain. By making a larger dollar investment in safety-stock and pipeline stock, it can be more difficult to effectively manage the “ramp down” phase of the product's life. In the “ramp down” phase, safety-stock and pipeline stock are drawn out of the system and used to fulfill demand. The goal is to leave as little inventory as possible in the supply chain when the product is terminated; if the effort is completely successful, no inventory will remain.

Since the Min UMC heuristic typically chooses the configuration with the longest lead-times, it requires significant pipeline and safety-stock levels. This is the exact opposite situation that a manager would want to create. However, the desire to create a lower investment supply chain must be balanced against the dramatic increase in cost created by implementing the most responsive supply chain (which can be found by using the Min Production Time heuristic).

The objective of the supply chain configuration problem is to balance these two competing interests. An effective way for managers to strike this balance is through the setting of the holding cost rate. The holding cost rate can be used to help gauge how much risk the company associates with making a large investment in safety and pipeline stock. If the company places a significant cost on making large initial investments in the supply chain, they can attach a higher holding cost rate. This would make the safety-stock cost and pipeline stock cost a much higher total proportion of the configuration cost, thereby acting to mitigate the increase in COGS due to choosing higher cost, lower lead-time options. Conversely, if the company is not concerned about making a large initial investment, they can choose a lower holding cost rate.

To demonstrate this effect, Table 13 (Configuration Cost Summary Table Under Different Holding Cost Rates), below, summarizes the optimal costs for each of the three configuration approaches when the holding cost rate is 15%, 30%, 45% and 60%.

TABLE 13

| | Minimum UMC | Minimum Production | Supply Chain |
|---|---|---|---|
| | Heuristic | Time Heuristic | Configuration Algorithm |
| Holding Cost - 15% | | | |
| Safety Stock Cost | $89,193 | $61,445 | $81,006 |
| Pipeline Stock Cost | $489,563 | $232,943 | $417,484 |
| COGS | $17,848,750 | $19,369,873 | $17,920,000 |
| Total Configuration Cost | $18,427,506 | $19,664,260 | $18,418,489 |
| Investment Cost | $3,858,375 | $1,962,584 | $3,323,262 |
| Length of Longest Path | 127 days | 45 days | 127 days |
| Holding Cost - 30% | | | |
| Safety Stock Cost | $178,386 | $122,890 | $148,254 |
| Pipeline Stock Cost | $979,127 | $465,886 | $700,097 |
| COGS | $17,848,750 | $19,369,873 | $18,022,915 |
| Total Configuration Cost | $19,006,263 | $19,958,648 | $18,871,266 |
| Investment Cost | $3,858,375 | $1,962,584 | $2,827,837 |
| Length of Longest Path | 127 days | 45 days | 118 days |
| Holding Cost - 45% | | | |
| Safety Stock Cost | $267,579 | $184,334 | $222,699 |
| Pipeline Stock Cost | $1,468,690 | $698,828 | $1,010,252 |
| COGS | $17,848,750 | $19,369,873 | $18,051,748 |
| Total Configuration Cost | $19,585,019 | $20,253,035 | $19,284,699 |
| Investment Cost | $3,858,375 | $1,962,584 | $2,739,892 |
| Length of Longest Path | 127 days | 45 days | 118 days |
| Holding Cost - 60% | | | |
| Safety Stock Cost | $356,772 | $245,779 | $270,291 |
| Pipeline Stock Cost | $1,958,253 | $931,771 | $1,254,324 |
| COGS | $17,848,750 | $19,369,873 | $18,170,498 |
| Total Configuration Cost | $20,163,775 | $20,547,423 | $19,695,113 |
| Investment Cost | $3,858,375 | $1,962,584 | $2,541,026 |
| Length of Longest Path | 127 days | 45 days | 96 days |

As the holding cost rate increases, the supply chain configuration algorithm chooses more higher cost, lower production lead-time options. This is demonstrated in the Table 14 (Optimal Supply Chain Configuration Under Different Holding Cost Rates) below.

TABLE 14

| | 15% | 30% | 45% | 60% |
|---|---|---|---|---|
| Raw Silicate | 1 | 1 | 1 | 1 |
| Wafer Fab | 1 | 1 | 1 | 2 |
| Wafer Pkg. and Test | 1 | 1 | 1 | 1 |
| CCD Assembly | 1 | 1 | 1 | 1 |
| Miscellaneous Components | 1 | 1 | 1 | 1 |
| Parts w/8 Week LT | 1 | 3 | 4 | 4 |
| Parts w/4 Week LT | 1 | 2 | 3 | 3 |
| Parts w/2 Week LT | 1 | 1 | 2 | 2 |
| Parts on Consignment | 1 | 1 | 1 | 1 |
| Circuit Board Assembly | 1 | 1 | 1 | 1 |
| Base Assembly | 2 | 2 | 2 | 2 |
| Accessory Processing | 1 | 1 | 1 | 1 |
| Local Accessory Inv. | 1 | 1 | 1 | 1 |
| Digital Capture Device Assembly | 1 | 1 | 1 | 1 |
| Central Distribution | 1 | 1 | 1 | 1 |
| US Demand | 1 | 2 | 2 | 2 |
| Export Demand | 1 | 2 | 2 | 2 |

When the holding cost rate is low, COGS dominates the total configuration cost. Therefore, the minimum cost heuristic produces a solution that is very close to the optimal solution. But as the holding cost rate increases, the supply chain configuration algorithm creates a supply chain that comes closer to creating the supply chain created using the minimum production time heuristic.

6.0 Machine Implementation and Graphical User Interface

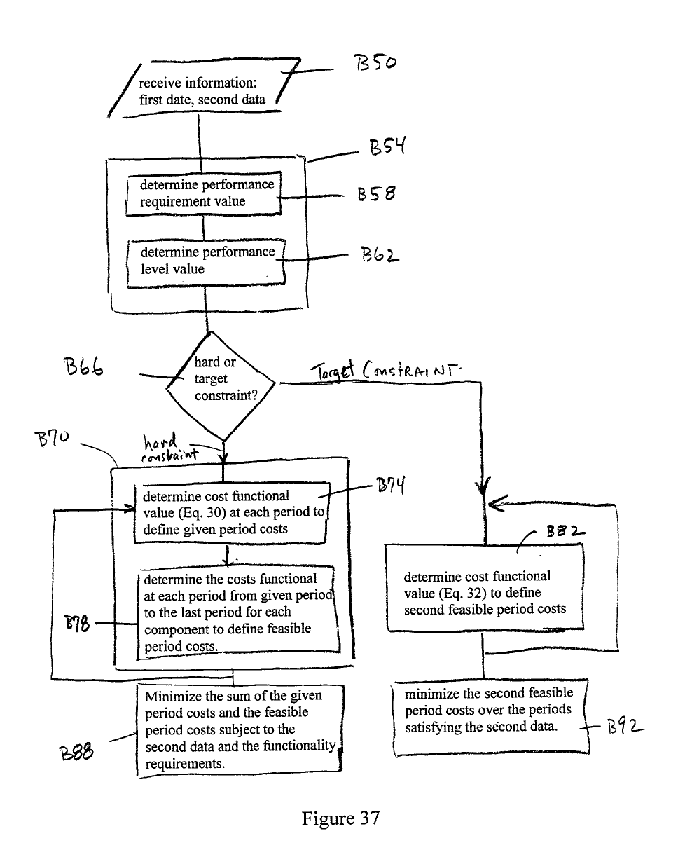

The present invention, including the methods of the present invention as described in sections 1-5 and 7 herein and as illustrated in FIGS. 7a-7d and 37, may be implemented according to a variety of computing topologies. In one embodiment, the present invention may be implemented using a networked computing system. In another embodiment, the present invention may be implemented using a standalone computer platform.

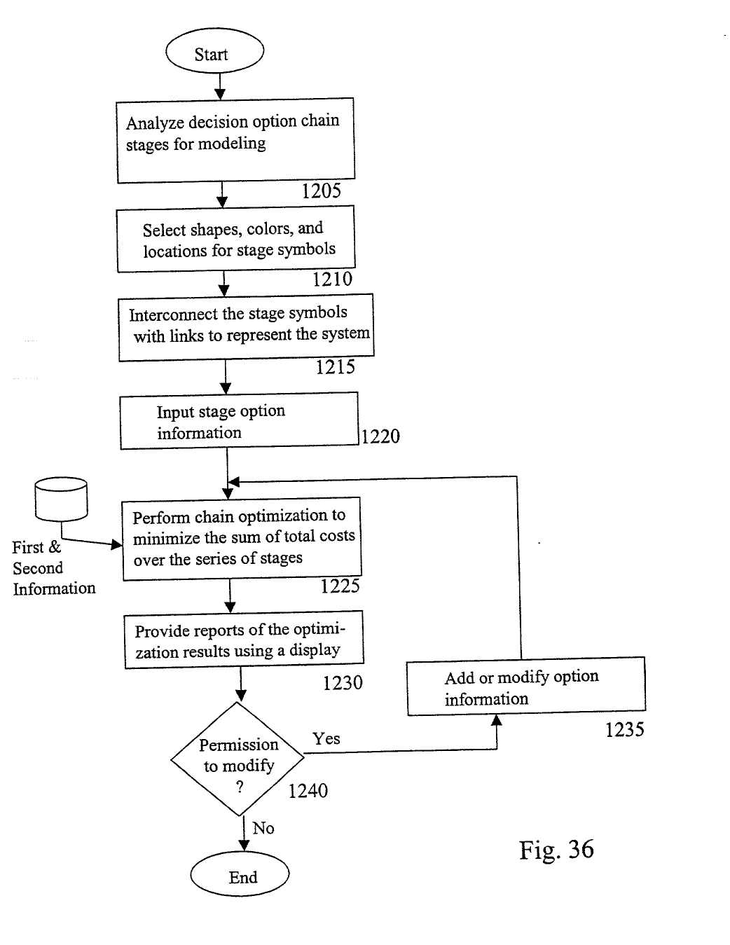

A flow chart illustration of an embodiment of a representation method 1200 according to the present invention is illustrated in FIG. 36. Referring to FIG. 36, a user may initiate a method 1200 by analyzing a particular decision option chain for modeling at 1205. The present invention may be used to represent a wide variety of operations in which an overall operation is supported by a series of underlying interrelated operations. The system and methods of the present invention provide for optimization of the overall operation by analysis of various options available at each underlying stage, and through selection of an optimum series of options that minimizes the total costs over the series of stages. In the description of the invention herein, a supply chain is used as a representative operation. Thus, a user of the system according to the present invention may analyze the overall operation to which the invention is to be applied in order to determine the appropriate stages and their interrelationships for modeling.

A user may next select a combination of stage shapes and colors to be used for stage symbols at 1210. The user may also choose the locations of the stages on a display representation of the supply chain in an arrangement that represents the interrelationships among stages of the supply chain. Next, the user may establish links, which may be represented as graphical links, between individual stage symbols in order to form a representation of the overall supply chain operation, at 1215.

Once the supply chain representation has been established, the user then may input information associated with at least one option for each stage in the supply chain at 1220. A user may accomplish this using a data entry device, or by providing a file containing the option information suitable for access and storing by a database according to the system of the present invention. Where a file containing at least the option information is predefined and simply retrieved, representation of the stages of the supply chain by stage symbols may be automatically performed, rather than the user selecting the combination of shapes and colors to be used for stage symbols.

After the option information is obtained, the user may initiate chain optimization at 1225, as discussed above in sections 1-5 and as illustrated in FIGS. 7a-7d. In one embodiment, the present invention performs chain optimization by executing instructions using a processor that determine an optimal option for each stage in the series of stages. The optimal series may be selected that minimizes the sum of the total costs over the series of stages for the entire supply chain. In performing the optimization, the present invention may include certain quantifiable stage information in the optimization calculations, and exclude other information as described herein. Such quantifiable information may include, for example, a first cost corresponding to a monetary amount associated with performing an operation and a second cost corresponding to an amount of time associated with performing an operation.

After the optimization has been performed, the present invention may make available to one or more users the results of the optimization by generating (and, in a networked configuration of the system according to the present invention, by transmitting formatted results to remote computer systems) and outputting using, for example, a display device, one or more reports to a requesting user of the system at 1230.

Certain users having modification permission (1240) may add or modify the option information for one or more affiliated stages in order to perform a subsequent optimization using the new or modified information, and to observe the associated optimization results, at 1235.

Certain of these portions of method 1200 are described in further detail elsewhere herein and in connection with, for example, FIGS. 7a-7d.

6.1 Computing Platform

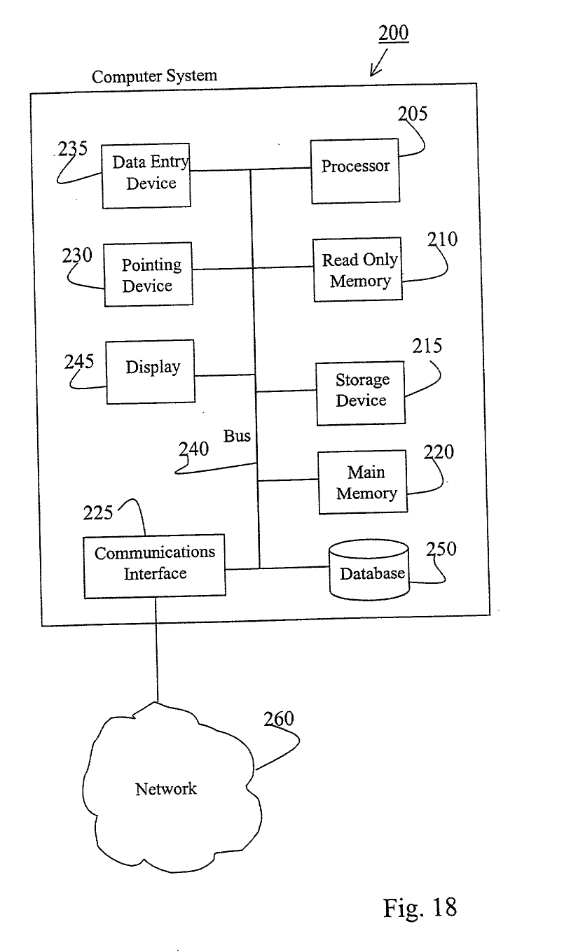

FIG. 18 is a block diagram of a computer system 200 (i.e., a computer) which may be used to implement the present invention. In an embodiment, computer system 200 may be a personal computer configured for executing DOS and Microsoft Windows™ based programming instructions. Alternatively, computer system 200 may be a workstation or a server system such as, for example, the Sun Netra™ server or Sun UltraSPARC™ based workstations available from Sun Microsystems, Inc. of Palo Alto, Calif. Computer system 200 may include a bus 240 or other communication mechanism for communicating information, and a processor 205 coupled with bus 240 for processing information. Computer system 200 also may include a main memory 220, such as a random access memory (RAM) or other dynamic storage device, coupled to bus 240 for storing information and instructions to be executed by processor 205. Main memory 220 also may be used for storing temporary variable or other intermediate information during execution of instructions to be executed by processor 205. Computer system 200 further may include a read only memory (ROM) 210 or other static storage device coupled to bus 240 for storing static information and instructions for processor 205. A storage device 215, such as a magnetic disk or optical disk, may be provided and coupled to bus 240 for storing information and instructions.

Processor 205 may comprise a processing portion of computer system 200 configured to execute a sequence of programmed instructions provided in accordance with the methods of the present invention as described herein. A receiving portion of computer system 200 may include data entry device 235, pointing device 230, storage device 215, main memory 220, database 250, and communications interface 225. The receiving portion may function to accept code and data from a variety of sources for input to the processing portion of computer system 200.

In one embodiment, database 250 may be coupled to bus 240 for storing static information and software instructions. Information stored in or maintained using database 250 may be provided in conformance with a database management system format such as, but not limited to, the structured query language (SQL) format. In one embodiment, database 250 may be a SQL database provided by the Oracle Corporation of Redwood Shores, Calif. Alternatively, database 250 may be a SQL Server 7.0 database supporting the ActiveX Data Object (ADO) and Open Database Connectivity (ODBC) protocols provided by IBM Corporation or Sybase Corporation. Database 250 may include information including, but not limited to, database query and access instructions in the form of one or more scripts which, when executed by a processor such as processor 205, serve to store and retrieve data maintained using database 250 according to the instructions contained in the script, and in particular regarding the data fields to be accessed, as well as their arrangement, provided in the response to processor 205.

Computer system 200 may be coupled via bus 240 to a display 245 for outputting information to a computer user. In one embodiment, display 245 may be a cathode ray tube (CRT) computer display monitor capable of displaying information using multiple colors. Alternatively, display 245 may be a liquid crystal display or a monochrome monitor.

A data entry device 235, including alphanumeric and other keys, may be coupled to bus 240 for communicating information and command selections to processor 205. Another type of user input device which may be coupled to bus 240 is pointing device 230, which may be a computer mouse, trackball, cursor direction keypad, tactile directional fingerpad, or other such device for allowing a user to control cursor location and movement on display 245, and for communicating direction information and command selections to processor 205. This pointing device 230 typically has two degrees of freedom in two axes, a first axis (e.g., x) and a second axis (e.g., y), that allows the pointing device to specify positions in a plane.

The present invention is related to the use of computer system 200 for decision option (i.e., option) analysis. According to one embodiment of the present invention, decision option analysis in the manner described earlier herein may be provided by computer system 200 in response to processor 205 executing one or more sequences of instructions contained in main memory 220. Such instructions may be read into main memory 220 from another computer-readable medium, such as storage device 215 or database 250. Execution of the sequences of instructions contained in main memory 220 may cause processor 205 to perform the process steps described herein. One or more processors in a multi-processing arrangement may also be employed to execute the sequences of instructions contained in main memory 220. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 205 for execution. Such a medium may take many forms, including, but not limited to, non-volatile media, volatile media, and transmission media. Non-volatile media include, for example, optical or magnetic disks, such as storage device 215. Volatile media include dynamic memory, such as main memory 220. Transmission media can also take the form of acoustic or light waves, such as those generated during radio frequency (RF) and infrared (IR) communications. Common forms of computer-readable media include, for example, floppy disk, a flexible disk, hard disk, magnetic tape, any other magnetic medium, a CD ROM, DVD any other optical medium, punch cards, paper tape, any other physical medium with patterns of holes, a RAM, a PROM, an EPROM, a Flash EPROM, any other memory chip or cartridge, a carrier wave as described hereinafter, or any other medium from which a computer can read.

Various forms of computer-readable media may be involved in carrying one or more sequences of one or more instructions to processor 205 for execution. For example, the instructions may initially be borne on a magnetic disk of a remote computer. The remote computer may load the instruction into its dynamic memory and send the instructions over a telephone line using a modem. A modem local to computer system 200 may receive the data on the telephone line and use an infrared transmitter to convert the data to an infrared signal and place the data on bus 240. Bus 240 may carry the data to main memory 220, from which processor 205 retrieves and executes the instructions. The instructions received by main memory 220 may optionally be stored on storage device 215 either before or after execution by processor 205.

Computer system 200 may also include a communication interface 225 coupled to bus 240. Communication interface 225 may provide a two-way data communication coupling to a network 260. For example, communication interface 225 may be a modem or an integrated services digital network (ISDN) card to provide a data communication connection to a corresponding type of telephone line. As another example, communication interface 225 may be a local area network (LAN) card to provide a data communication connection to a compatible LAN. Wireless links may also be implemented. In any such implementation, communication interface 225 sends and receives electrical, electromagnetic, or optical signals that carry digital data streams representing various types of information.

Communication interface 225 may provide data communication through one or more networks to other data devices. For example, communication interface 225 may provide a connection through a local network to a host computer or to data equipment operated by an Internet Service Provider (ISP). The ISP may in turn provide data communication services through the worldwide packet data communication network, now commonly referred to as the “Internet.” These networks use electrical, electromagnetic, or optical signals that carry digital data streams. These signals are exemplary forms of carrier waves transporting the information.

Computer system 200 may send messages and receive data, including program codes, through the network(s) and communication interface 225. In the Internet example, a server might transmit a requested code for an application program through the Internet, ISP, and communication interface 225. In accordance with the present invention, one such downloaded application provides for decision options analysis as described herein. The received code may be executed by processor 205 as it is received, and/or stored in storage device 215, or other non-volatile storage for later execution. In this manner, computer system 200 may obtain an application code in the form of a carrier wave.

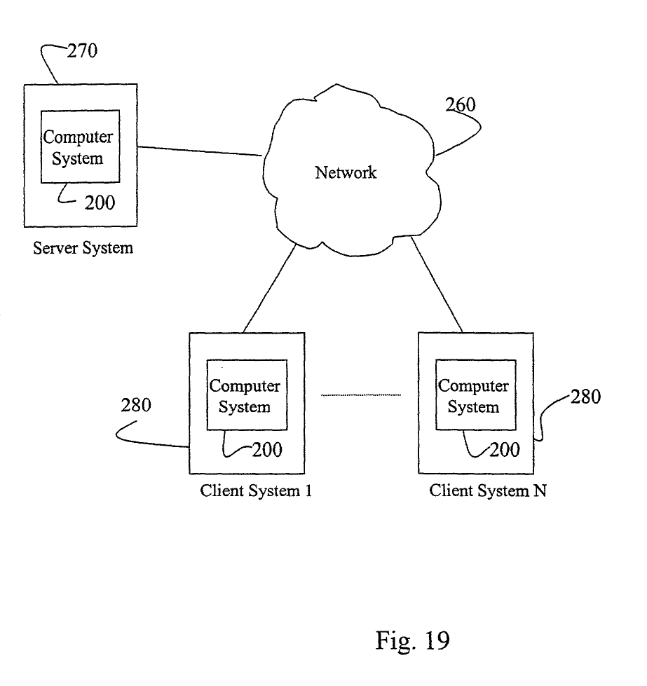

FIG. 19 is a block diagram of an embodiment of a networked configuration of the system according to the present invention. Referring now to FIG. 19, in the networked computing topology multiple computer systems 200 may be interconnected for communication using a network 260. In the network configuration, one of the computer systems 200 that communicate with database 250 may also be configured as a web server 270 to respond to user requests for supply chain or stage information received from one or more client systems 280. Client systems 280 may also include computer system 200. The web server 270 may generate and transmit the requested stage information to the requesting user via World Wide Web page using the Internet. Network 260 may be, for example, a network of interconnected networks such as the Internet, a local area network (LAN), a wide area network (WAN), an intranet including any of these, and/or the public switched telephone network (PSTN). Communications interface 225 may further include a web browser or thin client 220. The web browser displays data and is capable of communicating with other computers via a network such as, for example, the Internet or an intranet. The web browser provides a user with a way to navigate, via, for example, hyperlinks which are selected by a pointing device 230 such as a computer mouse, or as typed in by the user. The web browser uses a protocol such as, for example, HyperText Transfer Protocol (HTTP) of File Transfer Protocol (FTP), to transmit data of various content such as, for example, HyperText Transfer Markup Language (HTML) formatted documents, plain text documents, graphic images, and Extensible Markup Language (XML) documents for presentation to the user via a display 245. Web pages formatted in accordance with HTML or XML may also be provided in accordance with the eXtensible Style Language (XSL) specification available from the World Wide Web Consortium. XSL is useful for separating style from content as well as for providing a common interface for sharing of web pages across applications. The web browser may also run or execute programs, such as Java applets including sequences of instructions provided in accordance with the Java programming language, or JavaScript. The web browser may be, for example, Internet Explorer by Microsoft Corporation, Netscape Navigator by Netscape, or any other web browser.

Certain information maintained using database 250 maybe stored in the form of XML-formatted database files. Such XML-formatted information may include stage option information as discussed herein. In addition, code and data may be passed between or among the various software modules and components used to implement an embodiment of the present invention, and the transferred code and data also may be provided in accordance with the XML standard.

A thin client utilizes a two or more tiered client server model. In this model, the client runs a minimal set of services that provide functionality to interface with at least one server. A web browser may be a thin client.

In one embodiment, instructions executed by processor 205 from main memory 220 may include application software instructions that cause processor 205 to perform the decision option analysis described herein. In this embodiment, these application instructions may be implemented in the form of source code statements provided in accordance with the Visual C++ and Visual Basic™ higher order programming languages, development kits for which are available from Microsoft Corporation of Redmond, Wash. Other embodiments are possible. Application instructions may also include database scripts for accessing, storing, or selectively retrieving information contained in database 250. The database scripts may be contained in storage device 215 or may be stored using database 250. The database scripts may be implemented in the form of programming statements provided in accordance with, for example, structured query language (SQL) version 7.0 database management system query language, as well as Transact SQL. Other database implementations are possible, including those available from Oracle™ or IBM DB2™.

In an embodiment, computer system 200 may be configured to perform methods of the present invention as shown in FIGS. 7a-7d and 37 by executing a sequence of application software instructions embodying the processing as described herein with respect to those figures. Such sequences of instructions may be used to implement, for example, the optimal solution algorithm, spanning tree network, multivariable optimization, and dynamic forward recursion processing, as well as other methods as described herein.

6.2 User Interface Display Methodology

In one embodiment, application software instructions include a user interface portion, which may be a graphical user interface (GUI) portion, for generating interactive display screens by which a user may provide data to and receive information from computer system 200 and database 250 using display 245. A user may interact with computer system 200 via the graphical user interface provided by the GUI portion by using pointing device 230 and data entry device 235. The GUI portion may place the output of computer system 200 in a format for presentation to a user via display 245.

In particular, a user may select a particular data entry field of an interactive display page presented using display 245 by using the pointing device 230 or data entry device 235 to select that field. Upon selecting a field, a user may then enter information into the data entry field using a data entry device 235. After the user has entered data into the data entry field, the user may cause the GUI portion to input the user-entered information to computer system 200 using the pointing device 230 to select a corresponding display icon or command button.

The present invention provides a system and methods by which one or more users may observe and manipulate the overall end-to-end decision chain. In a decision chain with multiple stages, the present invention allows a user to define the relevant properties of each stage, link the stages together to represent inter-stage dependencies, and provide a visual mapping of the entire decision chain.

6.2.1 Login and View Chain

In one embodiment, users of the system must first login in order to access decision option information. Login may be accomplished by the user entering a corresponding Uniform Resource Locator (URL) address at the client web browser of the user's local computer system 200. In one embodiment, the accessing user's local computer system 200 may be a client system 280 which includes a second computer system not collocated with the server 270. Server 270 may include a first computer system 200 used to host the information and application program instructions as discussed herein using database 250. Client system 280 and server 270 may be interconnected using a network 260. Referring again to FIG. 19, entering at the second computer the URL associated with server 270 may cause client system 280 to transmit a login request message to server system 270 using a network 260. Upon receipt of the login request, server system 270 may generate and transmit an interactive login web page to client system 280 for display to the user via display 245. The requesting user may then enter identification data using the interactive login web page such as user identifier and password and command client system 280 to transmit the login information to server system 270.

Upon receipt of the login information from client server 280, server system 270 may compare the received information to corresponding login information maintained in database 250. If the received information matches corresponding stored login information, then server system 280 may generate and transmit an interactive home web page to client system 280.

In performing the above login processing as well as the client-server interaction described below, server system 270 may receive requests for information as well as user entered data from client system 280 via network 260. Such user provided requests and data may be received in the form of client-user entered data contained in an interactive web page provided in accordance with the Active Server Pages standard. Alternatively, user provided requests and data may be received in the form of client-user entered data contained in an interactive web page provided in accordance with the Java Server Pages™ standard developed by Sun Microsystems. In response to a user entered request, server system 270 may generate a report in the form of an interactive web page by obtaining decision option information associated with the user request by, for example, executing a corresponding command or scripted instruction (using, for example, ActiveX scripting developed by Microsoft Corporation) or sequence thereof to cause retrieval of the associated data from database 250. Upon receipt of the requested data, server system 270 may build an interactive web page including the requested information and transmit the page to the requesting client system 280 in accordance with HTML and ASP formatting standards.

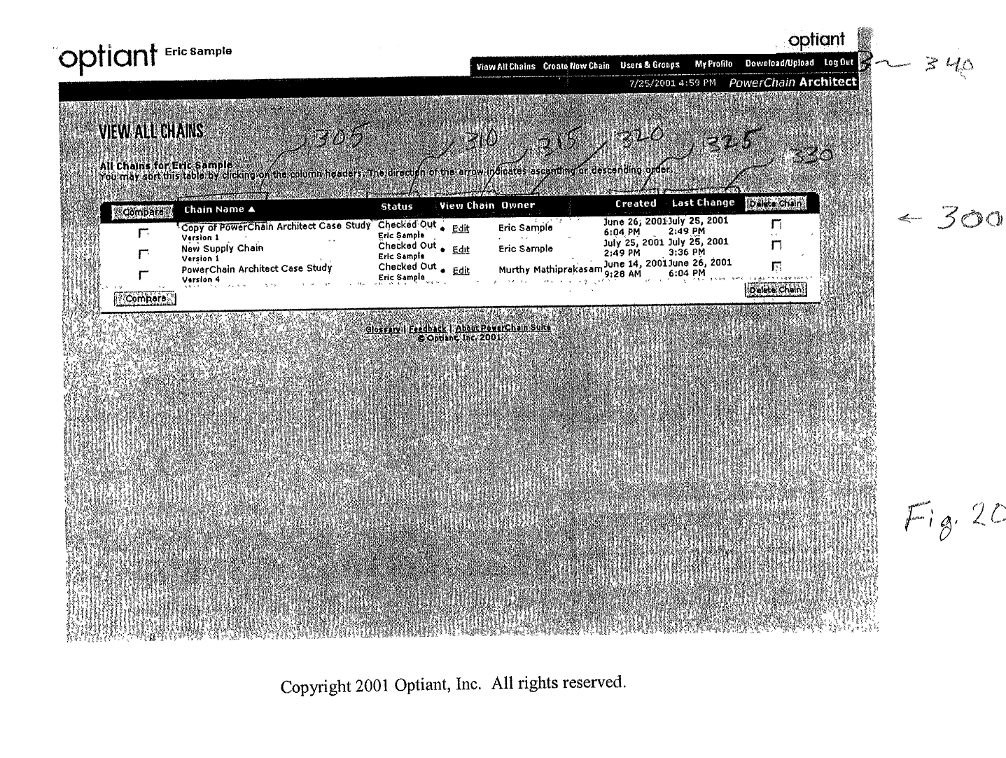

In one embodiment, upon successful login a decision option chain view page may be provided to the requesting user that includes a list of one or more decision chains that may be viewed by that user. FIG. 20 shows an illustration of an interactive decision option chain view page 300 listing multiple decision chains that may be viewed by an exemplary logged in user. Referring now to FIG. 20, decision option chain view page 300 may include for each viewable decision option chain one or more interactive data fields such as a chain name 305, chain status 310, view chain checkout type 315, a chain owner 320, a chain creation date 325, and a last change indicator 330.

Chain name 305 may be a name given to a particular decision option chain by the chain's creator. As shown in FIG. 20, chain name 305 may also include a version number for the chain. In one embodiment, the system according to the present invention includes a versioning capability in which a user having read/write access to a decision option chain may save a modified chain into a separate version. Each version of a decision option chain may be independently selected for view using client system 280, and different versions of the same chain may be compared in order to review the changes.

Chain status 310 may provide an indication of whether or not a given decision option chain is available for editing. Chain status 310 may include a “Checked-Out” status to indicate that a particular decision option chain is currently checked out by another user, and a “Checked-In” status to indicate that no other user has checked out the decision chain for edit. A decision option chain having a chain status 310 of “Checked-Out” may not be edited and can only be viewed as read-only.

View chain checkout type 315 may provide an indication of a level of access available to a particular user with respect to a particular chain. For example, checkout type 315 may indicate that a particular user has read/write access to a chain; or, alternatively, a user may have read-only access to a particular chain. In one embodiment, view chain checkout type 315 may be a discrete variable maintained using database 250 under control of the chain owner 320. The chain owner 320 may have the ability to set the view chain checkout type 315 access level for each other user having access to a particular decision option chain. In one embodiment, server system 270 allows the chain owner 320 to assign the view chain checkout type 315 parameter for each other user having access to a particular chain by selecting the corresponding entry from a pull-down menu of parameters options (e.g., “read/write,” “read only”).

Chain owner 320 may be one user who has responsibility for managing administrative and substantive changes to a particular decision option chain. The chain owner 320 may correspond to the chain creator. Chain creation date 325 may provide a date/time stamp of when a particular version of a chain was created. Last change indicator 330 may provide a date/time stamp of when a particular chain version was last updated as indicated by an associated information field contained in database 250.

Each of the columns for decision option chain view page 300 corresponding to a particular interactive data entry field may be sorted according to a variety of criteria. For example, a user may choose to view multiple decision option chains in order of creation date by, for example, using a pointing device 230 to double-click on the “Created” header field associated with the column containing chain creation date 325.

Chain Creation

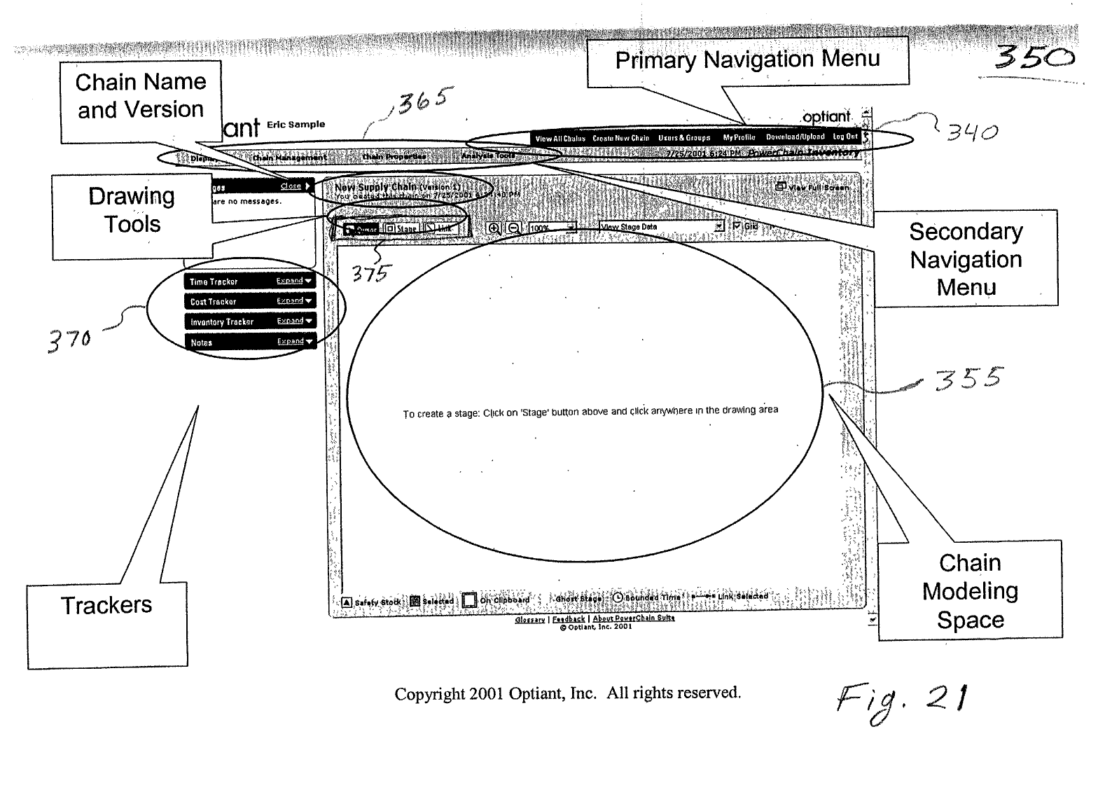

In one embodiment, a user may create a new decision option chain by selecting a corresponding selection tab provided within a primary navigation menu 340 by, for example, using a pointing device 230 to click on the “Create New Chain” selection tab as shown in FIG. 20. Upon user request to create a new decision option chain, client system 280 may transmit a request for a new chain home page to server system 270 using network 260. Upon receipt of this request, server system 270 may generate and transmit a chain home page to the requesting client system 280. FIG. 21 shows an embodiment of an exemplary chain home page 350 in accordance with the present invention.

Referring now to FIG. 21, chain home page 350 may include, but is not limited to, a chain modeling space 355 providing a graphical workspace for assembling a decision option chain, primary navigation menu 340 for selecting input/output options, a secondary navigation menu 365 for selecting decision chain input and analysis tools, tracking tools pull-down displays 370, and drawing tools 375. To create a decision option chain, a user may select the stage drawing tool from drawing tools 375 using pointing device 230, then cause a new stage to be shown in chain modeling space 355 by moving the cursor, using pointing device 230, to a desired location within chain modeling space 355. The user may cause computing system 200 to display a new stage at a particular location by, for example, clicking a selection button of pointing device 230 when the cursor is positioned at the desired location. Once a new stage is displayed within chain modeling space 355, a user may move the position of the stage within chain modeling space 355 using pointing device 230. Using this technique, the user may choose to add further new stages to chain modeling space 355 as required to represent a corresponding decision chain or portion thereof.

Further to creation of a decision option chain, after adding new stages in the manner described above, for example, or during the addition of new stages, a user may wish to connect stages using one or more links. In one embodiment, a user may select the link drawing tool from drawing tools 375 using pointing device 230, then cause a new link to be shown in chain modeling space 355 by moving the cursor using, for example, pointing device 230 to a desired stage from which a link is to be made (e.g., Stage 1), selecting that stage, then moving the cursor to a second stage to which a link is to be made (e.g., Stage 2), within chain modeling space 355. In one embodiment, these actions will cause computer system 200 to create a link between the stages (e.g., Stage 1 linked to Stage 2). Using this technique, the user may choose to add further links between and among stages within chain modeling space 355 as required to represent a corresponding decision chain or portion thereof.

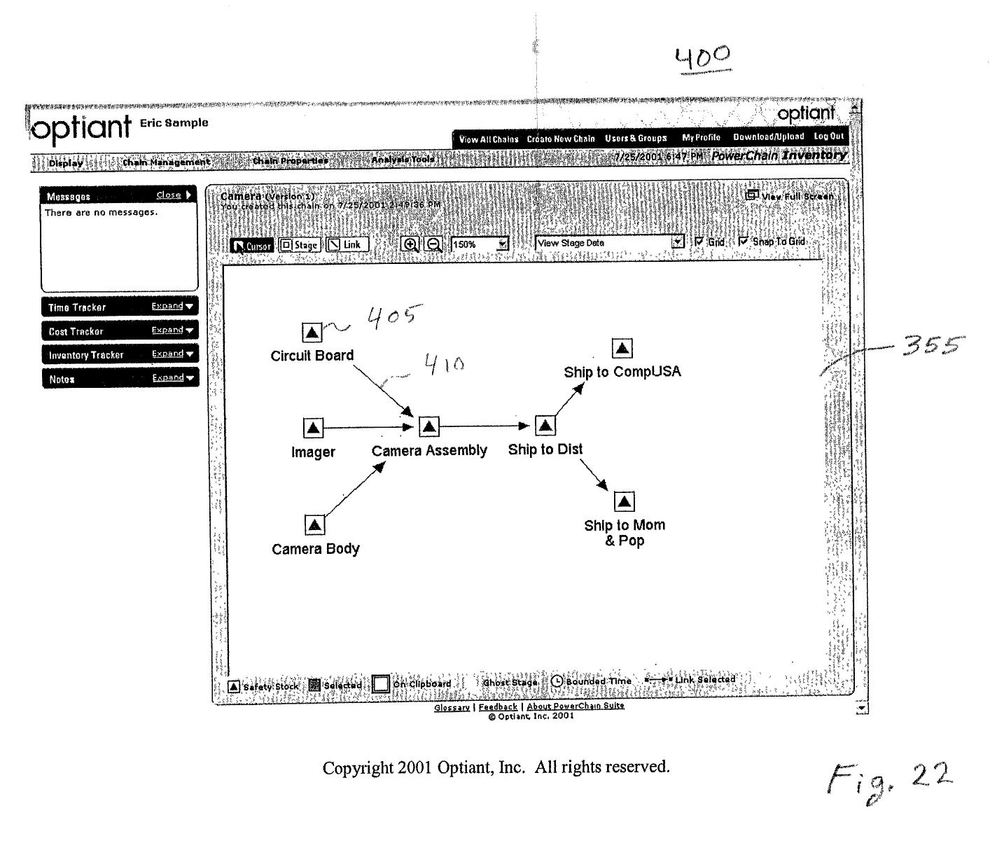

FIG. 22 shows an example of a decision option chain 400 having stages 405 and links 410. As shown in FIG. 22, any stage 405 may be the terminus for one or more links 410, and, further, any stage 405 may be the origination point for one or more links. Using this capability, a user may create decision option chains of multiple dimension or degree. The system and methods of the present invention thereby provide for the representation or mapping of decision option chains of various types and topology such as, but not limited to, linear chain, one-to-many, many-to-one, and spanning tree networks.

6.2.3. Stages & Links

In one embodiment, a user can select from among a variety of symbols to represent a stage or decision option point. In one embodiment of the exemplary supply chain decision option system described herein, a first symbol may be used to denote a processing stage 405. The first symbol may be a “●.” Further, a second symbol may be used to denote a safety stock location. The second symbol may be a “▴.” A user may also define a particular unique user-defined icon to be used to represent a stage, in addition to or in place of one or more system provided icons. In addition, color may be used in conjunction with the stage symbols to represent information associated with a particular stage. As with shapes, the user can choose a color from among a variety of system provided colors, or may choose to define a unique color using a color selection palette provided by the system. If the user does not select a particular color or colors, then the system will assign a default color to a given stage.

In one embodiment, links may be used to represent stage interdependencies. The method of the present invention includes representing each stage of an interconnected system using the stage symbols and links and displaying the representation using a display device such as display 245. The method of the present invention may further include maintaining information associated with one or more options that can be used or selected for each discrete stage representation and calculating an optimum series of options over a series of the stages in order to minimize the sum of total costs over the series of stages based on the information provided for each stage option. In one embodiment, the calculation of the optimum series may include applying one or more of the algorithms described previously herein to the stage information associated with the options for each stage in order to determine an optimum series of options based on total costs as a function of the stage option information. In one embodiment, information included as a basis for the optimum series calculation may include a first cost corresponding to, for example, a stage service time, and a second cost corresponding to, for example, a procurement cost. Certain stage information associated with a stage and maintained using database 250 but not affecting the total costs may be excluded from the optimum series calculation. For example, the information may include first data, which may be a stage modification permission parameter, may be excluded from the optimum series calculation. In this manner, the total costs is the summation of the quantifiable characteristics of the information associated with each stage.

Furthermore, a user may manually exclude one or more stages from being factored into the optimum series calculation. In one embodiment, a user may exclude a stage from optimum series calculations by clicking on a checkbox associated with the stage and provided for that purpose on an interactive display page on display 245, using pointing device 230.

In the exemplary embodiment described herein, decision options are described in terms of the stages of a supply chain and a link may represent a material feed from an upstream stage to downstream stage. In this example, a stage may represent an operation to be performed as part of a supply chain (the supply chain itself may represent a relatively larger operation). Those skilled in the art will appreciate that the stages and the processing, mathematical notation, and user interface representation of stages described herein may apply to a variety of decision option applications in accordance with the present invention.

In the exemplary supply chain embodiment described herein, a stage may represent a process or operation which may result in stored inventory for an item, component, assembly, subassembly, product or system. For example, a stage may represent processes such as, but not limited to, a raw materials warehouse after a procurement process, a work in process inventory after an assembly process, a distribution center after a transportation process, or a finished goods warehouse after a transportation process.

In an embodiment, upon receiving a user request to view a particular version of a decision option chain, server system 270 may retrieve a sequence of instructions that, when executed by computer system 200, will render the requested decision option chain representation for display. The sequence of instructions may include application programming instructions implemented as one or more a Java applets, as well as scripted instructions which may be formatted in accordance with the XML standard. The application programming instructions operate upon the scripted instructions to produce the decision option chain representation. The scripted instructions may embody information that, when executed in conjunction with application programming instructions by computer system 200, determine certain aspects of the decision chain representation such as, but not limited to, the number and location of stages and the number, direction and location of links used to interconnect the stages in the manner described herein.

The scripted instructions may be stored using database 250. In an embodiment, information associated with each version of a decision option chain may be stored in a single row in a table containing at least one such row in database 250. The table may include a number of columns associated with different items of information for each of the versions. At least one of the columns in the table may be a large text column that contains the full XML document associated with a display of a particular version of a decision option chain. Information stored using the table may include strategic supply chain data or supply chain design data, such as the stage option information described further herein. For example, a column may be provided in the table for each category of stage option information. Portions of the information contained thusly in the table may be retrieved or updated by computer system 200 executing one or more corresponding instructions or scripts. While the invention has been described in an implementation using the data structure described above, other data structures and embodiments are possible.

6.2.4 Stage Options and Information

For a decision chain with multiple stages, the present invention allows a user to define one or more attributes of relevant information associated with a decision or subdecision involving that stage. Stage information associated with one or more options for that stage may include, but is not limited to, a first cost corresponding to a monetary amount associated with performing an operation such as a procurement cost, a second cost corresponding to an amount of time associated with performing an operation such as a stage service time, and a third information which may correspond to a stage modification permission parameter. As described further herein, the first cost, second cost, or third information may be modified by a user of the system having permission to modify the information associated with a particular stage.

Other costs and information may also be represented for each stage option, including variations and derivations of the foregoing information. For example, in the exemplary supply chain embodiment described herein, such information may include, but is not limited to, parametric information such as procurement time, production time, service time, cost added, holding cost rate, demand statistics, demand uncertainty, and a total cost including a total of at least one of a manufacturing cost, an inventory cost, and a time to market cost. Each item or type of information and its current value may be selected by a user to be displayed for one or more stages of a decision chain using display 245. Each item of information may be maintained using database 250 and obtained from database 250 as required for display to a user via display 245. Stage information may be selected and displayed individually, in portions, or together in groups up to and including all items of stage information, including the optimum series of options. Combinations of particular items of stage information may represent stage options for evaluation using the system and methods of the present invention as discussed herein. For example, a stage 405 representing a component procurement process may have a choice of options, each option having a different lead time and cost. Further to this example, a first option (e.g., Option 1) may represent a lead time and component cost quoted by a first supplier of, say, 60 days lead time at $10 per part, and a second option (e.g., Option 2) may represent a lead time and component cost quoted by a second supplier of say, 90 days lead time at $8 per part.

The network configuration may be particularly useful for allowing the exchange and update of decision option information by one or more users of the system. For example, if a first computer system 200 is used to host database 250 and applications for decision option analysis as described herein, then a user at a second computer system 200 (which may or may not be collocated with the first host computer) may access and update the information associated with one or more decision options maintained using database 250 by interacting with the first host computer system 200 using the network 260. In one embodiment, a first computer may be a server 270 and a second computer may be a client system 280.

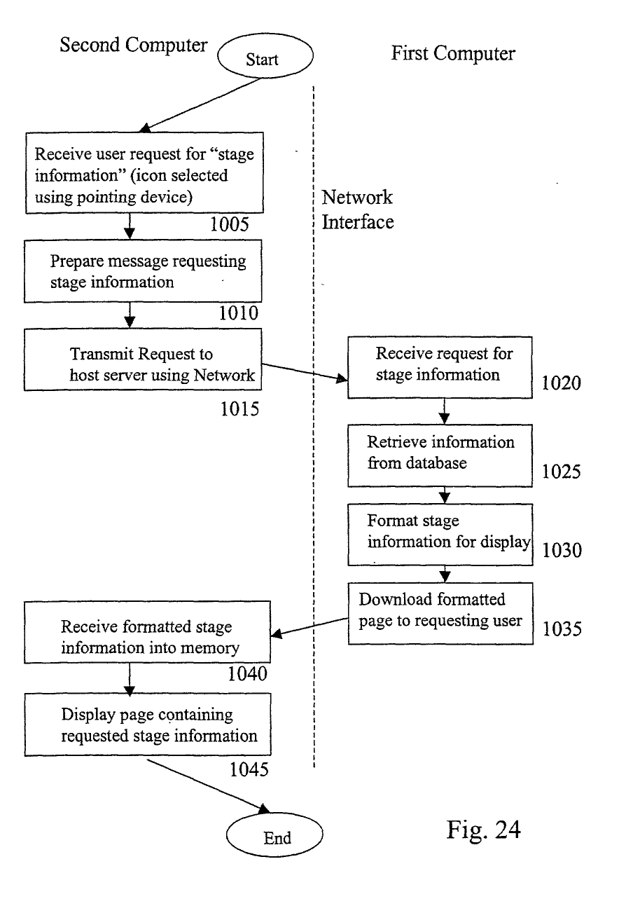

For example, in one embodiment, a user may select a stage report in order to view the current set of stage information associated with a particular stage 405. In a networked configuration, a user at a second computer may request to view stage information maintained at a first computer capable of sending and receiving information and requests to and from the second computer using a network. The second computer may correspond to a client system 280 and the first computer may be server 270. A method 1000 of the present invention for providing requested stage information to a user located at a second computer is shown in FIG. 24. Referring to FIG. 24, upon user selection of a user interface icon corresponding to a request for stage information at 1005, such as a stage report option using secondary navigation menu 365, client system 280 may prepare a message requesting the stage information at 1010 and transmit a request for a stage report to server system 270 using network 260 at 1015. Upon receipt of this request at 1020, server system 270 may retrieve the requested stage information from database 250 at 1025, then generate a stage report page formatted for display at the second computer at 1030, and download the formatted stage report page containing the requested stage information to the requesting client system 280 at 1035. Upon receipt of the stage report page at the second computer, the stage information received from the first computer may be stored in memory locations of the second computer at 1040 for use and display at the second computer at 1045.

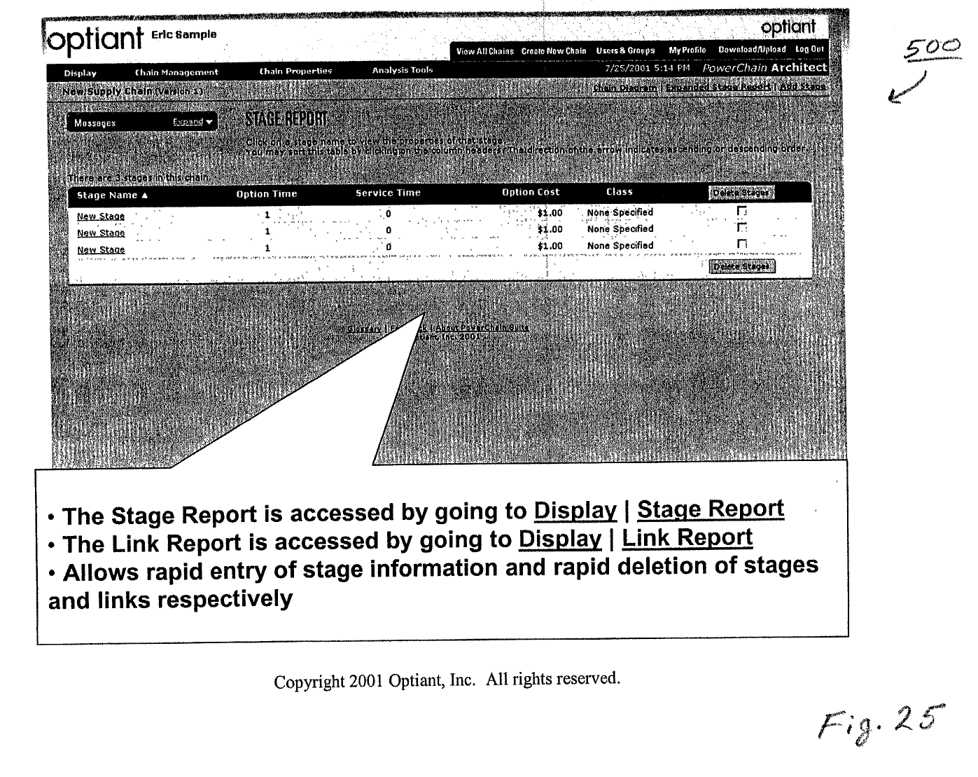

FIG. 25 shows an embodiment of an exemplary stage report 500 in accordance with the present invention. As can be observed from FIG. 25, a stage report 500 may include a display of stage information associated with a particular stage. The system of the present invention may also include a link report that shows a detailed description of a selected link, including, but not limited to, source stage(s), destination stage(s), and distance or cost.

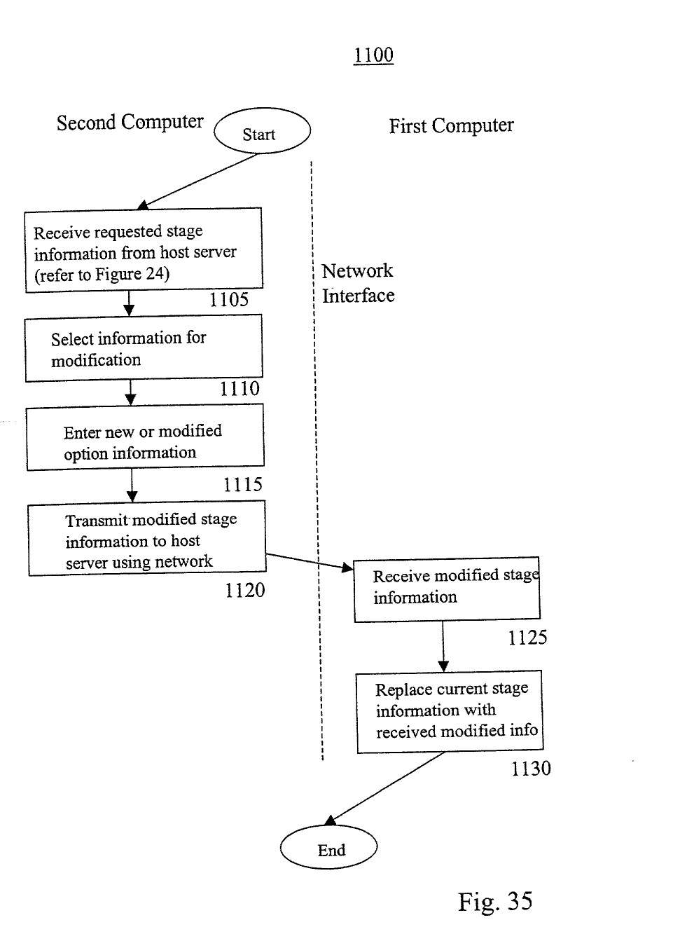

Furthermore, certain users may read, or modify and update, portions of the stage information at the second computer. One embodiment of a method of the present invention for providing modification of stage information by a user at a second computer is shown in FIG. 35. Referring to FIG. 35, a user at a second computer may request stage information as described above with respect to FIG. 24 at 1105. For users at a second computer having read access, only the local copy of the stage information contained in memory at the second computer may be modified by the user for comparative analysis using the techniques and methods described herein. For users at a second computer having modify and update access, the user may select the information to be modified at 1110, in which case the local copy of the stage information contained in memory at the second computer may be modified at 1115. The modified information may then be transmitted from the second computer to the first computer using a network such as, for example, network 260 at 1120. Upon receiving the modified stage information at 1125, the first computer may replace the corresponding stage information currently stored using database 250 with the modified stage information received from the second user from the second computer at 1130.

By providing a means for allowing certain remote users of the system to manipulate and change the decision option information for one or more stages or nodes, the present invention may permit and facilitate collaboration among various interested parties such as, but not limited to, component suppliers, assembly providers, distributors, wholesalers, and retailers. For example, a supplier of a component input at a given node of the supply chain may become aware of a forecast surplusage of the component due to, for example, a canceled order, which may result in a shorter lead time for the component than that currently reflected for the corresponding stage in the supply chain. Using the collaboration capability provided by the present invention, the component supplier can quickly enter the reduced lead time information for the stage into computer system 200 as a user of, for example, a second computer configured as a client system 280 for update and storage using database 250. In this way, all users of the system may be provided the most accurate information available for each stage of the supply chain. Such entered changes may be propagated forward and backward to effect changes in the analysis calculations and results for the overall supply chain.

As discussed above, certain users may also modify certain items of stage information as described herein, allowing that user to observe the stage impact and the end-to-end chain impact caused by a change in the parameter. The change may be made prospectively, thereby supporting “what if” analyses, or the change may be made in response to an actual change in the corresponding parameter. For example, inventory holding cost may increase at a particular stage due to increased facility costs. A user having “Read/Write” update permission for the stage representing that inventory location may use the system of the present invention to update the holding cost parameter for the stage, thereby providing all users of the system with updated actual information. The system of the present invention thereby allows users to observe the quantified impact to the stage as well as the impact to the overall end-to-end decision chain caused by the modified stage property. In the context of the exemplary supply chain described herein, this capability allows one or more users to determine optimum locations and levels of safety stock at various stages, or other inventory determination, in order to minimize the total inventory cost across the entire supply chain. Similar modifications may be made to other items of stage information to reflect changes or proposed changes to other parameters in order to allow one or more users to select the best decision options for suppliers, manufacturers, shippers, wholesalers, and retailers. In particular, one or more stages may be particularly affiliated with one or more users having modify and update access for the information associated with those stages. Other users may be granted “Read Only” access and are not able to modify stage information stored using database 250.

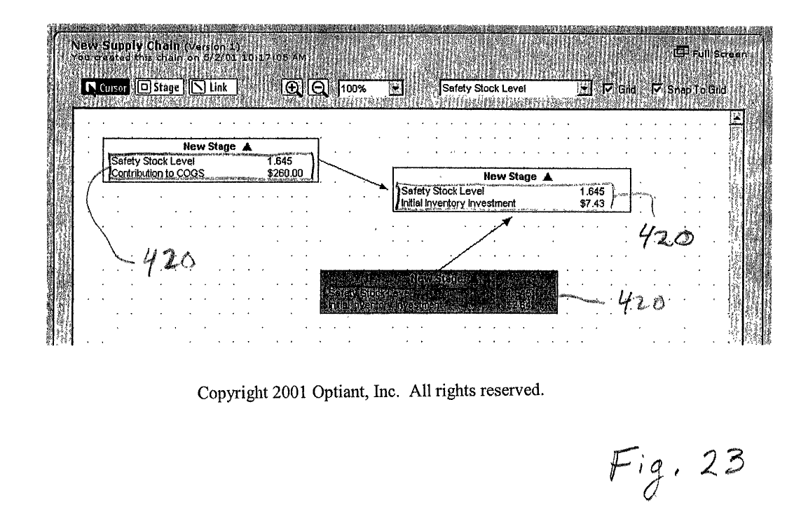

In one embodiment, a user having read/write access may select one or more particular options, corresponding to a particular grouped set of stage information, from among one or more options choices, to represent stage information associated with the stage. A user may choose to display one or more, or none, of the stage information associated with a particular stage. In one embodiment, for example, a user may select a particular stage 405 using pointing device 230, right-click on the selected stage 405 to cause computer system 200 to display a pull-down menu of options, and select an expanded stage display option. Selection of the expanded stage display option may cause one or more stage information 420 to be displayed proximate to the stage 405 icon within chain modeling space 355. FIG. 23 shows three stages 405 displayed along with an expanded stage display. Stage information may include, but is not limited to, safety stock level, contribution to Cost of Goods Sold (COGS), initial inventory investment, service time, purchase cost, replenishment lead time, net replenishment lead time, pipeline stock cost, production unit cost, weighted unit cost, mean demand, standard deviation in demand, and coefficient of variation in demand. FIG. 23 shows an example of expanded stage displays for safety stock level, contribution to Cost of Goods Sold (COGS), and initial inventory investment.

6.2.5 Stage Editing and Reporting

A system and method according to the present invention provides the capability to generate and present to the user a variety of stage and chain related reports. An example of one such report is the stage report 500 discussed above. Furthermore, several mechanisms may be provided by which a user (with read/write permission) may edit or modify the information associated with a particular stage.

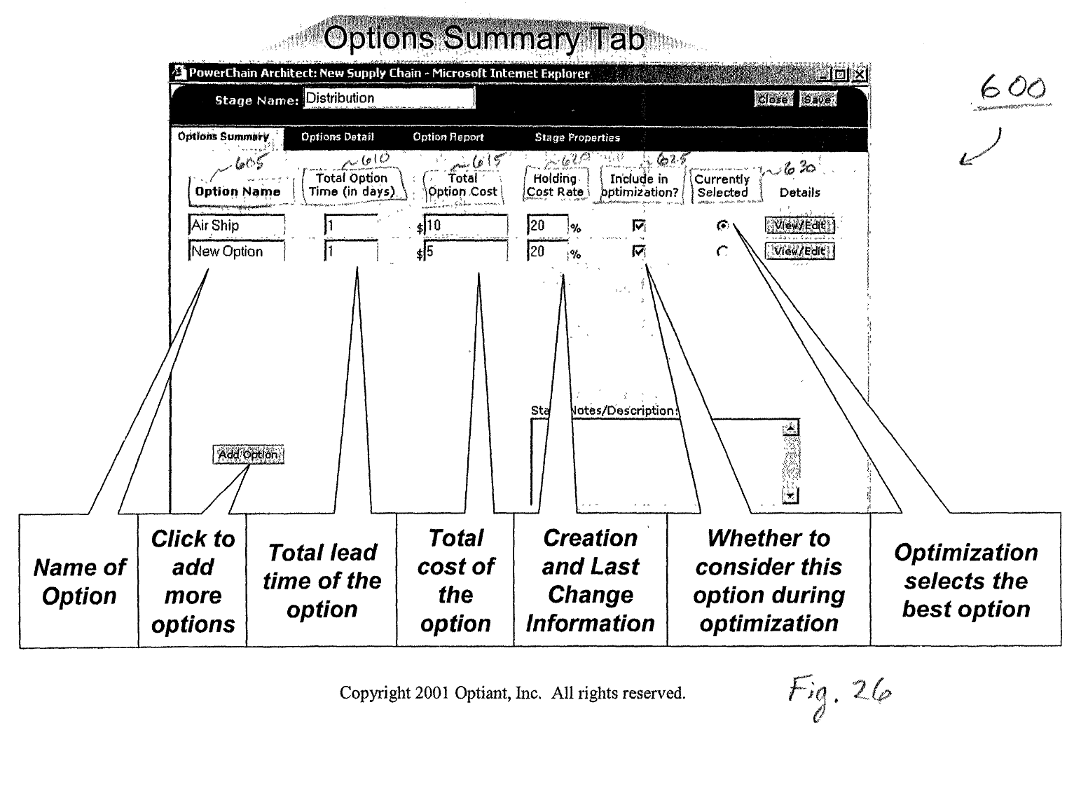

In one embodiment, a user may select a stage editing capability by, for example, double-clicking on a stage 405 of a displayed decision option chain 400 using pointing device 230. Upon receiving this user request, computer system 200 may generate and display one or more stage editor pages using display 245. For a requesting user at a client system 280, server 270 may generate and transmit a default stage editor options summary page 600 to client system 280 using network 260. Alternatively, a user can obtain a stage editor options summary page 600 by selecting the corresponding selection tab provided within a primary navigation menu as shown in FIG. 26.

Referring to FIG. 26, stage editor options summary page 600 may present a variety of stage information for a particular selected stage 405. In one embodiment, options summary page 600 includes stage information for one or more options associated with the stage, the options being listed by option name 605. For each option, information may be provided such as, but not limited to, total option time 610 representing, for example, the number of days required by the option, total option cost 615 which may be a monetary cost, holding cost rate 620 for inventory determination, a user-selectable checkbox 625 for including or excluding the stage 405 from optimization calculations, and a user-activated selection indicator 630 for reporting which one of the one or more options is currently selected for this stage.

Further stage edit pages which a user may select for view using pointing device 230 include, but are not limited to, an options detail editor for user editing of specific options in more detail and for specifying constraints on certain optimization parameters (e.g., specifying upper and lower bounds on option service time), an options report, a stage properties summary, a stage name editor, a production and services editor, an inventory and cost editor, a demand editor, and an optimization parameters editor. Constraints placed on particular optimization parameters are useful for preventing selection of an impractical option during optimization.

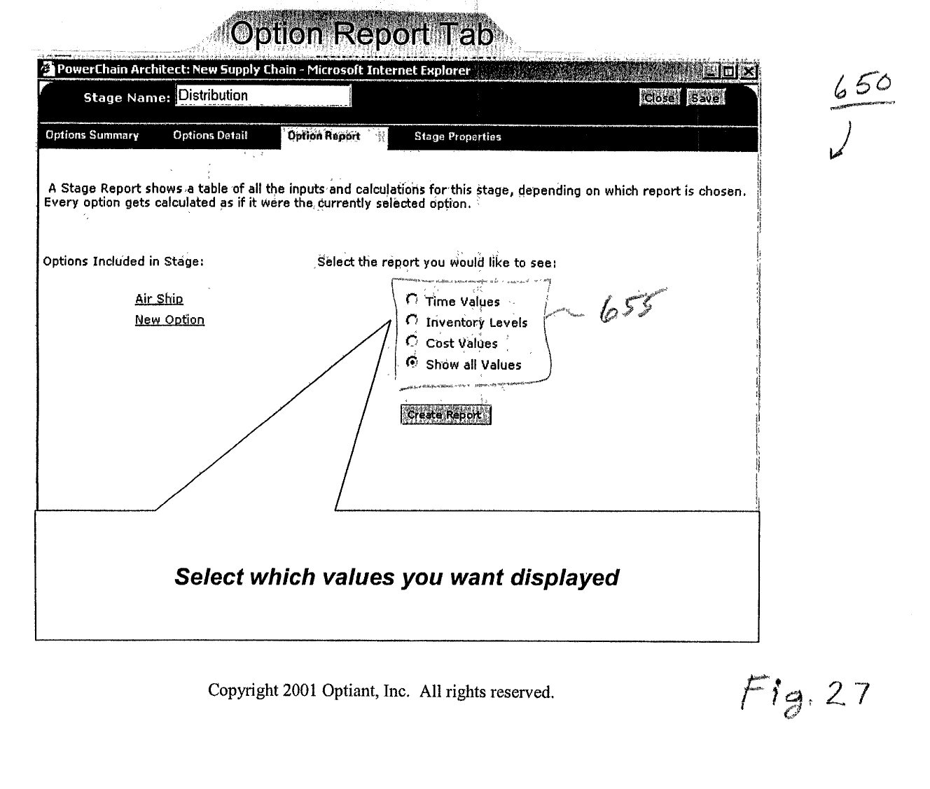

FIG. 27 shows an exemplary embodiment of an options report 650 in accordance with the present invention. Referring to FIG. 27, options report 650 may include one or more report selection buttons 655 by which a user may select a particular options report. As shown in FIG. 27, in one embodiment report selection buttons 655 provide the user the capability to choose to view the time-based values, inventory levels, cost values, or all values associated with one or more options for a particular stage 405.

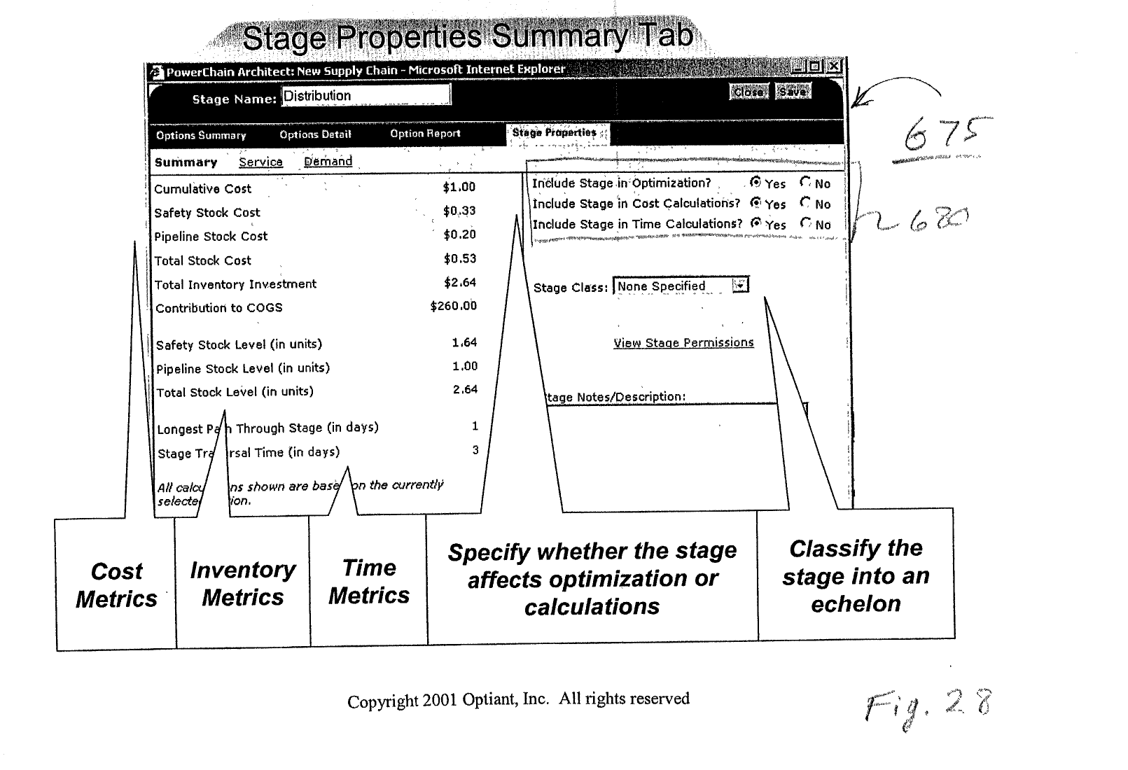

FIG. 28 shows an exemplary embodiment of a stage properties summary 675 in accordance with the present invention. Referring to FIG. 28, stage properties summary 675 may include a presentation of the values and parameters associated with the option currently selected for the stage 405. In particular, a series of optimization selection buttons 680 may be provided for a user to specify in more detail which, if any, particular optimization calculations from which to exclude the stage 405 from consideration. For example, in one embodiment as shown in FIG. 28, a user may specify, using optimization selection buttons 680, that a stage is to be excluded from all optimization, only cost optimizations, or only time optimizations.

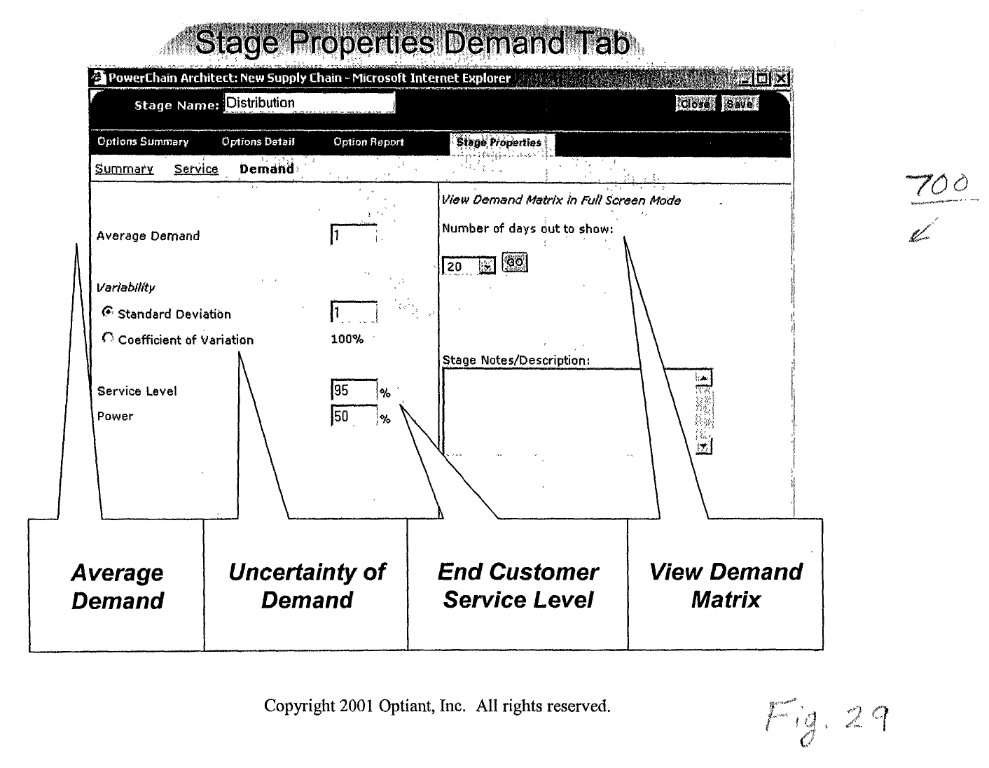

Further to these reports and editing capabilities, a user may also specify particular characteristics of the demand statistics that apply to a particular stage. FIG. 29 shows an exemplary embodiment of a stage properties demand page 700 in accordance with the present invention. Referring to FIG. 29, stage properties demand page 700 may include one or more data entry fields in an interactive display page for a user to specify stage demand statistics for modeling, including, but not limited to, average demand as well as the standard deviation and coefficient of variation of demand that applies to the stage. In one embodiment, the capability is provided for a user to specify a pooling factor for a given stage. The pooling factor may be used to represent the statistical independence of two or more demand streams operating at a stage that represents a distribution stage.

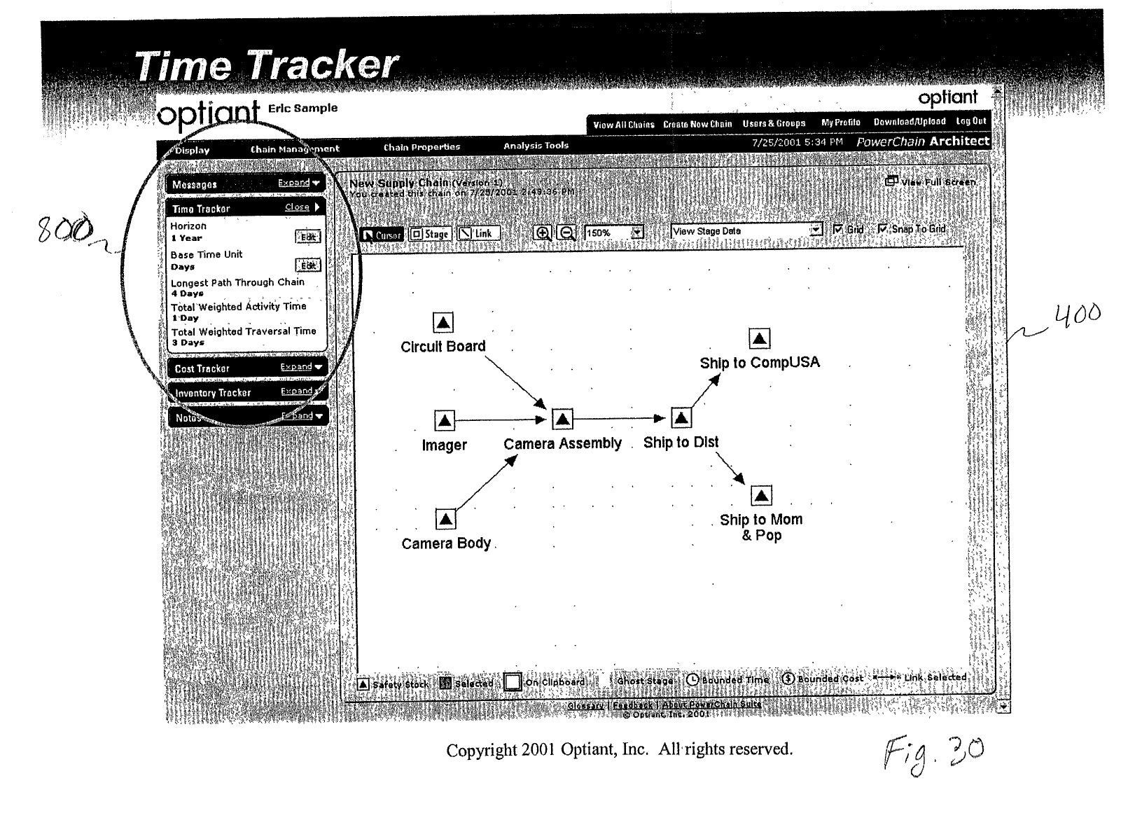

Additional reporting capabilities provided by an embodiment of the present invention includes one or more metrics tracking reports. In particular, computing system 200 configured according to the present invention may include metrics trackers for reporting certain time metrics, cost metrics, and inventory metrics. Exemplary embodiments of these metrics tracking reports are shown in FIGS. 30, 31, and 32, respectively. FIG. 30 shows an exemplary time metrics tracking report 800 associated with a series of stages 405 representing a decision option chain 400.

As shown in FIG. 30, time metrics tracking report 800 may include a number of time-oriented metrics associated with a stage such as a time horizon specifying a period over which financial metrics are calculated, a base time unit, an indication of the longest path through the chain representing the sum of the stage times, a total weighted activity time indicating the weighted measure of the average stage time, and a total weighted traversal time indicating the weighted measure of the average stage time plus the average time spent in inventory throughout the chain.

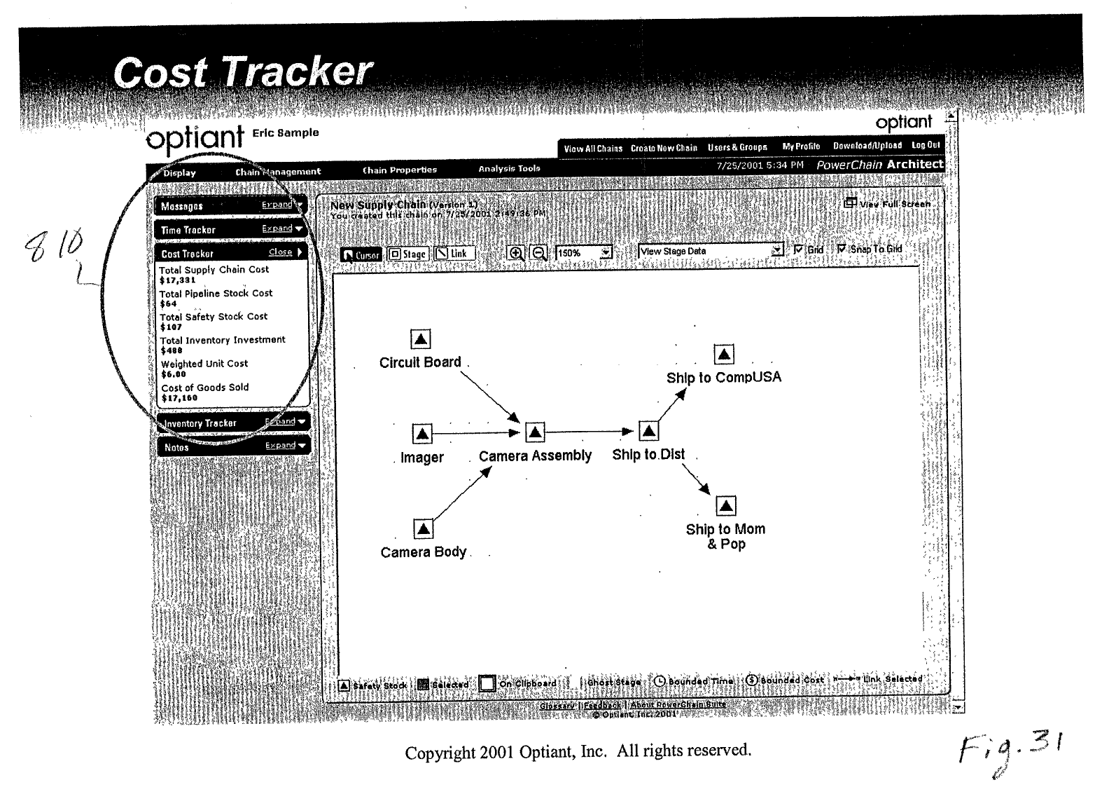

FIG. 31 shows a cost metrics tracking report 810 that may include a number of cost metrics associated with a stage such as a total supply chain cost which may represent the total inventory cost and product cost throughout the chain over the time horizon, a total pipeline stock cost throughout the chain over the time horizon, a total safety stock cost throughout the chain over the time horizon, a total inventory investment cost required to fill the chain before product can be released, a weighted unit cost which may represent the final product cost weighted across all customer demands, and a cost of goods sold value for the cost of final products sold over the time horizon.

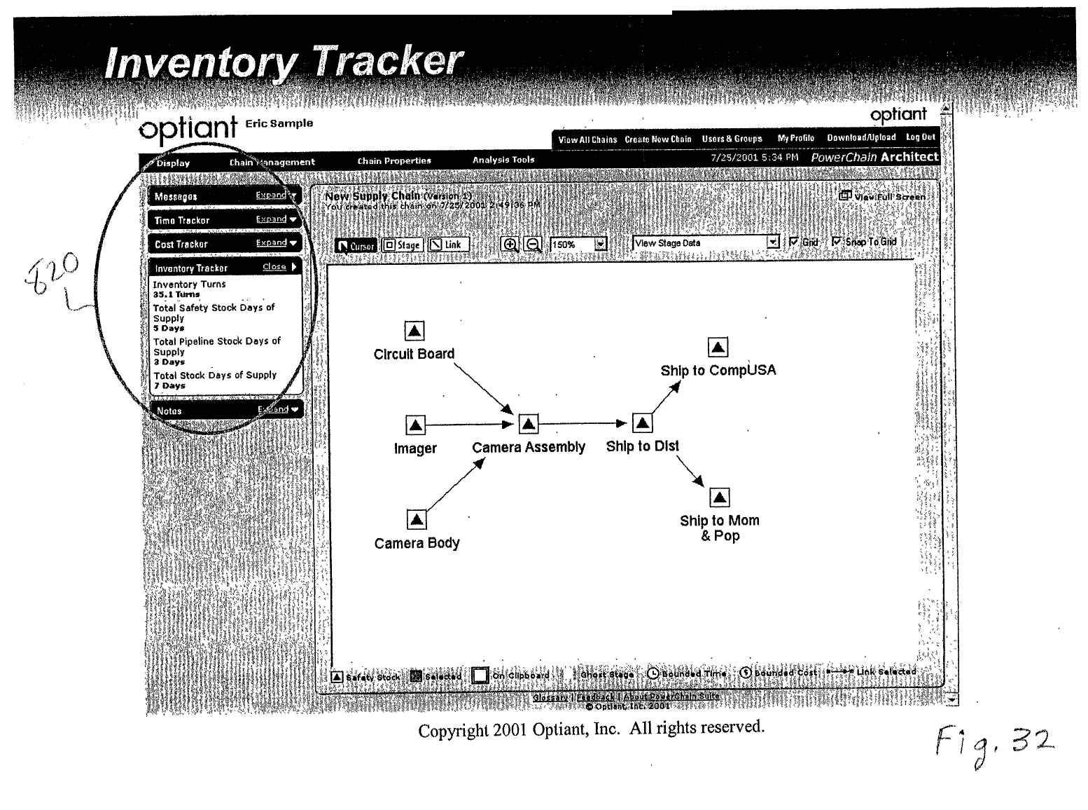

FIG. 32 shows an inventory metrics tracking report 820 that may include a number of inventory metrics associated with a stage such as inventory turns, total safety stock days of supply, total pipeline stock days of supply, and a total stock days of supply which may represent the number of periods of demand worth of inventory stored throughout the supply chain. Furthermore, in one embodiment the computer system 200 configured according to the present invention may calculate the optimum levels of safety stock (i.e., “right-sized”) for each stage of a supply chain.

6.3 Analysis Tools

The present invention may further provide one or more analysis tools useful for optimizing the supply chain in order to minimize the total costs of the overall supply chain. In one embodiment, an optimization tool is provided which applies the minimization calculations and methods described herein to the stage information, and the various options which may be associated with each stage, for the supply chain. In particular, the optimization tool determines those options at each stage which when selected operate to minimize the total costs of the supply chain. In this manner, the system and methods according to the present invention provide an end-to-end optimization across the complete decision option chain.

In one embodiment, a user may initiate optimization calculations provided by the optimization tool by selecting the corresponding interactive user selection tab using pointing device 230. Upon receiving the user request for optimization, computer system 200 may execute sequences of application software instructions embodying the optimization calculations described herein. As a result of the optimization calculations, computer system 200 may generate and display an updated chain home page 300 (reference FIG. 20) reporting the optimized options selected for each stage. The user may be a user of a client system 280, in which case the updated chain home page 300 may be transmitted to the client system 280 from a server 270 using a network 260.

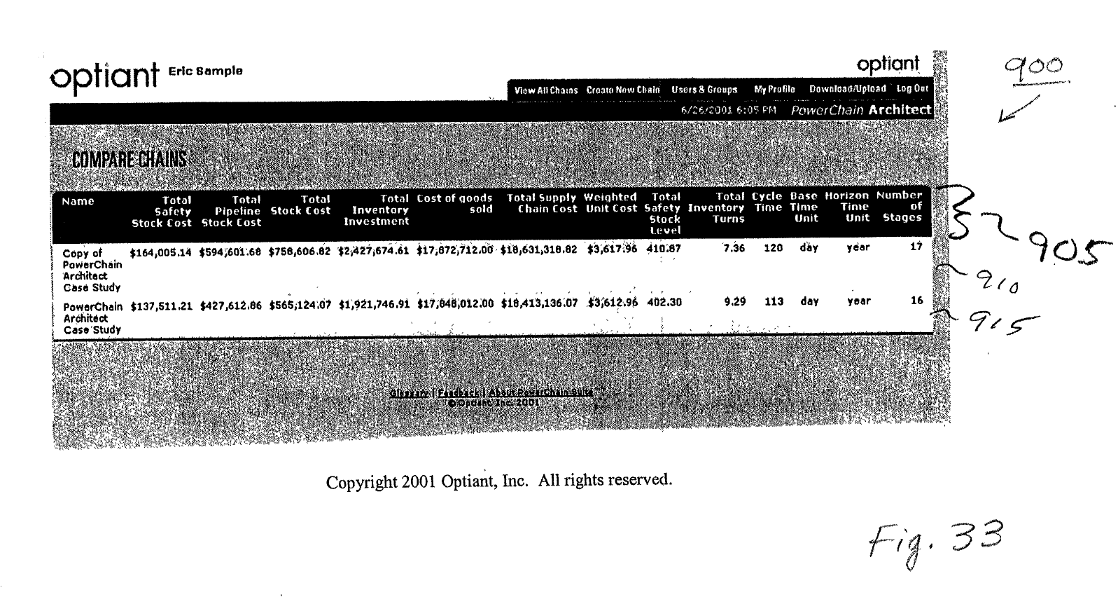

The present invention also may provide the capability to generate and present a side by side chain comparison report. FIG. 33 shows an exemplary embodiment of a chain comparison report 900 in accordance with the present invention. Referring to FIG. 33, chain comparison report 900 may show one or more total costs 905 for all stages for an optimum series of options 910 for a supply chain, as compared to the corresponding total costs 905 for all stages for another series of options 905 for a supply chain. As shown in FIG. 33, the total costs 905 may be presented in tabular form. Alternatively, the total costs 905 may be presented in graphical form.

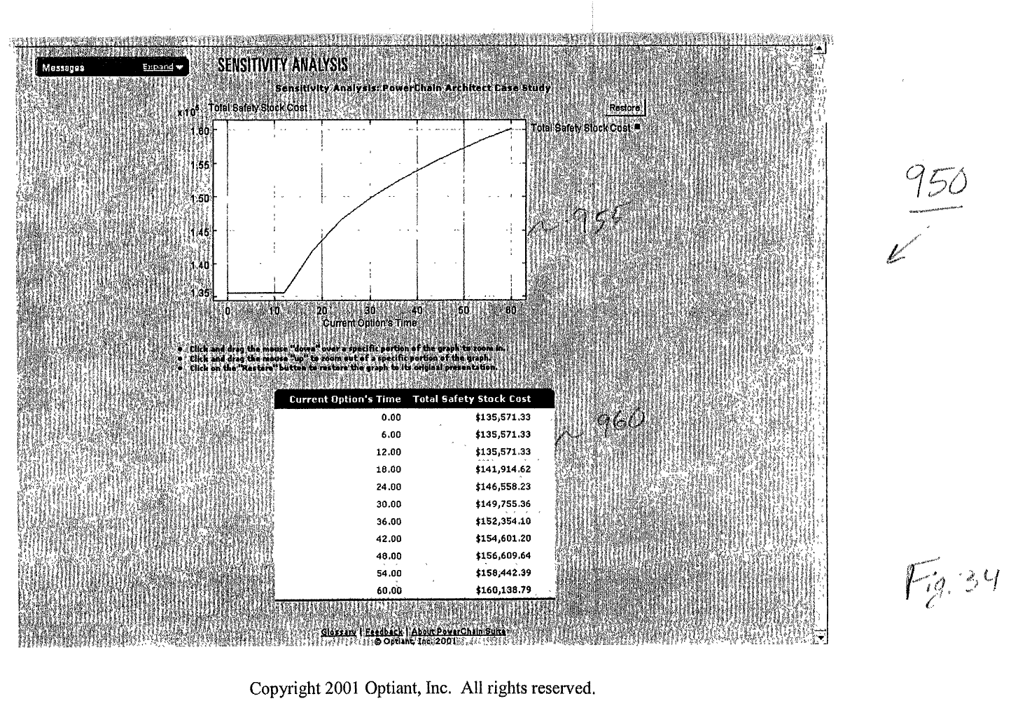

The present invention may also provide the capability to generate and present a sensitivity analysis. FIG. 34 shows an exemplary embodiment of a sensitivity analysis results page 950 in accordance with the present invention. Sensitivity analysis may be useful to provide an indication of the relevant impact to the overall chain total costs caused by a corresponding change in the information associated with the option under analysis. Typically, a sensitivity analysis is accomplished by varying the option information in discrete steps over a user-specified range and observing the calculated total costs for the overall chain over the same period of time. In one embodiment, the user may specify the range (i.e., the initial value and the final value) of the option information being varied, and may also specify the number of iterations to be calculated for the sensitivity analysis. The user may input these parameters using a corresponding sensitivity analysis input page and pointing device 230. As shown in FIG. 34, the sensitivity analysis results may be presented in graphical format 955 or tabular format 960.

In addition, computer system 200 in accordance with the present invention may include additional reports including, but not limited to the following:

a. A Profit/Loss Calculator that compares financial metrics (e.g., a simulated balance sheet) of a pre-optimized and a post-optimized (or a “before” and “after”) version of a supply chain model.

b. A Cost Breakout that allows a user to view high-level inventory cost and COGS, broken out by different groupings/aggregations of stages within the supply chain.

c. An Inventory Breakout showing unit inventory levels.

d. An Inventory by Cause Report providing a more detailed analysis of why inventory is being stored throughout the supply chain which may assist a user in determining the cause of inventory levels present throughout a supply chain (e.g., due to batching, early arrivals, demand uncertainty, or stage-time uncertainty).

e. An Configurable Chain Report which provides an ad hoc reporting tool for filtering, selecting, grouping, and presenting stage information in a user specified arrangement.

f. Custom Reports for user specified presentations of stage information and additional metrics calculated according to user requirements.

7.0 Part Selection in Multigeneration Products

7.1 Introduction

Another aspect of the present invention is the determination of optimal part selection strategies in multigeneration products. The object of this invention is to provide a decision support tool that a product development team can use when they are determining what parts to design into their product. The model framework considers the development cost associated with redesigning the product, the part manufacturing cost and the level of functionality that the part must provide. The part selection problem seeks to choose the optimal set of parts that minimize the sum of the development and manufacturing costs subject to satisfying each period's functionality requirements.

This section will look at determining optimal part selection strategies in multigeneration products. The goal is to develop a decision support tool that a product development team can use when they are determining what parts to design into their product. The model framework considers the development cost associated with redesigning the product, the part manufacturing cost and the level of functionality that the part must provide. The part selection problem seeks to choose the optimal set of parts that minimize the sum of the development and manufacturing costs subject to satisfying each period's functionality requirements.

First, the modeling framework is introduced, followed by different cases that are formulated and solved. Then, a brief numerical example is presented.

7.2 Model Introduction

This section presents the basics of the modeling framework. The decision variables and inputs are defined.

7.3 Performance definitions

7.3.1 Part performance level

A single attribute, or a collection of attributes, determines the performance level of each part. A mapping function transforms the part's attribute into a performance level value, which may be a unit index value. The performance level value can range from negative to positive infinity. The nature of the attribute will dictate whether a part with a higher or lower performance level corresponds to a superior part. We assume that each part can be mapped into the performance level.

For some attributes, the mapping function is simply the multiplication of the technical attribute by a constant to create a unit-less index value. For example, for microprocessors, if the attribute of interest is speed, multiplying by 1/mhz creates a valid performance range; i.e., a 100 mhz processor has a performance of 100. For other attributes, like weight or picture quality, more complicated mapping functions are necessary. It will be understood by those skilled in the art that any mapping function is contemplated. Additionally, the mapping function may include interpolation of the attribute of interest with a predefined, computer memory stored table of data.

For each part i, we let aᵢ denote its attribute of interest. The function pⱼ(aᵢ) then converts part i's attribute into its corresponding performance level in period j. Note that the performance mapping function, pⱼ( ), is period dependent. Thus, we can allow the part to decline relatively to other available parts. In addition, if the performance level is a function of multiple attributes, then aᵢ would be a vector of these attributes.

7.3.2 Performance requirement

Each period, there is a performance value that represents the desired part performance level value. The performance level value may thus be a desired index value for each component in each of said periods. The desired index value and the index value of the performance requirement value are of the same units. Informally, this corresponds to the market's “sweet spot.” If cost was not a concern and the set of available parts was sufficient to cover all possible performance levels, then each period the selected part's performance level would equal the period's performance requirement. However, since these two conditions are not met each period, it will not always be feasible, let alone optimal, to meet exactly the performance requirement each period.

The nature of performance requirement dictates the solution procedure employed. Two cases are considering: when the performance requirement is deterministic and when the performance requirement is an independent random variable. When the performance requirement is deterministic, each period's performance requirement is known with certainty at the start of the problem horizon. In this case, the performance requirement value may be determined from a predefined function. In the case where the performance requirement is a function of a random variable, the probability distribution for each period's requirement is known at the start of the horizon.

7.4 Timing of Events

We consider a firm that is determining its part selection strategy for the next N periods, where time proceeds from period 1 to period N. At the start of each period, the period's performance requirement is realized. The firm then chooses the part that will be used to satisfy the current period's performance and demand requirements. After the part has been selected, the period's costs are incurred.

7.5 Part indexing

Let n denote the total number of distinct parts that are available in at least one of the N periods. We assume that the parts are indexed from 1 to n and that a part's index stays constant across periods. That is, if part i is available in two different periods, then part i refers to the same part. A further impact of this assumption is that the set of parts available each period will likely not be numbered contiguously. Since a part's performance level can be period dependent, we can not order the parts in an ascending or descending order based on their performance levels.

We let Sⱼ denote the set of parts that are available in period j.

7.6 Costs

There are three relevant costs to consider: development cost, manufacturing cost and recycling cost.

7.6.1 Development cost

A development cost of K is incurred whenever the part used in the current period in the product differs from the part used in the previous period. Typical activities that must occur when a new part is selected include redesigning the interface between the part and the rest of the product, prototyping the new part, and certifying the part's supplier. Although the development cost could be both part and time dependent, we assume that it is a constant in our formulation. This is due to the example that motivated this research.

7.6.2 Manufacturing cost

Manufacturing cost is composed of the costs required to make a part in the current period. Typical costs include the procurement of raw materials and the transformation of the raw materials into completed parts. The period's unit manufacturing cost will depend on its initial cost net any discounts that can depend either on cumulative production volume or the length of time the part has been used. We denote the initial unit cost of part i in period j by cᵢⱼ.

This model considers both time and quantity discounts. In practice, both discounts are specified in the part's contract; this contract would be written in period t after the part is selected.

The time discount is a negotiated price break that occurs in every period the part is produced. For example, the discount might be 5% of the initial part cost for each period that the part is used. The volume discount is based on the part's cumulative production volume prior to the start of the current period. For example, the supplier might give a 1% discount for every 100,000 units purchased in earlier periods.

Let eᵢⱼ(t, v) denote the discount rate for part i in period j given that the part was introduced in period t and the cumulative production up to period j equals v. It is defined below:

$$eij ( t , v ) = ( j - t ) α i + [ \frac{v}{vi} ] β i for j \geq t \qquad ( 27 )$$

where αᵢ is the time-dependent discount, βᵢ is the volume-dependent discount, and vᵢ is the volume discount step size; these constants are all part specific.

7.6.3 Recycling cost

There are two ways to satisfy demand in the current period. First, as described above in Section 7.6.2, they can produce new parts. Second, the firm can recycle parts that are returned (the company has an active and successful recycling program). The cost to recycle an existing part is significantly less than the cost of producing a new part. Recycling an existing part requires extricating the part from the housing and testing it to make sure that the part is still functional.

It is important to note that only the products containing the current part are worth recycling. Since the product had to be modified to accommodate the current part, older parts are unusable even if they still function properly. Let yᵢ denote the cost of remanufacturing part i. Remanufacturing is a labor-dominated process and as such does not depend on the period or the part's original manufacturing cost.

7.7 Production and demand requirements

Before the part selection problem can formulated, the demand and recycling processes must first be characterized.

7.7.1 Demand process characterization

Assume that demand each period is deterministic. Demand in period j is denoted dⱼ.

7.7.2 Recycling process characterization

Of interest is characterizing the stream of recycled parts that are available to use in each period. In the context of recycling, let τ denote the useful life of the product. That is, a product produced in period t can only be recycled during the interval [t+1, t+τ]. γₖ is a scalar that represents the fraction of parts used in period t−k that are returned in period t. Since we can not receive more units than was shipped in a period, it must be true that:

$${\sum }_{k = 1}^{τ} γ k \leq 1$$

where the constraint is satisfied with equality only when all the parts produced in a period are eventually returned within τ periods.

Let qⱼ(t) denote the number of recycled parts that are available to satisfy demand in period j given that the part was introduced in period t. qⱼ(t) is a function of the amount of the current part in circulation, and is computed as follows:

$$qj ( t ) = {\sum }_{k = 1}^{l} ( γ k ) {(}^{d} j - k ) where l = min ( τ , t - j ) \qquad ( 28 )$$

For example, if τ=3, the current period is 5 and the part was introduced in period 1, Equation (28) would look like:

q5(1)=γ₁d₄+γ₂d₃+γ₃d₂.

7.7.3 Cumulative production recursion

The presence of recycling makes the calculation of the cumulative production slightly more cumbersome. The cumulative production is not simply the sum of the demands from previous periods. Depending on τ and when the part was introduced, a part produced in a previous period might be reused multiple times.

We let vⱼ(t) denote the cumulative production at the start of period j given that the part was introduced in period t. vⱼ(t) is calculated as follows:

vⱼ(t)=dⱼ₋₁−qⱼ₋₁(t)+vⱼ₋₁(t) (29)

where vⱼ(t)=0 if t≧j. The cumulative production at the start of period j equals the cumulative production at the start of period j−1 plus the amount of new production in period j−1. The amount of production in period j−1 is the difference between the period's demand and the amount of product returned in period j−1.

It is assumed that the demand in a period is always greater than the amount recycled in the same period. This is a valid assumption if the product is seeing steady annual growth.

7.8 Algorithm Formulation

As mentioned above, the formulation for the discrete part selection problem depends on the nature of the performance requirement. This section will treat separately two instances of the performance requirement. In the first case, the performance requirement is deterministic. That is, the performance requirement for each period is known with certainty at the start of period 1. In Section 7.9 (Case 1), this problem is formulated as a shortest path problem. In the second case, each period's performance requirement is an independent random variable. In this case, the distribution for each period's performance requirement is known at the start of period 1, but the period's requirement is not realized until the start of the period. In Section 7.10 (Case 2), this problem is formulated as a backward dynamic program.

Before these three algorithms can be constructed, there is first the need to describe how the performance requirement and the part performance level interact. This is described below.

7.8.1 Relating the performance requirement and performance level

Depending on the part being analyzed, the performance requirement can be enforced using a hard constraint or a target constraint. The specifics of the industrial application will dictate which type of constraint will be required. As we will see in later sections, the enforcement technique will significantly affect the problem's structure and the solution procedure. Therefore, we will analyze each of these enforcement techniques separately.

7.8.1.1 Hard constraint definition

If the enforcement is done using a hard constraint, then the chosen part's performance level must meet or exceed the period's performance requirement. If higher performance values denote superior performance (as in the case of processor speed) then this requires the part's performance level to meet or exceed the performance requirement. If lower levels denote superior performance (as in the case of product weight) then this requires the part's performance level to be no greater than the performance requirement. In either context, there is no penalty for exceeding the period's performance requirement. For example, if a digital camera's CCD must capture 768 bits in the current generation, a CCD capable of 1024 bit resolution is also permissible to use. In this case, the camera's software will ignore the higher resolution and only process images at 768 bits. However, a CCD that can only capture 512 bits is unacceptable because there is no way for this part to capture the required 768 bits.

Thus, the hard constraint acts to further limit the set of candidate parts in period j; only the subset of parts from the set Sⱼ that meet or exceed the performance requirement are candidates when there is a hard constraint.

7.8.1.2 Target constraint definition

If the enforcement is done using a target constraint, a penalty is imposed based on the deviation of the performance level from the requirement. For example, an example presented later in this chapter utilizes the target constraint when planning the size of a circuit board. The ideal size of the circuit board in the first period is 50 cubic centimeters. Larger and smaller sizes are feasible, but they will require a costly redesign of the product. A target constraint is also applicable when the performance level is an aggregation of several different technical attributes.

Rather than imposing a constraint in the problem formulation, we capture the target constraint by adding a quadratic cost to the objective function. A period-dependent scalar, rⱼ, is multiplied by the square of the difference between the chosen part's performance level and the realized performance requirement.

7.9 Case 1: Deterministic performance requirement

Let wⱼ denote the performance requirement in period j. Since the performance requirements are deterministic, their values are known for all jεN at the start of period 1.

7.9.1 Shortest path formulation

We formulate the shortest path problem on a N+1 node network where the nodes are labeled from 1 to N+1. Each node represents a period in the model, with node N+1 representing the termination of the horizon. An arc from j to k represents selecting a new part in period j and using it through period k−1. In this formulation, a development activity will occur in periods j and k. By construction, there can be no arcs (j, k) such that j≧k.

Let Cⱼₖ denote the cost on the arc from j to k, namely the cost of choosing the part that is feasible for periods j through k−1 and satisfies the periods' demand requirements at a minimum cost. If there is no part that is feasible for each of the periods j through k−1, then there will be no arc from j to k in the network. Cⱼₖ is determined below for both the hard constraint and target constraint cases.

7.9.1.1 Hard constraint case

In this section, it is assumed that higher performance levels denote superior performance. In the hard constraint case, the cost for the arc from j to k equals:

$${C}_{jk} = {min}_{i} [ K + {\sum }_{l = j}^{k - 1} [ 1 - eil ( j , vl ( j ) ) cij ( dl - ql ( j ) ) + yiql ( j ) ] ] \qquad ( 30 )$$

where 1≦j<k≦N+1 and i satisfies

$$\{ i : iε {⋂}_{l = j}^{k - 1} Sl , pl ( ai ) \geq wl for j \leq l < k \} . \qquad ( 31 )$$

Recall that qⱼ( ), the number of recycled parts that are available in period j, is given by (28) in Section 7.7.2 (Recycling process characteristics), vⱼ( ), the cumulative production in period j, is given by (29) in Section 7.7.3 (Cumulative production recursion), and eᵢⱼ( ), the discount rate for part i in period j, is given by (27) in Section 7.6.2 (Manufacturing cost). Equation (30) represents the minimum cost of choosing a part in period j and using that part through period k−1. There are three components of this cost. First, a development cost of K must be incurred since one development cycle will occur during the interval [j, k−1]. Second, the manufacturing cost for new parts is incurred. The per unit cost in a period is the initial unit manufacturing cost net any discounts accrued since period j. The number of new units manufactured in a period equals the period's demand net any units that are recycled in the period. Finally, a remanufacturing cost is applied to all of the units that are recycled each period.

The minimization in (30) occurs over the set of parts that meet two conditions: First, they must be available in periods j to k−1. Second, they must meet or exceed each period's performance requirement. This set is constructed in (31).

7.9.1.2 Target constraint case

As mentioned in Section 7.8.1.2, the target constraint is captured by adding a quadratic penalty cost to the objective function. The cost of the arc from j to k equals:

$${C}_{jk} = {min}_{i} \{ K + {\sum }_{l = j}^{k - 1} [ ( 1 - {e}_{il} ( j , {v}_{l} ( j ) ) ) {c}_{ij} ( {d}_{l} - {q}_{l} ( j ) ) + {y}_{i} {q}_{l} ( j ) + {{r}_{l} ( {p}_{l} ( {a}_{i} ) - {w}_{l} )}^{2} ] \} \qquad ( 32 )$$

where 1≦j<k≦N+1 and i

$$ε {⋂}_{l = j}^{k - 1} {S}_{l} .$$

The development, manufacturing, and recycling costs in (32) are the same as in (30). The additional term in (32) captures the per period penalty cost incurred when the part's performance level deviates from the period's performance requirement. The only requirement for a part to be considered is that it must be available from period j through period k−1.

7.9.2 Problem complexity

When the shortest path is constructed and solved, the bottleneck operation is the construction of the network itself. Recall that the total number of parts available during the problem's horizon is n. There will be a maximum of N arcs emanating from each node. Therefore, the complexity of the network construction phase is O(nN²).

7.10 Case2: independently distributed performance requirements

The performance requirement in period j is a random variable denoted by Wⱼ. At the start of period 1, for all jεN, Wⱼ has a known probability density function φⱼ(w) and distribution function Φⱼ(w). At this point, we assume that the Wⱼ are independent for all jεN. Without loss of generality, we assume that period j's performance requirement, wⱼ, is realized at the start of period j. At some point before period j's demand occurs, the design team knows the requirement for period j. This model assumes that the requirement becomes known at the start of the period.

7.10.1 Hard constraint case

For this section it is assumed that higher performance levels denote superior performance. When the performance requirement is a random variable, the hard constraint case is formulated as a backward dynamic program. There are two state variables: the part used in the previous period and the period in which the part was introduced. We need to keep track of the part's introductory period in order to determine the amount recycled in the current period as well as the current period's discount rate.

Let gⱼ(i, t, k) denote the cost in period j if the initial state is (i, t) and part k is selected. gⱼ(i, t, k) is defined below:

$${g}_{j} ( i , t , k ) = \{ \begin{matrix}( 1 - {e}_{ij} ( t , {v}_{j} ( t ) ) ) {c}_{ij} ( {d}_{j} - {q}_{j} ( t ) ) + {y}_{i} {q}_{j} ( t ) & if k = i \\ K + {c}_{kj} {d}_{j} & o . w .\end{matrix}$$

The value of gⱼ(i, t, k) depends on whether or not part i is replaced in period j. If part i is not replaced (k equals i) then the part used in period j is the same part that was used in period j−1, and the recycling stream and discounts from previous periods have to be considered. This corresponds to the first expression for gⱼ(i, t, k). If part i is replaced (k does not equal i), then production in period j is starting from scratch. There are no discounts to apply and no recycled parts available to remanufacture. In this case, the only two costs that are incurred are the development cost and the cost to manufacture the entire period's demand.

Let fⱼ(i, t, w) represent the minimum cost from periods j through N given that the state at the start of period j is (i, t) and the realized performance requirement in period j is w. fⱼ(i, t, w) is formulated below:

$${f}_{j} ( i , t , w ) = {min}_{k} \{ {g}_{j} ( i , t , k ) + {f}_{j + 1} ( k , j ) \} \qquad ( 33 )$$

where k satisfies kεSⱼ and pⱼ(aₖ)≧w.

The cost-to-go function, fⱼ(i, t), represents the minimum cost from periods j through N given that the state at the start of period j is (i, t). The state variable definition allows the cost-to-go function to be separated into the cost in period j plus the optimal cost-to-go for periods j+1 through N. In the hard constraint case, the cost-to-go Equation equals:

fⱼ(i,t)=E{fⱼ(i,t,w} (34)

where 1≦j≦N.

7.10.2 Target constraint case

As with the deterministic performance requirement presented in Section 7.9.1.2 (Target Constraint Case), the stochastic performance constraint can be solved as a shortest path problem when the target constraint is employed. Recall that in the target constraint case, a part that belongs to Sⱼ is not excluded in period j if the part's performance level does not exceed the performance requirement. A cost is incurred in the objective function, but it is still possible to use the part. Therefore, in the target constraint case, each period's set of feasible parts is known at the start of the horizon.

As in the deterministic formulation, we formulate the shortest path problem on a N+1 node network where the nodes are labeled from 1 to N+1. Each node represents a period in the model, with node N+1 representing the termination of the horizon. In the stochastic formulation, an arc from j to k represents the expected cost of selecting a new part in period j and using it through period k−1, where the expectation is taken over the performance requirements from period j through k−1.

Let Cⱼₖ denote the expected cost of choosing the part that is feasible for periods j through k−1 and satisfies the periods' demand requirements at a minimum cost. If there is no part that is feasible for each of the periods j through k−1, then there will be no arc from j to k in the network. Cⱼₖ is determined below:

$${C}_{jk} = {min}_{i} {\{}_{Wj , … ,} {E}_{Wk - 1} [ K + {\sum }_{l = j}^{k - 1} [ 1 - eil ( j , vl ( j ) ) ) cij ( d l - ql ( j ) ) + yipl ( j ) + {rl ( pl {(}^{a} i ) - wl )}^{2} ] ] \} \qquad ( 35 )$$

where 1≦j≦k≦N+1 and i satisfies i

$$ε {⋂}_{l = j}^{k - 1} {S}_{l} .$$

Recall that qⱼ( ), the number of recycled parts that are available in period j, is given by Equation (28) in Section 7.7.2, vⱼ( ), the cumulative production in period j, is given by Equation (29) in Section 7.7.3, and eᵢⱼ( ), the discount rate for part i in period j, is given by Equation (27) in Section 7.6.2. Equation (35) represents the minimum expected cost of choosing a part in period j and using that part through period k−1. There are four components of this cost. First, a development cost of K must be incurred since one development cycle will occur during the interval [j, k−1]. Second, the manufacturing cost for new parts is incurred. The per unit cost in a period is the base unit manufacturing cost net any discounts accrued since period j. The actual number of new units manufactured in a period equals the period's demand net any units that are recycled in the period. Third, a remanufacturing cost is applied to all of the units that are recycled each period. Finally, a quadratic penalty cost is applied to the deviation of the part's performance level from each of the performance requirements in periods j through k−1. The per period penalty cost is the square of the difference between the performance level value in a given period for a given component and the performance requirement value in the given for the given component, multiplied by a period dependent constant, rl. The period dependent constant, rl, may be an input.

It is now shown that the stochastic formulation can be converted into the deterministic formulation. Certainly equivalence holds when the optimal solution from a stochastic formulation remains the same after the random variables are replaced with their expected values. Their costs will differ by a constant, but the optimal solution is the same.

That certainty equivalence holds in this case can be seen by performing some basic algebraic manipulations of Equation (35). We first separate the quadratic penalty cost as shown below:

$$\begin{matrix}{C}_{jk} = {min}_{i} \{ [ K + {\sum }_{l = j}^{k - 1} [ 1 - eil ( j , vl ( j ) ) ) cij ( dl - ql ( j ) ) + yiql ( j ) ] + \\ Wj , … , EWk - 1 [ {\sum }_{l = j}^{k - 1} [ {rl ( pl ( ai ) - wl )}^{2} ] ] ] \}\end{matrix} \qquad ( 36 )$$

Since the expectation of the sum equals the sum of the expectations, we can further rewrite Equation (36) as:

$$\begin{matrix}{C}_{jk} = {min}_{i} \{ [ K + {\sum }_{l = j}^{k - 1} [ ( 1 - eil ( j , vl ( j ) ) ) cij ( dl - ql ( j ) ) + yiql ( j ) ] + \\ {\sum }_{l = j}^{k - 1} [ rl ( {pl ( ai )}^{2} - 2 pl ( ai ) E [ wl ] ) ] ] \} + {\sum }_{l = j}^{k - 1} [ rlE [ {wj}^{2} ] ]\end{matrix} \qquad ( 37 )$$

where the last term has been removed from the minimization because it does not depend on i. Finally, if we complete the square, we can rewrite (36) as:

$$\begin{matrix}{C}_{jk} = {min}_{i} \{ [ K + {\sum }_{l = j}^{k - 1} ( 1 - eil ( j , vl ( j ) ) ) cij ( dl - ql ( j ) ) + yiql ( j ) ] + \\ {\sum }_{l = j}^{k - 1} [ {rl ( pl ( ai ) - E [ wl ] )}^{2} ] ] \} + {\sum }_{l = j}^{k - 1} [ rl ( E [ {wj}^{2} ] - {E [ wj ]}^{2} ) ]\end{matrix} \qquad ( 38 )$$

The minimization considers four costs: the development cost, manufacturing cost, remanufacturing cost, and quadratic penalty cost. However, the quadratic penalty cost depends only on the expected values of the performance requirements. The final terms (on the third line of Equation (38)) are outside the minimization since they do not depend on i. On the path from j to k, this is the constant by which the deterministic and stochastic formulations differ.

When the deterministic formulation is populated with the means of the periods' performance requirements, the constant by which the stochastic and deterministic formulations will differ equals:

$${\sum }_{l = 1}^{N} [ rl ( E [ {wj}^{2} ] - {E [ wj ]}^{2} ) ] \qquad ( 39 )$$

The constant by which the two formulations differ equals the summation of each period's penalty cost times the variance of the period's performance requirement. As the variance increases, so too does the constant.

Recasting the stochastic formulation as a deterministic shortest path problem significantly reduces the problem's computational time. Certainty equivalence will always hold when the problem consists of a quadratic penalty function and linear constraints. For a different construction of the certainty equivalence result, the interested reader is referred to Bertsekas (1995).

The above method for determining the optimal set of components to be used in a product over a series of periods is generally summarized using a flowchart shown in FIG. 37. In an embodiment, the method of the present invention as shown in FIG. 37 may be implemented using a computer system such as, for example, computer system 200 as set forth herein and configured to perform the processing steps as specified in FIG. 37.

Generally, referring to FIG. 37, the method comprises receiving, at B50, information corresponding to each of a plurality of components used in a product. The information includes first data and second data, wherein the first data is the quantifiable attribute of interest and the second data is an availability of each component in each of a plurality of time periods. The method includes determining (at B54), based upon the information received at B50, corresponding functionality requirements that each component must provide over each of a series of the periods that the corresponding component is incorporated into the product. Generally, the method determines the optimal set of components to be used in said product over a series of said periods that minimizes a cost functional subject to satisfying at least one of said second data and said functionality requirements over said series of said periods, wherein said cost functional includes the sum of at least one of a development costs and a manufacturing costs of said product over said series of said periods. The solution method differs depending on whether the problem is a Hard Constraint Case or a Target Constraint Case.

If the problem is a Hard Constraint Case (determined at B66), Equation (30) (i.e., the cost functional) is evaluated and minimized, beginning at B70. If the problem is a Target Constraint Case, Equation (32) (i.e., the cost functional) is evaluated and minimized, beginning at B82. In the Hard Constraint Case (at B70), the method includes proceeding in sequential order from the last period N of said series of periods to the first period 1 of said series of periods. At each period, the method includes determining, at B74, the cost functional value at each period to define given period costs. The method includes determining, at B78, the cost functional at each period from the given period to the last period for each of the components to define feasible period costs. The method includes minimizing, at B88, the sum of the given period costs and the feasible period costs over the series of periods subject to satisfying the second data and the functionality requirements over the series of the periods.

In the Target Constraint Case (at B70), the method includes proceeding in sequential order from the last period N of said series of periods to the first period 1 of said series of periods. As discussed above, the cost functional of Equation (32) include includes the per period penalty cost. Generally, the method includes determining, at B82, the cost functional for each of the components at each period to define second feasible period costs. The method includes minimizing, at B92, the second feasible period costs over the series of periods subject to satisfying the second data over the series of the periods.

The above method for determining the optimal set of components may be implemented on a computer or computer system, which is described in Section 6.0. In an embodiment, the method of the present invention for determining the optimal set of components as shown in FIG. 37 may be implemented using computer system 200 as set forth herein and configured to perform the processing steps as specified in FIG. 37.

7.11 Example

This section presents an exploratory application of the part selection problem. Section 7.1 1.1 describes the company's current part selection process. Section 7.11.2 presents an initial investigation to see if the model is applicable to their problem.

7.11.1 Current Process

A hypothetical firm's product competes in a high volume consumer-focused business. For the purposes of this section, we will assume that the firm sells a handheld personal digital assistant (PDA). Size, as measured by the product's volume, is the primary differentiating characteristic in the market. As a general rule, the smaller the product, the more desirable consumers find the product. The product category has existed for several years now and the company has been quite good at estimating the size requirements for future versions of the product.

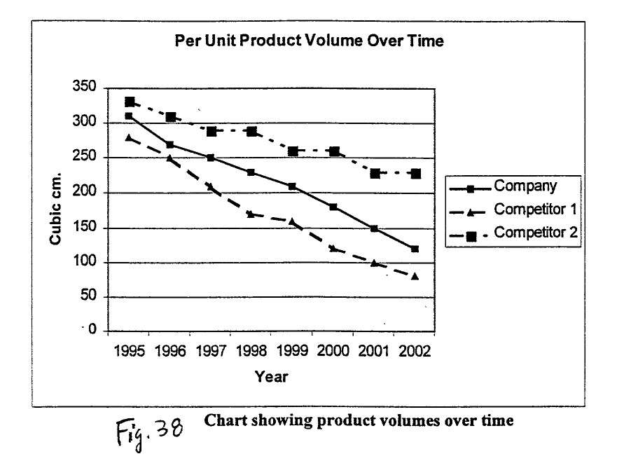

FIG. 38 contains a version of the recent history for the product category's volume requirements over time.

The market place is populated with three firms, although it is dominated by two firms: Competitor 1 and the sponsor company. The customer marketplace has been segmented according to size and cost preferences. Competitor 1 has established itself as the leader in PDA miniaturization, allowing it to charge a market premium and to attract lead users who value this feature. The sponsor company has kept pace with Competitor 1 but its product is consistently larger. Its product costs slightly less, thereby targeting a more price sensitive customer segment.

Currently, product introductions occur once a year in the Fall. The product introduction coincides with the industry's large trade show.

A PDA is composed of several standard off-the-shelf components like the LCD display and the serial connector. The company's operating procedure has been to assume that each component takes up a certain percentage of the product's total volume. Smaller and larger volume options are available, but the smaller volume option will significantly increase the per unit cost of the component. The bulk of the cost for the product is the circuit board. Although this part's functionality does not change significantly from year to year, its size does.

As a general rule, the circuit board consumes twenty five percent of the product's volume. If a higher volume circuit board is chosen, then less space is available for other parts, so more expensive components will have to be used for the other parts. If a lower volume circuit board is chosen, then the plastic housing can be designed to fill the space that is not consumed by the circuit board. However, a smaller circuit board requires smaller parts which can significantly increase the board's price.

Each generation, the cost of a new circuit board with a volume of 25% of the product's volume is typically right around fifty cents. Two factors contribute to this general rule. First, the entire industry has a good sense of what the product size requirements will look like over time. Second, the industries that provide components are also miniaturizing their offerings at a well-defined rate. The combination of these two factors means that the price for a standard set of components is nearly constant from generation to generation, although the size of the components has decreased each generation.

If a firm wanted to use a smaller circuit board, that would be possible but the per unit cost can run upwards of one dollar and fifty cents. In this firm, one often hears the comment “pennies matter.” And this advice is quite appropriate. Since product volumes are 400,000 units a year and growing at 15% a year, the cost of choosing a circuit board that is smaller than necessary can easily exceed one hundred thousand dollars in the first year.

An important part of the company's strategic vision is the ability to let customers return a previous generation's product in exchange for a discount towards the purchase price of a new product. This corporate strategy was put in place in order to decrease the likelihood that an existing customer will switch to a rival's product. If the returned product's circuit board is the same board that is being used, then it can be put into the current generation's PDA. If the circuit board is a different board, then the entire product is scrapped. The circuit board is the only part worth recycling. All of the other components have either been scratched or are incompatible with the current product's design. While it is true that the plastic parts from each returned product are pulverized into plastic pellets, this cost is such a small part of the product's cost that it can safely be ignored.

The company's design strategy has been to redesign the product from scratch each generation (each year). This means that all components, including the circuit board, are redesigned each year. There are several reasons the company has done this. First, the company is struggling to revise the product each generation. There are few resource available to devote to solving problems that do not concern the next product launch. Second, the entire customer segment is growing rapidly. Therefore, the company's emphasis has been on delivering products that the customer wants to purchase in the current year. This product has not yet seen the kind of cost consciousness that is more prevalent in mature market segments. Third, up to this point, the company has had no way to characterize the benefits of doing anything other than myopically optimizing each generation's design.

To summarize, the company's current circuit board selection process consists of choosing the part that minimizes the circuit board cost in the current generation. This involves minimizing the per unit cost plus any cost that must be incurred based on the board's deviation from the “ideal” size that period. Whether a smaller or larger part is chosen will depend on the relative importance of these two costs.

7.12 Handheld Product Example

To explore the utility of this approach, this section will examine the part selection process for the years 1999 to 2002. The circuit board's yearly performance requirement is displayed below in Table 15.

TABLE 15
Circuit Board Performance Requirement

| | Performance |
|---|---|
| Year | Requirement (cm\hat{ }3) |
| 1999 | 52.5 |
| 2000 | 45.0 |
| 2001 | 37.5 |
| 2002 | 30.0 |

The performance requirement is estimated to equal twenty-five percent of the product's performance requirement; recall that the company's estimate of the performance requirements were displayed in FIG. 38. We assume that the performance requirements are deterministic.

We assume that there are 8 different circuit boards available. For simplicity, all eight boards are available in every period. The boards have performance levels ranging from 54 to 26 cubic centimeters. Although the performance level of each board does not vary by period, its initial part cost does vary. We assume that the board's per unit cost in a period is derived from the Equation:

min{$.50+(w−p)×$.03, $.33}

where w is the period's performance requirement and p is the part's performance level.

Although these numbers are entirely fictitious, the formula captures the proper behavior of a part's unit cost. If the part performance level equals the requirement, then the part costs fifty cents. If the part's performance level is larger than the requirement, then the part costs less than fifty cents. This corresponds to the case where the part is an older part. However, no part can cost less than 33 cents. Finally, if the part's performance level exceeds (is less than) the performance requirement, then the part is more expensive. The higher expense could either reflect the scarcity of the part or the increased cost due to the smaller components used. The performance level and initial part cost per period for each part are shown in Table 16.

TABLE 16
Part Performance Levels and Initial Costs

| | | Initial Cost by Year | | | |
|---|---|---|---|---|---|
| Part | Performance Level | 1999 | 2000 | 2001 | 2002 |
| 1 | 54 | 0.46 | 0.23 | 0.33 | 0.33 |
| 2 | 50 | 0.58 | 0.35 | 0.33 | 0.33 |
| 3 | 46 | 0.70 | 0.47 | 0.33 | 0.33 |
| 4 | 42 | 0.82 | 0.59 | 0.37 | 0.33 |
| 5 | 38 | 0.94 | 0.71 | 0.49 | 0.33 |
| 6 | 34 | 1.06 | 0.83 | 0.61 | 0.38 |
| 7 | 30 | 1.18 | 0.95 | 0.73 | 0.50 |
| 8 | 26 | 1.30 | 1.07 | 0.85 | 0.62 |

The development cost is initially assumed to equal $250,000 whenever the circuit board's design is modified. The entire product will be revised each period but the circuit board will only be revised when necessary. For this reason, the rest of the product's development costs are viewed as fixed and the analysis in this section focuses on the development of the circuit board.

In order to capture the effect of the recycling process, each year is separated into two six-month periods. Therefore, there are eight periods in the model. The recycling rate in the period after the part's introduction is assumed to be 50%. In all subsequent periods, the recycling rate is zero; using the notation in Section 7.7.2, τ=1.

To achieve the stated annual growth rate of 15%, the semiannual growth rate is set at 7.24%. As a starting point, we also assume that the demand in the first half of 1999 equals 200,000 units.

There is no time discount but there is a 1% quantity discount for every 100,000 circuit boards that are produced.

The scalar associated with the quadratic penalty cost was set to equal 1000. Recall that this scalar will be multiplied by the squared difference between the part's performance level and the period's performance requirement. Another way to view this scalar is that, each period, it acts to limit the set of parts to some set of parts centered at the ideal part performance level. Setting this scalar higher will act to reduce the set of parts that are realistic to consider each period.

The results in the Table 17 below summarize the optimal solution and the company's heuristic of redesigning the circuit board each period:

TABLE 17

| | | | |
|---|---|---|---|
| Part Used | Period Introduced | Last Period Used | Total Cost |

Company Heuristic

| | | | |
|---|---|---|---|
| 1 | 1999 | 1999 | 416,545 |
| 3 | 2000 | 2000 | 443,737 |
| 4 | 2001 | 2001 | 467,646 |
| 6 | 2002 | 2002 | 492,179 |
| Total ($k) | | | 1,820 |

Optimal Upgrade Strategy

| | | | |
|---|---|---|---|
| 2 | 1999 | 2000 | 697,595 |
| 5 | 2001 | 2002 | 819,782 |
| Total ($k) | | | 1,517 |

The company's heuristic is approximately $303,000, or 20%, more expensive than the optimal upgrade strategy. Recall that the arc from i to j denotes a part revision in both years i and j. We define a part selection strategy as a sequence of parts that cover every period in the model. That is, each period is served by exactly one part. To better understand the results in Table 17, we can separate the total cost for a part selection strategy into three costs: development cost, production cost and conformance cost. Development cost is the sum of the development costs incurred over the problem's horizon. The production cost is the total manufacturing and remanufacturing costs over the production horizon. The conformance cost is the total penalty costs incurred over the horizon. A summary of these costs is displayed in Table 18 below:

TABLE 18
Detailed Cost Analysis
Company Heuristic

| Part Used | Period Introduced | Last Period Used | Development | Production | Conformance |
|---|---|---|---|---|---|
| 1 | 1999 | 1999 | 250000 | 162045 | 4500 |
| 3 | 2000 | 2000 | 250000 | 191737 | 2000 |
| 4 | 2001 | 2001 | 250000 | 177146 | 40500 |
| 6 | 2002 | 2002 | 250000 | 210179 | 32000 |
| | | Totals ($k) | 1000 | 741 | 79 |

Optimal Upgrade Strategy

| | | | | | |
|---|---|---|---|---|---|
| 2 | 1999 | 2000 | 250000 | 385095 | 62500 |
| 5 | 2001 | 2002 | 250000 | 441282 | 128500 |
| | | Totals ($k) | 500 | 826 | 191 |

The company's heuristic does a good job of minimizing production and conformance costs, but it must incur a large development cost to achieve this. The optimal upgrade strategy incurs higher production and conformance costs but offsets these costs by skipping two product development cycles. The optimal strategy uses each circuit board for two product generations. To accomplish this, the optimal strategy overdesigns the product in the first year, incurring extra manufacturing cost. In contrast, the company's heuristic “underdesigns” the part each generation. Since the company is redesigning the part each generation, it is clear that they will either choose between the two parts that are closest to the performance requirement. Given the parameters presented in this example, the optimal decision is to choose the larger volume part. This is due to the decreased manufacturing costs associated with older parts.

7.12.1 Sensitivity analysis

It is now desired to better understand the impact that the development cost has on the optimal number of product revisions over the problem horizon. In order to do this, we want to express the cost of each upgrade strategy as a function of the develop cost. Let fᵢ(d) denote the minimum total cost when the development cost is d and the product is revised exactly i times over the product horizon.

We want to determine fᵢ(d) for i−1, 2, 3, and 4. To calculate fᵢ(d), we find the upgrade strategy that minimizes production and conformance costs subject to their being exactly i product revisions. Since the number of upgrades is fixed for each calculation, the development cost is not included in this calculation. The following table, Table 19, summarizes the optimal upgrade strategy when the number of upgrades is held fixed.

TABLE 19
Summary of Optimal Upgrade Strategies

| | | | | |
|---|---|---|---|---|
| Part | | | | |
| Used | Period Introduced | Last Period Used | Production | Conformance |

Four Part Development Strategy

| | | | | |
|---|---|---|---|---|
| 1 | 1999 | 1999 | 162045 | 4500 |
| 3 | 2000 | 2000 | 191737 | 2000 |
| 4 | 2001 | 2001 | 177146 | 40500 |
| 6 | 2002 | 2002 | 210179 | 32000 |
| | | Totals ($k) | 741 | 79 |

Three Part Development Strategy

| | | | | |
|---|---|---|---|---|
| 2 | 1999 | 2000 | 385095 | 62500 |
| 4 | 2001 | 2001 | 177146 | 40500 |
| 6 | 2002 | 2002 | 210179 | 32000 |
| | | Totals ($k) | 772 | 135 |

Two Part Development Strategy

| | | | | |
|---|---|---|---|---|
| 2 | 1999 | 2000 | 385095 | 62500 |
| 5 | 2001 | 2002 | 441282 | 128500 |
| | | Totals ($k) | 826 | 191 |

One Part Development Strategy

| | | | | |
|---|---|---|---|---|
| 4 | 1999 | 2002 | 1102319 | 567000 |
| | | Totals ($k) | 1102 | 567 |

The information in Table 19 is sufficient to calculate fᵢ(d). This is done in the Table 20, below.

TABLE 20
fᵢ(d) calculation

| i | fᵢ(d) |
|---|---|
| 1 | 820 + 4d |
| 2 | 907 + 3d |
| 3 | 1017 + 2d |
| 4 | 1669 + d |

Using the information in Table 20, we can now calculate the ranges for d where each upgrade strategy is optimal. Letting F(d) denote the optimal cost policy as a function of the development cost, F(D) is calculated below:

$$F ( d ) = \{ \begin{matrix}820 + 4 d & for d < 87 \\ 907 + 3 d & for 87 < d < 110 \\ 1017 + 2 d & for 110 < d < 652 \\ 1669 + d & for d < 652\end{matrix}$$

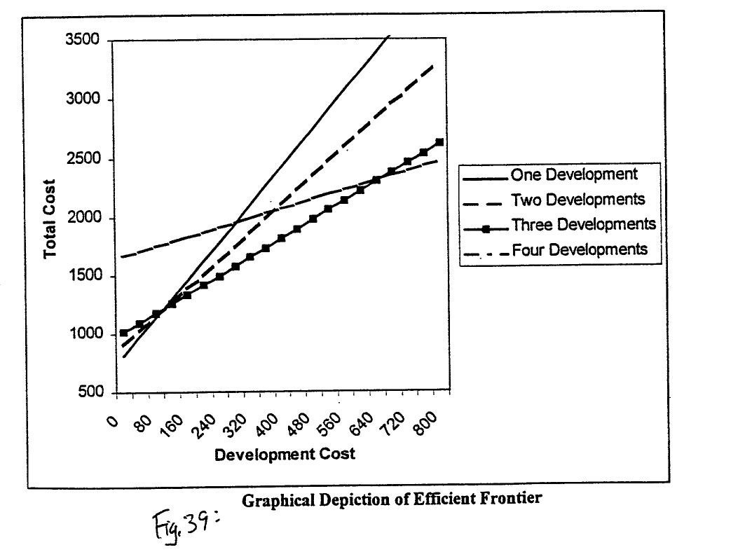

This section has calculated the efficient frontier for the optimal number of product revisions as a function of the development cost. A graphical representation of this efficient frontier is shown in FIG. 39.

7.14 General insights

At this point, several general insights can be drawn from an examination of the problem's structure. These results are summarized in Table 21 and described below in more detail.

TABLE 21
General Behavior of Optimal Solution

| Variable | Action | Effect on Number of Revisions |
|---|---|---|
| Development Cost | Increase | Decrease |
| Demand | Increase | Increase |
| Penalty Cost | Increase | Increase |
| Recycling Rate | Increase | Decrease |

As the development cost increases, the optimal number of revisions decreases. This is due to the fact that if the development cost increases, then it is more attractive to find paths that increase the penalty and conformance cost while lowering the development cost. As demand increases, the number of revisions also increases. The primary cost involved here is the production cost. As demand increases, the production cost increases. An increase in the penalty cost increases the number of part revisions. Increasing the penalty cost increases the total penalty cost, making it more optimal to find parts that might require a higher manufacturing cost but are more closely aligned with each period's requirement. Finally, increasing the recycling rate decreases the number of revisions. Increasing the recycling rate decreases the production cost when parts are used longer.

An informal way to look at these results is to note that different variables affect the self-sufficiency of each generation. Conditions that promote self-sufficiency in each generation make it cost effective to redesign the circuit board more often.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims.

What is claimed is:

1. A method, comprising:
receiving at least one data set for each of a plurality of interconnected stages, each data set corresponding to an option at the corresponding stage, each data set including a first cost and a second cost; and
determining, based upon said at least one data set, an optimum series of options over a series of said stages by selecting a single option at each stage in said series of said stages that minimizes the sum of total costs over said series of said stages, wherein said total costs is a function of said at least one data set.

2. The method of claim 1, further comprising:
transforming said series of said stages into a subgraph of numbered nodes from 1 to N such that each node corresponds to a stage and each node, except a last node N, has only one adjacent node to it that has a higher node number, said one adjacent node having said higher node number being a parent node.

3. The method of claim 2, further comprising:
proceeding in sequential order from node i=1 to node i=N−1, when the corresponding parent node for node i is downstream thereof:
a) determining the summation of said total costs contributed by node i as a function of first state variables to define first node i costs, said first state variables being a function of said first cost and said second cost over said nodes;
b) minimizing the summation of said total costs for the remainder of the nodes that are upstream of node i as a function of said first state variables to define first upstream node i costs;
c) minimizing the summation of total costs of the nodes that are downstream and adjacent of node i as a function of said first state variables to define first downstream node i costs;
d) summing the first node i costs, first upstream node i costs, and first downstream node i costs to define first minimum total costs for the subgraph rooted at node i;
e) minimizing the first minimum total costs for the subgraph rooted at node i over each said option and over a first parameter, said first parameter being one of said first state variables.

4. The method of claim 3, further comprising:
when the corresponding parent node for node i is upstream of node i:
a) determining the summation said total costs contributed by node i as a function of a plurality of second state variables to define second node i costs, said second state variables being a function of said first state variables;
b) minimizing the summation of said total costs for the remainder of the system that is upstream of node i as a function of said plurality of second state variables to define second upstream node i costs;
c) minimizing the summation of said total costs for the nodes that are downstream and adjacent of node i as a function of said plurality of second state variable to define second downstream node i costs;
d) summing the second node i costs, second upstream node i costs, and second downstream node i costs to define a second minimum total costs for the subgraph rooted at node i;
e) minimizing the second minimum total costs for the subgraph rooted at node I over each said option and over a second parameter, said second parameter being one of said second state variables.

5. The method of claim 4, further comprising:
for the last node, at node i=N:
a) determining the summation of said total costs contributed by node N as a function of said plurality of second state variables to define node N costs;
b) minimizing the summation of said total costs for the remainder of the nodes that are upstream of node N to define upstream node N costs;
c) minimizing the summation of said total costs for the nodes that are downstream and adjacent of node N as a function of said plurality of second state variables to define downstream node N costs;
d) summing the node N costs, upstream node N costs, and downstream node N costs to define third minimum total costs for the subgraph rooted at node N;
e) minimizing the third minimum total costs for the subgraph rooted at node N over each said option and over said second parameter.

6. The method of claim 5, further comprising:
selecting the option at each node that minimizes the sum of said total costs for the subgraph rooted at each node over said nodes.

7. The method of claim 5, wherein said plurality of first state variables includes a cumulative first cost at a given node, said cumulative first cost being the sum of said first costs of the preceding nodes of at least one option plus the first cost at the given node associated with a corresponding option.

8. The method of claim 7, wherein said plurality of first state variables includes an incoming service second cost at a given node, said incoming service second cost being the second cost of an option that a preceding node quotes fulfillment to the given node.

9. The method of claim 8, wherein said plurality of first state variables includes a maximum second cost at node i, the maximum second cost at node i being the maximum said second cost of said nodes that directly feed into a given node plus said second cost associated with a corresponding option.

10. The method of claim 9, wherein said plurality of first state variables includes an outgoing service second cost, said outgoing service second cost being the second cost of an option that a given node quotes fulfillment to a successive node.

11. The method of claim 8, wherein said first parameter is said incoming service second cost.

12. The method of claim 11, wherein said plurality of said second state variables include said first state variables having added to each thereto a corresponding said first cost and said second cost of a corresponding option.

13. The method of claim 12, wherein said second parameter is said outgoing service second cost.

14. The method of claim 1, wherein
said interconnected stages is a supply chain;
each of said plurality of stages represents an operation to be performed;
said first cost is a monetary amount associated with performing said operation; and
said second cost is an amount of time associated with performing said operation.

15. The method of claim 14, wherein said total costs include manufacturing costs of a given stage.

16. The method of claim 15, wherein said manufacturing costs at each stage is the product of an average demand for a product at a given stage and the monetary amount associated with each option.

17. The method of claim 14, wherein said total costs include inventory costs at a given stage.

18. The method of claim 17, said inventory costs include a safety-stock cost, said safety-stock cost being a cost associated with holding stock at a stage to protect against variability.

19. The method of claim 18, wherein said variability is variability of demand at the stage.

20. The method of claim 19, wherein said variability of demand is based on a forecast.

21. The method of claim 18, wherein said safety-stock cost at each stage is the product of an expected safety-stock cost at each stage, a holding cost rate, and a cumulative cost, said cumulative cost being the sum of said monetary amounts of the preceding stages plus the monetary amount at a stage associated with a corresponding option.

22. The method of claim 21, wherein said expected safety-stock at each stage is a maximum demand at each stage over an interval of time minus an average demand over said interval of time.

23. The method of claim 17, said inventory costs include a pipeline stock cost for each stage, the pipeline stock cost being a cost associated with stock undergoing said operation by the stage but not yet completed.

24. The method of claim 23, wherein the pipeline stock cost at each stage is a function of an expected pipeline stock at each stage multiplied by the average cost of the product at a given stage.

25. The method of claim 24, wherein the expected pipeline stock at each stage is the product of an average demand and said amount of time associated with a corresponding option.

26. The method of claim 14, wherein said total costs include a time-to-market cost at each stage.

27. The method of claim 26, wherein said time-to-market cost at each stage is the product of a weighted cost and a longest time path up to and including said amount of time associated with an option at the given stage.

28. The method of claim 14, said monetary amount includes at least one of a direct material cost and a direct labor cost associated with performing said function at said stage.

29. The method of claim 14, said amount of time includes at least one of a processing time required to put an item in inventory and a transportation time.

30. The method of claim 1, said first cost is a monetary amount associated with an option at a stage.

31. The method of claim 1, wherein said second cost is an amount of time associated with an option at a stage.

32. The method of claim 1, wherein each of said plurality of stages represents an operation to be performed.

33. A method of claim 1, wherein said interconnected stages is a production system.

34. A method of claim 33, wherein said production system is a supply chain.

35. A method of claim 1, wherein said series of said stages includes at least one of said plurality of stages.

36. A method of claim 35, wherein said at least one of said plurality of said stages includes all of said stages.

37. A method of claim 1, wherein said total costs is the summation of quantifiable characteristics, said summation of quantifiable characteristics being a function of said data sets.

38. A method of claim 37, wherein said summation of quantifiable characteristics includes at least one of a manufacturing cost, inventory cost, and time-to-market cost.

39. A method of claim 1, wherein said at least one data set includes a plurality of data sets.

40. A computer-readable medium encoded with a program for a computer, the program comprising:
receiving at least one data set for each of a plurality of interconnected stages, each data set corresponding to an option at the corresponding stage, each data set including a first cost and a second cost; and
determining, based upon said at least one data set, an optimum series of options over a series of said stages by selecting a single option at each stage in said series of said stages that minimizes the sum of total costs over said series of said stages, wherein said total costs is a function of said at least one data set.

41. The computer-readable medium of claim 40, further comprising:
transforming said series of said stages into a subgraph of numbered nodes from 1 to N such that each node corresponds to a stage and each node, except a last node N, has only one adjacent node to it that has a higher node number, said one adjacent node having said higher node number being a parent node.

42. The computer-readable medium of claim 41, further comprising:
proceeding in sequential order from node i=1 to node i=N−1,
when the corresponding parent node for node i is downstream thereof:
a) determining the summation of said total costs contributed by node i as a function of first state variables to define first node i costs, said first state variables being a function of said first cost and said second cost over said nodes;
b) minimizing the summation of said total costs for the remainder of the system that is upstream of node i as a function of said first state variables to define first upstream node i costs;
c) minimizing the summation of total costs of the nodes that are downstream and adjacent of node i as a function of said first state variables to define first downstream node i costs;
d) summing the first node i costs, first upstream node i costs, and first downstream node i costs to define first minimum total costs for the subgraph rooted at node i;
e) minimizing the first minimum total costs for the subgraph rooted at node i over each said option and over a first parameter, said first parameter being one of said first state variables.

43. The computer-readable medium of claim 42, further comprising:
when the corresponding parent node for node i is upstream of node i:
a) determining the summation said total costs contributed by node i as a function of a plurality of second state variables to define second node i costs, said second state variables being a function of said first state variables;
b) minimizing the summation of said total costs for the remainder of the system that is upstream of node i as a function of said plurality of second state variables to define second upstream node i costs;
c) minimizing the summation of said total costs for the nodes that are downstream and adjacent of node i as a function of said plurality of second state variable to define second downstream node i costs;
d) summing the second node i costs, second upstream node i costs, and second downstream node i costs to define a second minimum total costs for the subgraph rooted at node i;
e) minimizing the second minimum total costs for the subgraph rooted at node I over each said option and over a second parameter, said second parameter being one of said second state variables.

44. The computer-readable medium of claim 43, further comprising:
for the last node, at node i=N:
a) determining the summation of said total costs contributed by node N as a function of said plurality of second state variables to define node N costs;
b) minimizing the summation of said total costs for the remainder of the system that is upstream of node N to define upstream node N costs;
c) minimizing the summation of said total costs for the nodes that are downstream and adjacent of node N as a function of said plurality of second state variables to define downstream node N costs;
d) summing the node N costs, upstream node N costs, and downstream node N costs to define third minimum total costs for the subgraph rooted at node N;
e) minimizing the third minimum total costs for the subgraph rooted at node N over each said option and over said second parameter.

45. The computer-readable medium of claim 44, further comprising:
selecting the option at each node that minimizes the sum of said total costs for the subgraph rooted at each node over said nodes.

46. The computer-readable medium of claim 44, wherein said plurality of first state variables includes a cumulative first cost at a given node, said cumulative first cost being the sum of said first costs of the preceding nodes of at least one option plus the first cost at the given node associated with a corresponding option.

47. The computer-readable medium of claim 46, wherein said plurality of first state variables includes an incoming service second cost at a given node, said incoming service second cost being the second cost of an option that a preceding node quotes fulfillment to the given node.

48. The computer-readable medium of claim 47, wherein said plurality of first state variables includes a maximum second cost at node i, the maximum second cost at node i being the maximum said second cost of said nodes that directly feed into a given node plus said second cost associated with a corresponding option.

49. The computer-readable medium of claim 48, wherein said plurality of first state variables includes an outgoing service second cost, said outgoing service second cost being the second cost of an option that a given node quotes fulfillment to a successive node.

50. The computer-readable medium of claim 47, wherein said first parameter is said incoming service second cost.

51. The computer-readable medium of claim 50, wherein said plurality of said second state variables include said first state variables having added to each thereto a corresponding said first cost and said second cost of a corresponding option.

52. The computer-readable medium of claim 51, wherein said second parameter is said outgoing service second cost.

53. The computer-readable medium of claim 40, wherein
said interconnected stages is a supply chain;
each of said plurality of stages represents an operation to be performed;
said first cost is a monetary amount associated with performing said operation; and
said second cost is an amount of time associated with performing said operation.

54. The computer-readable medium of claim 53, wherein said total costs include manufacturing costs of a given stage.

55. The computer-readable medium of claim 54, wherein said manufacturing costs at each stage is the product of an average demand for a product at a given stage and the monetary amount associated with each option.

56. The computer-readable medium of claim 53, wherein said total costs include inventory costs at a given stage.

57. The computer-readable medium of claim 56, said inventory costs include a safety-stock cost, said safety-stock cost being a cost associated with holding stock at a stage to protect against variability.

58. The computer-readable medium of claim 57, wherein said variability is variability of demand at the stage.

59. The computer-readable medium of claim 58, wherein said variability of demand is based on a forecast.

60. The computer-readable medium of claim 57, wherein said safety-stock cost at each stage is the product of an expected safety-stock cost at each stage, a holding cost rate, and a cumulative cost, said cumulative cost being the sum of said monetary amounts of the preceding stages plus the monetary amount at a stage associated with a corresponding option.

61. The computer-readable medium of claim 60, wherein said expected safety-stock at each stage is a maximum demand at each stage over an interval of time minus an average demand over said interval of time.

62. The computer-readable medium of claim 56, said inventory costs include a pipeline stock cost for each stage, the pipeline stock cost being a cost associated with stock undergoing said operation by the stage but not yet completed.

63. The method of claim 62, wherein the pipeline stock cost at each stage is a function of an expected pipeline stock at each stage multiplied by the average cost of the product at a given stage.

64. The computer-readable medium of claim 63, wherein the expected pipeline stock at each stage is the product of an average demand and said amount of time associated with a corresponding option.

65. The computer-readable medium of claim 53, wherein said total costs include a time-to-market cost at each stage.

66. The computer-readable medium of claim 65, wherein said time-to-market cost at each stage is the product of a weighted cost and a longest time path up to and including said amount of time associated with an option at the given stage.

67. The computer-readable medium of claim 53, said monetary amount includes at least one of a direct material cost and a direct labor cost associated with performing said function at said stage.

68. The computer-readable medium of claim 53, said amount of time includes at least one of a processing time required to put an item in inventory and a transportation time.

69. The computer-readable medium of claim 40, said first cost is a monetary amount associated with an option at a stage.

70. The computer-readable medium of claim 40, wherein said second cost is an amount of time associated with an option at a stage.

71. The computer-readable medium of claim 40, wherein each of said plurality of stages represents an operation to be performed.

72. The computer-readable medium of claim 40, wherein said interconnected stages is a production system.

73. The computer-readable medium of claim 72, wherein said production system is a supply chain.

74. The computer-readable medium of claim 40, wherein said series of said stages includes at least one of said plurality of stages.

75. The computer-readable medium of claim 74, wherein said at least one of said plurality of said stages includes all of said stages.

76. The computer-readable medium of claim 40, wherein said total costs is the summation of quantifiable characteristics, said summation of quantifiable characteristics being a function of said data sets.

77. The computer-readable medium of claim 76, wherein said summation of quantifiable characteristics includes at least one of a manufacturing cost, inventory cost, and time-to-market cost.

78. The computer-readable medium of claim 40, wherein said at least one data set includes a plurality of data sets.

79. An apparatus, comprising:
a first computer including a receiving portion and a processing portion, said receiving portion configured to receive at least one data set for each of a plurality of interconnected stages, each data set corresponding to an option at the corresponding stage, each data set including a first cost and a second cost; and
said processing portion is configured to determine, based upon said at least one data set, an optimum series of options over a series of said stages by selecting a single option at each stage in said series of said stages that minimizes the sum of total costs over said series of said stages, wherein said total costs is a function of said at least one data set.

80. The apparatus of claim 79, further includes:
the processing portion being configured to transform said series of said stages into a subgraph of numbered nodes from 1 to N such that each node corresponds to a stage and each node, except a last node N, has only one adjacent node to it that has a higher node number, said one adjacent node having said higher node number being a parent node.

81. The apparatus of claim 80, further includes:
the processing portion being configured to proceed in sequential order from node i=1 to node i N−1,
when the corresponding parent node for node i is downstream thereof, the processing portion is configured to:
a) determine the summation of said total costs contributed by node i as a function of first state variables to define first node i costs, said first state variables being a function of said first cost and said second cost over said nodes;
b) minimize the summation of said total costs for the remainder of the system that is upstream of node i as a function of said first state variables to define first upstream node i costs;
c) minimize the summation of total costs of the nodes that are downstream and adjacent of node i as a function of said first state variables to define first downstream node i costs;
d) sum the first node i costs, first upstream node i costs, and first downstream node i costs to define first minimum total costs for the subgraph rooted at node i;
e) minimize the first minimum total costs for the subgraph rooted at node i over each said option and over a first parameter, said first parameter being one of said first state variables.

82. The apparatus of claim 81, further including:
when the corresponding parent node for node i is upstream of node i, the processing portion is configured to:
a) determine the summation said total costs contributed by node i as a function of a plurality of second state variables to define second node i costs, said second state variables being a function of said first state variables;
b) minimize the summation of said total costs for the remainder of the system that is upstream of node i as a function of said plurality of second state variables to define second upstream node i costs;
c) minimize the summation of said total costs for the nodes that are downstream and adjacent of node i as a function of said plurality of second state variable to define second downstream node i costs;
d) sum the second node i costs, second upstream node i costs, and second downstream node i costs to define a second minimum total costs for the subgraph rooted at node i;
e) minimize the second minimum total costs for the subgraph rooted at node i over each said option and over a second parameter, said second parameter being one of said second state variables.

83. The apparatus of claim 82, further including:
for the last node, at node i=N, the processing portion is configured to:
a) determine the summation of said total costs contributed by node N as a function of said plurality of second state variables to define node N costs;
b) minimize the summation of said total costs for the remainder of the system that is upstream of node N to define upstream node N costs;
c) minimize the summation of said total costs for the nodes that are downstream and adjacent of node N as a function of said plurality of second state variables to define downstream node N costs;
d) sum the node N costs, upstream node N costs, and downstream node N costs to define third minimum total costs for the subgraph rooted at node N;
e) minimize the third minimum total costs for the subgraph rooted at node N over each said option and over said second parameter.

84. The apparatus of claim 83, further including:
the processing portion being configured to select the option at each node that minimizes the sum of said total costs for the subgraph rooted at each node over said nodes.

85. The apparatus of claim 83, wherein said plurality of first state variables includes a cumulative first cost at a given node, said cumulative first cost being the sum of said first costs of the preceding nodes of at least one option plus the first cost at the given node associated with a corresponding option.

86. The apparatus of claim 85, wherein said plurality of first state variables includes an incoming service second cost at a given node, said incoming service second cost being the second cost of an option that a preceding node quotes fulfillment to the given node.

87. The apparatus of claim 86, wherein said plurality of first state variables includes a maximum second cost at node i, the maximum second cost at node i being the maximum said second cost of said nodes that directly feed into a given node plus said second cost associated with a corresponding option.

88. The apparatus of claim 87, wherein said plurality of first state variables includes an outgoing service second cost, said outgoing service second cost being the second cost of an option that a given node quotes fulfillment to a successive node.

89. The method of claim 86, wherein said first parameter is said incoming service second cost.

90. The method of claim 89, wherein said plurality of said second state variables include said first state variables having added to each thereto a corresponding said first cost and said second cost of a corresponding option.

91. The method of claim 90, wherein said second parameter is said outgoing service second cost.

92. The apparatus of claim 79, wherein
said interconnected stages is a supply chain;
each of said plurality of stages represents an operation to be performed;
said first cost is a monetary amount associated with performing said operation; and
said second cost is an amount of time associated with performing said operation.

93. The apparatus of claim 92, wherein said total costs include manufacturing costs of a given stage.

94. The apparatus of claim 93, wherein said manufacturing costs at each stage is the product of an average demand for a product at a given stage and the monetary amount associated with each option.

95. The apparatus of claim 92, wherein said total costs include inventory costs at a given stage.

96. The apparatus of claim 95, said inventory costs include a safety-stock cost, said safety-stock cost being a cost associated with holding stock at a stage to protect against variability.

97. The apparatus of claim 96, wherein said variability is variability of demand at the stage.

98. The apparatus of claim 97, wherein said variability of demand is based on a forecast.

99. The apparatus of claim 96, wherein said safety-stock cost at each stage is the product of an expected safety-stock cost at each stage, a holding cost rate, and a cumulative cost, said cumulative cost being the sum of said monetary amounts of the preceding stages plus the monetary amount at a stage associated with a corresponding option.

100. The apparatus of claim 99, wherein said expected safety-stock at each stage is a maximum demand at each stage over an interval of time minus an average demand over said interval of time.

101. The apparatus of claim 95, said inventory costs include a pipeline stock cost for each stage, the pipeline stock cost being a cost associated with stock undergoing said operation by the stage but not yet completed.

102. The apparatus of claim 101, wherein the pipeline stock cost at each stage is a function of an expected pipeline stock at each stage multiplied by the average cost of the product at a given stage.

103. The apparatus of claim 102, wherein the expected pipeline stock at each stage is the product of an average demand and said amount of time associated with a corresponding option.

104. The apparatus of claim 92, wherein said total costs include a time-to-market cost at each stage.

105. The apparatus of claim 104, wherein said time-to-market cost at each stage is the product of a weighted cost and a longest time path up to and including said amount of time associated with an option at the given stage.

106. The apparatus of claim 92, said monetary amount includes at least one of a direct material cost and a direct labor cost associated with performing said function at said stage.

107. The apparatus of claim 92, said amount of time includes at least one of a processing time required to put an item in inventory and a transportation time.

108. The apparatus of claim 79, said first cost is a monetary amount associated with an option at a stage.

109. The apparatus of claim 79, wherein said second cost is an amount of time associated with an option at a stage.

110. The apparatus of claim 79, wherein each of said plurality of stages represents an operation to be performed.

111. The apparatus of claim 79, wherein said interconnected stages is a production system.

112. The apparatus of claim 111, wherein said production system is a supply chain.

113. The apparatus of claim 79, wherein said series of said stages includes at least one of said plurality of stages.

114. The apparatus of claim 113, wherein said at least one of said plurality of said stages includes all of said stages.

115. The apparatus of claim 79, wherein said total costs is the summation of quantifiable characteristics, said summation of quantifiable characteristics being a function of said data sets.

116. The apparatus of claim 115, wherein said summation of quantifiable characteristics includes at least one of a manufacturing cost, inventory cost, and time-to-market cost.

117. The apparatus of claim 79, wherein said at least one data set includes a plurality of data sets.

118. A method, comprising:
representing, via a user interface of a given computer, each stage of a network of interconnected stages using a stage symbol;
interconnecting the stage symbols with links to form a representation of the network of interconnected stages, said links being displayed on a display device, wherein each stage symbol is connected to at least one other stage symbol by at least one link; and
determining, based upon information associated with a plurality of options at each of said stages, an optimum series of options over a series of said stages by selecting a single option at each stage in said series of said stages that minimizes the sum of total costs over said series of said stages, wherein said total costs is a function of said information.

119. The method of claim 118, further comprising:
obtaining said information associated with each option of a corresponding stage.

120. The method of claim 119, wherein said information for each option includes at least a first cost and a second cost.

121. The method of claim 120, wherein said information further includes first data.

122. The method of claim 119, further comprising displaying, via the user interface, said information of at least one of said stages.

123. The method of claim 119, wherein obtaining information includes retrieving said information from a database.

124. The method of claim 123, wherein said information is formatted in accordance with Extensible Markup Language (XML) in said database.

125. The method of claim 123, wherein said database is stored in a memory of said given computer.

126. The method of claim 119, wherein said obtaining information further includes accepting said information from a data entry device in conjunction with said user interface.

127. The method of claim 123, wherein the method further comprises maintaining, using said database, one or more chain versions for each said network of interconnected stages.

128. The method of claim 127, wherein the method further comprises controlling user access to each said chain version according to a level of access associated with each of one or more users.

129. The method of claim 127, wherein the method further comprises displaying, via the user interface, a chain status for each said chain version indicating whether or not the chain version is available for editing.

130. The method of claim 123, wherein said database is stored in a second memory of a second computer, and wherein retrieving said information includes:
transmitting, through a network, said information from said second computer to said first computer.

131. The method of claim 130, wherein said network includes at least one of a public switched telephone network, an Internet, and an Intranet.

132. The method of claim 130, wherein said information of said database is accessible by a second user.

133. The method of claim 132, wherein said second user is affiliated with at least one stage of the system.

134. The method of claim 133, wherein said accessible information is readable by said second user.

135. The method of claim 134, wherein said accessible information is modifiable by said second user, and when modified defines modified information, the accessibility of said information being determined by said first data.

136. The method of claim 134, wherein only said information associated with said at least one stage is modifiable by said second user.

137. The method of claim 136, wherein only at least one of said first cost, said second cost, and said third information of a corresponding option is modifiable by said second user.

138. The method of claim 136, wherein obtaining information further includes:
transmitting, through said network, said modified information from said second computer to said first computer; and
replacing, in said database, said information associated with a stage with said modified information.

139. The method of claim 120, wherein said interconnected stages is a supply chain; each of said plurality of stages represents an operation to be performed; said first cost is a monetary amount associated with performing said operation; and said second cost is an amount of time associated with performing said operation.

140. The method of claim 139, wherein said total cost includes at least one of a manufacturing cost, an inventory cost, and a time-to-market cost.

141. The method of claim 140, further comprising:
displaying, via the user interface, a portion of said optimum series of options.

142. The method of claim 141, wherein a portion of said optimum series of options includes at least one of a total of said manufacturing cost, said inventory cost, and said time-to-market cost for a user selected stage of the system.

143. The method of claim 118, wherein said series of said stages includes at least one user selected stage of the system, wherein said user selects, via the user interface, at least one specific stage to be included in the system when determining said optimum series of options.

144. The method of claim 118, wherein said series of said stages includes all stages of the system.

145. The method of claim 118, wherein said optimal series of options includes a user selected option at a corresponding stage, said user selected option being selected by the user via the user interface.

146. The method of claim 141, wherein displaying results includes:
generating, upon a user request, a comparison report showing said total costs for all stages for said optimum series of options and total costs for another series of options, said another series of options including a user selected option at a corresponding stage, said user selected option being selected by the user via the user interface.

147. The method of claim 120, further including:
inputting, via the user interface, a range for at least one of said first cost and said second cost for at least one of said options, and
displaying the totals costs for said optimum series of options as a function of said range, said displaying includes at least one of a tabular format and a graphical format.

148. The method of claim 120, further including:
calculating, upon user request, financial metrics for said optimum series of options for said interconnected system;
calculating, upon user request, said financial metrics for at least one other series of options for said interconnected system; and
displaying, via the user interface, the financial metrics for said optimum series of options and said at least one other series of options in the form of a profit/loss comparison report, said displaying including at least a tabular format.

149. The method of claim 139, further including:
displaying, upon user request, a cost breakout report showing said inventory cost and said manufacturing cost for a portion of said optimum series of options, said portion corresponding to one or more of said stages selected by the user via the user interface, said displaying including at least a tabular format.

150. The method of claim 139, further including:
displaying, upon user request, an inventory report showing an inventory level associated with said optimum series of options, said displaying including at least a tabular format.

151. The method of claim 150, further including:
displaying, upon user request, an inventory by cause report showing for each said inventory level detailed analysis information, said detailed analysis information including at least one of batching, early arrivals, demand uncertainty, and stage time uncertainty, said displaying including at least a tabular format.

152. The method of claim 120, further including:
displaying, upon user request, said information selected and presented in a user specified arrangement in the form of an ad hoc report, said arrangement selected by the user via the user interface, said displaying including at least a tabular format.

153. The method of claim 120, wherein said cost is a monetary cost associated with an option.

154. The method of claim 120, wherein said time is an amount of time associated with an option.

155. The method of claim 118, wherein each of said plurality of stages represents an operation to be performed.

156. The method of claim 118, wherein said total costs is the summation of quantifiable characteristics, said summation of quantifiable characteristics being a function of said information.

157. The method of claim 156, wherein said summation of quantifiable characteristics includes at least one of a manufacturing cost, inventory cost, and time-to-market cost.

158. The method of claim 118, wherein said stage symbol include at least one of a first shape and a second shape, each of said shapes signifying at least one specific function to be performed at said stage.

159. The method of claim 158, wherein said at least one of said first and said second shapes is colored by at least one of a user defined color and a default color.

160. The method of claim 158, wherein said stage symbol includes at least one user defined icon.

161. The method of claim 160, wherein said at least one user defined icon is user selected, via the user interface, from among a plurality of existent icons.

162. The method of claim 118, wherein said user interface is presented by a web browser.

163. The method of claim 118, wherein at least one of said stages is user defined based upon commands of said user.

164. The method of claim 163, wherein said representing further includes:
positioning, using said user interface, each of said stage symbols within a chain modeling space.

165. A computer-readable medium encoded with a program for a computer, the program comprising:
representing, via a user interface of a given computer, each stage of a network of interconnected stages using a stage symbol;
interconnecting the stage symbols with links to form a representation of the network of interconnected stages, said links being displayed on a display device, wherein each stage symbol is connected to at least one other stage symbol by at least one link; and
determining, based upon information associated with a plurality of options at each of said stages, an optimum series of options over a series of said stages by selecting a single option at each stage in said series of said stages that minimizes the sum of total costs over said series of said stages, wherein said total costs is a function of said information.

166. The computer-readable medium of claim 165, further comprising:
obtaining said information associated with each option of a corresponding stage.

167. The computer-readable medium of claim 166, wherein said information for each option includes at least a first cost and a second cost.

168. The computer-readable medium of claim 167, wherein said information further includes first data.

169. The computer-readable medium of claim 166, further comprising displaying, via the user interface, said information of at least one of said stages.

170. The computer-readable medium of claim 166, wherein obtaining information includes retrieving said information from a database.

171. The computer-readable medium of claim 170, wherein said information is formatted in accordance with Extensible Markup Language (XML) in said database.

172. The computer-readable medium of claim 170, wherein said database is stored in a memory of said given computer.

173. The computer-readable medium of claim 166, wherein said obtaining information further includes accepting said information from a data entry device in conjunction with said user interface.

174. The computer-readable medium of claim 170, further comprising: maintaining, using said database, one or more chain versions for each said network of interconnected stages.

175. The computer-readable medium of claim 174, further comprising controlling user access to each said chain version according to a level of access associated with each of one or more users.

176. The computer-readable medium of claim 174, further comprising displaying, via the user interface, a chain status for each said chain version indicating whether or not the chain version is available for editing.

177. The computer-readable medium of claim 170, wherein said database is stored in a second memory of a second computer, and wherein retrieving said information includes:
transmitting, through a network, said information from said second computer to said first computer.

178. The computer-readable medium of claim 177, wherein said network includes at least one of a public switched telephone network, an Internet, and an Intranet.

179. The computer-readable medium of claim 177, wherein said information of said database is accessible by a second user.

180. The computer-readable medium of claim 179, wherein said second user is affiliated with at least one stage of the system.

181. The computer-readable medium of claim 180, wherein said accessible information is readable by said second user.

182. The computer-readable medium of claim 181, wherein said accessible information is modifiable by said second user, and when modified defines modified information, the accessibility of said information being determined by said first data.

183. The computer-readable medium of claim 181, wherein only said information associated with said at least one stage is modifiable by said second user.

184. The computer-readable medium of claim 183, wherein only at least one of said first cost, said second cost, and said first data of a corresponding option is modifiable by said second user.

185. The computer-readable medium of claim 183, wherein obtaining information further includes:
transmitting, through said network, said modified information from said second computer to said first computer; and
replacing, in said database, said information associated with a stage with said modified information.

186. The computer-readable medium of claim 167, wherein said interconnected stages is a supply chain; each of said plurality of stages represents an operation to be performed; said first cost is a monetary amount associated with performing said operation; and said second cost is an amount of time associated with performing said operation.

187. The computer-readable medium of claim 186, wherein said total cost includes at least one of a manufacturing cost, an inventory cost, and a time-to-market cost.

188. The computer-readable medium of claim 187, further comprising:
displaying, via the user interface, a portion of said optimum series of options.

189. The computer-readable medium of claim 188, wherein a portion of said optimum series of options includes at least one of a total of said manufacturing cost, said inventory cost, and said time-to-market cost for a user selected stage of the system.

190. The computer-readable medium of claim 165, wherein said series of said stages includes at least one user selected stage of the system, wherein said user selects, via the user interface, at least one specific stage to be included in the system when determining said optimum series of options.

191. The computer-readable medium of claim 165, wherein said series of said stages includes all stages of the system.

192. The computer-readable medium of claim 165, wherein said optimal series of options includes a user selected option at a corresponding stage, said user selected option being selected by the user via the user interface.

193. The computer-readable medium of claim 188, wherein displaying results includes:
generating, upon a user request, a comparison report showing said total costs for all stages for said optimum series of options and total costs for another series of options, said another series of options including a user selected option at a corresponding stage, said user selected option being selected by the user via the user interface.

194. The computer-readable medium of claim 167, further including:
inputting, via the user interface, a range for at least one of said first cost and said second cost for at least one of said options, and
displaying the totals costs for said optimum series of options as a function of said range, said displaying includes at least one of a tabular format and a graphical format.

195. The computer-readable medium of claim 167, further including:
calculating, upon user request, financial metrics for said optimum series of options for said interconnected system;
calculating, upon user request, said financial metrics for at least one other series of options for said interconnected system; and
displaying, via the user interface, the financial metrics for said optimum series of options and said at least one other series of options in the form of a profit/loss comparison report, said displaying including at least a tabular format.

196. The computer-readable medium of claim 186, further including:
displaying, upon user request, a cost breakout report showing said inventory cost and said manufacturing cost for a portion of said optimum series of options, said portion corresponding to one or more of said stages selected by the user via the user interface, said displaying including at least a tabular format.

197. The computer-readable medium of claim 186, further including:
displaying, upon user request, an inventory report showing an inventory level associated with said optimum series of options, said displaying including at least a tabular format.

198. The computer-readable medium of claim 197, further including:
displaying, upon user request, an inventory by cause report showing for each said inventory level detailed analysis information, said detailed analysis information including at least one of batching, early arrivals, demand uncertainty, and stage time uncertainty, said displaying including at least a tabular format.

199. The computer-readable medium of claim 167, further including:
displaying, upon user request, said information selected and presented in a user specified arrangement in the form of an ad hoc report, said arrangement selected by the user via the user interface, said displaying including at least a tabular format.

200. The computer-readable medium of claim 167, wherein said cost is a monetary cost associated with an option.

201. The computer-readable medium of claim 167, wherein said time is an amount of time associated with an option.

202. The computer-readable medium of claim 165, wherein each of said plurality of stages represents an operation to be performed.

203. The computer-readable medium of claim 165, wherein said total costs is the summation of quantifiable characteristics, said summation of quantifiable characteristics being a function of said information.

204. The computer-readable medium of claim 203, wherein said summation of quantifiable characteristics includes at least one of a manufacturing cost, inventory cost, and time-to-market cost.

205. The computer-readable medium of claim 165, wherein said stage symbol include at least one of a first shape and a second shape, each of said shapes signifying at least one specific function to be performed at said stage.

206. The computer-readable medium of claim 205, wherein said at least one of said first and said second shapes is colored by at least one of a user defined color and a default color.

207. The computer-readable medium of claim 205, wherein said stage symbol includes at least one user defined icon.

208. The computer-readable medium of claim 207, wherein said at least one user defined icon is user selected, via the user interface, from among a plurality of existent icons.

209. The computer-readable medium of claim 165, wherein said user interface is presented by a web browser.

210. The computer-readable medium of claim 165, wherein at least one of said stages is user defined based upon commands of said user.

211. The computer-readable medium of claim 210, wherein said representing further includes:
positioning, using said user interface, each of said stage symbols within a modeling space.

212. An apparatus, comprising:
a first computer including a processor and a memory; and
a display device operatively connected to and responsive to the first computer;
wherein the processor is configured to:
represent each stage of a network of interconnected stages using a stage symbol,
interconnect each of said stage symbols with links to form a representation of the network of interconnected stages, the links being displayed via the user interface, each stage symbol being connected to at least one other stage symbol by at least one link, and
determine, based upon information associated with a plurality of options at each of said stages, an optimum series of options over a series of said stages by selecting a single option at each stage in said series of said stages that minimizes the sum of total costs over said series of said stages, wherein said total costs is a function of said information.

213. The apparatus of claim 212, wherein the processor is further configured to:
obtain said information associated with each option of a corresponding stage.

214. The apparatus of claim 213, wherein said information for each option includes at least a first cost and a second cost.

215. The apparatus of claim 214, wherein said information further includes first data.

216. The apparatus of claim 213, wherein the processor is further configured to:
display, via the user interface, said information of at least one of said stages.

217. The apparatus of claim 213, wherein the processor is further configured to:
obtain said information by retrieving said information from a database.

218. The apparatus of claim 217, wherein said information is formatted in accordance with Extensible Markup Language (XML) in said database.

219. The apparatus of claim 217, wherein said database is stored in said memory of said first computer.

220. The apparatus of claim 213, wherein the processor is further configured to obtain said information by accepting said information from a data entry device in conjunction with said user interface.

221. The apparatus of claim 217, wherein the processor is further configured to: maintain, using said database, one or more chain versions for each said network of interconnected stages.

222. The apparatus of claim 221, wherein the processor is further configured to: control user access to each said chain version according to a level of access associated with each of one or more users.

223. The apparatus of claim 224, wherein the processor is further configured to: display, via the user interface, a chain status for each said chain version indicating whether or not the chain version is available for editing.

224. The apparatus of claim 217, wherein said database is stored in a second memory of a second computer, and wherein the processor of said first computer is further configured to retrieve said information from said database by receiving said information from said second computer through a network.

225. The apparatus of claim 224, wherein said network includes at least one of a public switched telephone network, an Internet, and an Intranet.

226. The apparatus of claim 224, wherein said information of said database is accessible by a second user.

227. The apparatus of claim 226, wherein said second user is affiliated with at least one stage of the system.

228. The apparatus of claim 227, wherein said accessible information is readable by said second user.

229. The apparatus of claim 228, wherein said accessible information is modifiable by said second user, and when modified defines modified information, the accessibility of said information being determined by said first data.

230. The apparatus of claim 228, wherein only said information associated with said at least one stage is modifiable by said second user.

231. The apparatus of claim 230, wherein only at least one of said first cost, said second cost, and said third information of a corresponding option is modifiable by said second user.

232. The apparatus of claim 230, wherein the processor is further configured to obtain said information by:
receiving, through said network, said modified information transmitted from said second computer to said first computer; and
replacing, in said database, said information associated with a stage with said modified information.

233. The apparatus of claim 214, wherein said interconnected stages is a supply chain; each of said plurality of stages represents an operation to be performed; said first cost is a monetary amount associated with performing said operation; and said second cost is an amount of time associated with performing said operation.

234. The apparatus of claim 233, wherein said total cost includes at least one of a manufacturing cost, an inventory cost, and a time-to-market cost.

235. The apparatus of claim 234, wherein the processor is further configured to:
display, via the user interface, a portion of said optimum series of options.

236. The apparatus of claim 235, wherein a portion of said optimum series of options includes at least one of a total of said manufacturing cost, said inventory cost, and said time-to-market cost for a user selected stage of the system.

237. The apparatus of claim 212, wherein said series of said stages includes at least one user selected stage of the system, wherein said user selects, via the user interface, at least one specific stage to be included in the system when determining said optimum series of options.

238. The apparatus of claim 212, wherein said series of said stages includes all stages of the system.

239. The apparatus of claim 212, wherein said optimal series of options includes a user selected option at a corresponding stage, said user selected option being selected by the user via the user interface.

240. The apparatus of claim 235, wherein the processor is further configured to:
generate, upon a user request, a comparison report showing said total costs for all stages for said optimum series of options and total costs for another series of options, said another series of options including a user selected option at a corresponding stage, said user selected option being selected by the user via the user interface.

241. The apparatus of claim 214, wherein the processor is further configured to:
accept, via the user interface, an input of a range for at least one of said first cost and said second cost for at least one of said options, and
display the totals costs for said optimum series of options as a function of said range, wherein said display includes at least one of a tabular format and a graphical format.

242. The apparatus of claim 214, wherein the processor is further configured to:
calculate, upon user request, financial metrics for said optimum series of options for said interconnected system;
calculate, upon user request, said financial metrics for at least one other series of options for said interconnected system; and
display, via the user interface, the financial metrics for said optimum series of options and said at least one other series of options in the form of a profit/loss comparison report, said display including at least a tabular format.

243. The apparatus of claim 233, wherein the processor is further configured to:
display, upon user request, a cost breakout report showing said inventory cost and said manufacturing cost for a portion of said optimum series of options, said portion corresponding to one or more of said stages selected by the user via the user interface, said display including at least a tabular format.

244. The apparatus of claim 233, wherein the processor is further configured to:
display, upon user request, an inventory report showing an inventory level associated with said optimum series of options, said display including at least a tabular format.

245. The apparatus of claim 244, wherein the processor is further configured to:
display, upon user request, an inventory by cause report showing for each said inventory level detailed analysis information, said detailed analysis information including at least one of batching, early arrivals, demand uncertainty, and stage time uncertainty, said display including at least a tabular format.

246. The apparatus of claim 214, wherein the processor is further configured to:
display, upon user request, said information selected and presented in a user specified arrangement in the form of an ad hoc report, said arrangement selected by the user via the user interface, said display including at least a tabular format.

247. The apparatus of claim 214, wherein said cost is a monetary cost associated with an option.

248. The apparatus of claim 214, wherein said time is an amount of time associated with an option.

249. The apparatus of claim 212, wherein each of said plurality of stages represents an operation to be performed.

250. The apparatus of claim 212, wherein said total costs is the summation of quantifiable characteristics, said summation of quantifiable characteristics being a function of said information.

251. The apparatus of claim 250, wherein said summation of quantifiable characteristics includes at least one of a manufacturing cost, inventory cost, and time-to-market cost.

252. The apparatus of claim 212, wherein said stage symbol include at least one of a first shape and a second shape, each of said shapes signifying at least one specific function to be performed at said stage.

253. The apparatus of claim 252, wherein said at least one of said first and said second shapes is colored by at least one of a user defined color and a default color.

254. The apparatus of claim 252, wherein said stage symbol includes at least one user defined icon.

255. The apparatus of claim 254, wherein said at least one user defined icon is user selected, via the user interface, from among a plurality of existent icons.

256. The apparatus of claim 212, wherein said user interface is presented by a web browser.

257. The apparatus of claim 212, wherein at least one of said stages is user defined based upon commands of said user.

258. The apparatus of claim 257, wherein said visual presentation display further includes a chain modeling space.

259. A method, comprising:
receiving information corresponding to each of a plurality of components used in a product, said information including first data and second data, wherein said first data is a quantifiable attribute of interest and said second data is an availability of each component in each of a plurality of time periods;
determining, based upon said information, corresponding functionality requirements that each component must provide over each of a series of said periods that the corresponding component is incorporated into said product; and
determining the optimal set of components to be used in said product over a series of said periods that minimizes a cost functional subject to satisfying at least one of said second data and said functionality requirements over said series of said periods, wherein said cost functional includes the sum of at least one of a development costs and a manufacturing costs of said product over said series of said periods.

260. The method of claim 259, wherein at least one of said functionality requirements is that a performance level value of a component must be at least a performance requirement value of said component in each period, wherein
said performance level value being an index value corresponding to each component in each of said periods, said index value being a function of said second data;
said performance requirement value being a desired index value for each component in each of said periods.

261. The method of claim 260, wherein determining said functionality requirements includes determining said performance requirement value and said performance level value for each component in each period.

262. The method of claim 261, wherein determining said performance level value is determined from a first predefined function, said first predefined function being a function of said second data.

263. The method of claim 261, wherein the performance requirement value is determined from a second predefined function.

264. The method of claim 263, wherein said second predefined function is a function of a random variable.

265. The method of claim 263, wherein said second predefined function is deterministic.

266. The method of claim 260, wherein said manufacturing costs is a product of a first quantity, a second quantity, and a third quantity, wherein
said first quantity is a discount rate of each component in each period,
said second quantity is an initial unit cost of each component in each period,
said third quantity is the number of components incorporated into said product in each period.

267. The method of claim 266, wherein said number of components used in each period is a difference between a fourth quantity and a fifth quantity, wherein
said fourth quantity is a demand for each component in each period; and
said fifth quantity is a quantity of recycled components available to satisfy said demand in each period.

268. The method of claim 267, wherein said demand for each component in each period is a predefined, deterministic value.

269. The method of claim 267, wherein the said number of recycled components available to satisfy said demand is the summation of the product of the number of components used in a given period and said demand for a given period.

270. The method of claim 266, wherein said discount rate is the sum of time dependent discounts and volume dependent discounts.

271. The method of claim 270, wherein said time dependent discounts is the product of the number of periods a component is used and a time-dependent discount value, the time-dependent discount value being a price reduction received in each period the component is produced.

272. The method of claim 270, wherein said volume dependent discounts is the product of a cumulative production of a component up to a given period, a volume-dependent discount for each component, and a volume discount step for each component.

273. The method of claim 272, wherein said cumulative production up to a given period is the demand of a preceding period minus the number of recycled components used in the preceding period plus a cumulative production of a preceding period.

274. The method of claim 270, wherein each of said time-dependent discount, said volume-dependent discount, and said volume discount step size are component specific, predefined constants in each period.

275. The method of claim 266, wherein said initial unit cost of each component in each period includes at least one of the cost to transform raw material into a completed component and the procurement of the raw material.

276. The method of claim 267, wherein said cost functional further includes a remanufacturing cost, the remanufacturing cost being the product of a cost of remanufacturing a recycled component and said quantity of recycled components.

277. The method of claim 260, further comprising:
proceeding in sequential order from the last period N of said series of periods to the first period 1 of said series of periods, and at each period:
determining said cost functional at each period to define given period costs;
determining said cost functional at each period from said given period to the last period for each of said components to define feasible period costs; and
minimizing the sum of said given period costs and said feasible period costs over said series of periods subject to satisfying said second data and said functionality requirements over said series of said periods.

278. The method of claim 260, wherein said cost functional further includes a per period penalty cost, said per period penalty cost being a cost incurred when said performance level value in a given period for a given component deviates from the performance requirement value in the given period for the given component.

279. The method of claim 278, further comprising:
proceeding in sequential order from the last period N of said series of periods to the first period 1 of said series of periods, and at each period:
determining said cost functional for each of said components at each period to define second feasible period costs;
minimizing said second feasible period costs over said series of periods subject to satisfying said second data over said series of said periods.

280. The method of claim 278, wherein said per period penalty cost is the square of the difference between said performance level value in a given period for a given component and said performance requirement value in the given for the given component, multiplied by a period dependent constant.

281. The method of claim 259, wherein said development cost is the cost incurred as result of using a component in a given period that differs from a corresponding component used in the previous period.

282. The method of claim 259, wherein said series of said periods includes all of said plurality of periods.

283. A computer-readable medium encoded with a program for a computer, the program comprising:
receiving information corresponding to each of a plurality of components used in a product, said information including first data and second data, wherein said first data is a quantifiable attribute of interest and said second data is an availability of each component in each of a plurality of time periods;
determining, based upon said information, corresponding functionality requirements that each component must provide over each of a series of said periods that the corresponding component is incorporated into said product; and
determining the optimal set of components to be used in said product over a series of said periods that minimizes a cost functional subject to satisfying at least one of said second data and said functionality requirements over said series of said periods, wherein said cost functional includes the sum of at least one of a development costs and a manufacturing costs of said product over said series of said periods.

284. The computer-readable medium of claim 283, wherein at least one of said functionality requirements is that a performance level value of a component must be at least a performance requirement value of said component in each period, wherein
said performance level value being an index value corresponding to each component in each of said periods, said index value being a function of said second data;
said performance requirement value being a desired index value for each component in each of said periods.

285. The computer-readable medium of claim 284, wherein determining said functionality requirements includes determining said performance requirement value and said performance level value for each component in each period.

286. The computer-readable medium of claim 285, wherein determining said performance level value is determined from a first predefined function, said first predefined function being a function of said second data.

287. The computer-readable medium of claim 285, wherein the performance requirement value is determined from a second predefined function.

288. The computer-readable medium of claim 287, wherein said second predefined function is a function of a random variable.

289. The computer-readable medium of claim 287, wherein said second predefined function is deterministic.

290. The computer-readable medium of claim 284, wherein said manufacturing costs is a product of a first quantity, a second quantity, and a third quantity, wherein
said first quantity is a discount rate of each component in each period,
said second quantity is an initial unit cost of each component in each period,
said third quantity is the number of components incorporated into said product in each period.

291. The computer-readable medium of claim 290, wherein said number of components used in each period is a difference between a fourth quantity and a fifth quantity, wherein
said fourth quantity is a demand for each component in each period; and
said fifth quantity is a quantity of recycled components available to satisfy said demand in each period.

292. The computer-readable medium of claim 291, wherein said demand for each component in each period is a predefined, deterministic value.

293. The computer-readable medium of claim 291, wherein the said number of recycled components available to satisfy said demand is the summation of the product of the number of components used in a given period and said demand for a given period.

294. The computer-readable medium of claim 290, wherein said discount rate is the sum of time dependent discounts and volume dependent discounts.

295. The computer-readable medium of claim 294, wherein said time dependent discounts is the product of the number of periods a component is used and a time-dependent discount value, the time-dependent discount value being a price reduction received in each period the component is produced.

296. The computer-readable medium of claim 294, wherein said volume dependent discounts is the product of a cumulative production of a component up to a given period, a volume-dependent discount for each component, and a volume discount step for each component.

297. The computer-readable medium of claim 296, wherein said cumulative production up to a given period is the demand of a preceding period minus the number of recycled components used in the preceding period plus a cumulative production of a preceding period.

298. The computer-readable medium of claim 294, wherein each of said time-dependent discount, said volume-dependent discount, and said volume discount step size are component specific, predefined constants in each period.

299. The computer-readable medium of claim 290, wherein said initial unit cost of each component in each period includes at least one of the cost to transform raw material into a completed component and the procurement of the raw material.

300. The computer-readable medium of claim 291, wherein said cost functional further includes a remanufacturing cost, the remanufacturing cost being the product of a cost of remanufacturing a recycled component and said quantity of recycled components.

301. The computer-readable medium of claim 284, further comprising:
proceeding in sequential order from the last period N of said series of periods to the first period 1 of said series of periods, and at each period:
determining said cost functional at each period to define given period costs;
determining said cost functional at each period from said given period to the last period for each of said components to define feasible period costs; and
minimizing the sum of said given period costs and said feasible period costs over said series of periods subject to satisfying said second data and said functionality requirements over said series of said periods.

302. The computer-readable medium of claim 284, wherein said cost functional further includes a per period penalty cost, said per period penalty cost being a cost incurred when said performance level value in a given period for a given component deviates from the performance requirement value in the given period for the given component.

303. The computer-readable medium of claim 302, further comprising:
proceeding in sequential order from the last period N of said series of periods to the first period 1 of said series of periods, and at each period:
determining said cost functional for each of said components at each period to define second feasible period costs; and
minimizing said second feasible period costs over said series of periods subject to satisfying said second data over said series of said periods.

304. The computer-readable medium of claim 302, wherein said per period penalty cost is the square of the difference between said performance level value in a given period for a given component and said performance requirement value in the given for the given component, multiplied by a period dependent constant.

305. The computer-readable medium of claim 283, wherein said development cost is the cost incurred as result of using a component in a given period that differs from a corresponding component used in the previous period.

306. The computer-readable medium of claim 283, wherein said series of said periods includes all of said plurality of periods.

307. An apparatus, comprising:
a computer including a receiving portion and a processing portion, said receiving portion configured to receive information corresponding to each of a plurality of components used in a product, said information including first data and second data, wherein said first data is a quantifiable attribute of interest and said second data is an availability of each component in each of a plurality of time periods;
said processing portion being configured to determine, based upon said information, corresponding functionality requirements that each component must provide over each of a series of said periods that the corresponding component is incorporated into said product; and
said processing portion being configured to determine the optimal set of components to be used in said product over a series of said periods that minimizes a cost functional subject to satisfying at least one of said second data and said functionality requirements over said series of said periods, wherein said cost functional includes the sum of at least one of a development costs and a manufacturing costs of said product over said series of said periods.

308. The apparatus of claim 307, wherein at least one of said functionality requirements is that a performance level value of a component must be at least a performance requirement value of said component in each period, wherein
said performance level value being an index value corresponding to each component in each of said periods, said index value being a function of said second data;
said performance requirement value being a desired index value for each component in each of said periods.

309. The apparatus of claim 308, wherein determining said functionality requirements includes said processing portion being configured to determine said performance requirement value and said performance level value for each component in each period.

310. The apparatus of claim 309, wherein said processing portion is configured determine said performance level value from a first predefined function, said first predefined function being a function of said second data.

311. The apparatus of claim 309, wherein the processing portion is configured to determine the performance requirement value is from a second predefined function.

312. The apparatus of claim 311, wherein said second predefined function is a function of a random variable.

313. The apparatus of claim 311, wherein said second predefined function is deterministic.

314. The apparatus of claim 308, wherein said manufacturing costs includes a product of a first quantity, a second quantity, and a third quantity, wherein
said first quantity is a discount rate of each component in each period,
said second quantity is an initial unit cost of each component in each period,
said third quantity is the number of components incorporated into said product in each period.

315. The apparatus of claim 314, wherein said number of components used in each period is a difference between a fourth quantity and a fifth quantity, wherein
said fourth quantity is a demand for each component in each period; and
said fifth quantity is a quantity of recycled components available to satisfy said demand in each period.

316. The apparatus of claim 315, wherein said demand for each component in each period is a predefined, deterministic value.

317. The apparatus of claim 315, wherein the said number of recycled components available to satisfy said demand is the summation of the product of the number of components used in a given period and said demand for a given period.

318. The apparatus of claim 314, wherein said discount rate is the sum of time dependent discounts and volume dependent discounts.

319. The apparatus of claim 318, wherein said time dependent discounts is the product of the number of periods a component is used and a time-dependent discount value, the time-dependent discount value being a price reduction received in each period the component is produced.

320. The apparatus of claim 318, wherein said volume dependent discounts is the product of a cumulative production of a component up to a given period, a volume-dependent discount for each component, and a volume discount step for each component.

321. The apparatus of claim 320, wherein said cumulative production up to a given period is the demand of a preceding period minus the number of recycled components used in the preceding period plus a cumulative production of a preceding period.

322. The apparatus of claim 318, wherein each of said time-dependent discount, said volume-dependent discount, and said volume discount step size are component specific, predefined constants in each period.

323. The apparatus of claim 314, wherein said initial unit cost of each component in each period includes at least one of the cost to transform raw material into a completed component and the procurement of the raw material.

324. The apparatus of claim 315, wherein said cost functional further includes a remanufacturing cost, the remanufacturing cost being the product of a cost of remanufacturing a recycled component and said quantity of recycled components.

325. The apparatus of claim 308, further comprising:
the processing portion being configured to proceed in sequential order from the last period N of said series of periods to the first period 1 of said series of periods, and at each period the processing portion being configured to:
determine said cost functional at each period to define given period costs;
determine said cost functional at each period from said given period to the last period for each of said components to define feasible period costs; and
minimize the sum of said given period costs and said feasible period costs over said series of periods subject to satisfying said second data and said functionality requirements over said series of said periods.

326. The apparatus of claim 308, wherein said cost functional further includes a per period penalty cost, said per period penalty cost being a cost incurred when said performance level value in a given period for a given component deviates from the performance requirement value in the given period for the given component.

327. The apparatus of claim 326, further comprising:
the processing portion being configured to proceed in sequential order from the last period N of said series of periods to the first period 1 of said series of periods, and at each period the processing portion being configured to:
determine said cost functional for each of said components at each period to define second feasible period costs;
minimize said second feasible period costs over said series of periods subject to satisfying said second data over said series of said periods.

328. The apparatus of claim 326, wherein said per period penalty cost is the square of the difference between said performance level value in a given period for a given component and said performance requirement value in the given for the given component, multiplied by a period dependent constant.

329. The apparatus of claim 307, wherein said development cost is the cost incurred as result of using a component in a given period that differs from a corresponding component used in the previous period.

330. The apparatus of claim 307, wherein said series of said periods includes all of said plurality of periods.
